(19) United States
(12) Patent Application Publication
(10) Pub. No.: US 2015/0070516 A1
(43) Pub. Date: Mar. 12, 2015

(54) Automatic Content Filtering

(71) Applicant: Biscotti Inc., McKinney, TX (US)

(72) Inventors: Matthew B. Shoemake, Allen, TX (US); Syed Nadeem Ahmed, Allen, TX (US)

(21) Appl. No.: 14/539,106

(22) Filed: Nov. 12, 2014

Related U.S. Application Data
(63) Continuation-in-part of application No. 14/106,263, filed on Dec. 13, 2013.
Application No. 14/106,263 is a continuation-in-part of application No. 14/170,499, filed on Jan. 31, 2014.
Application No. 14/170,499 is a continuation-in-part of application No. 14/341,009, filed on Jul. 25, 2014.
Application No. 14/341,009 is a continuation-in-part of application No. 14/472,133, filed on Aug. 28, 2014.
Application No. 14/472,133 is a continuation-in-part of application No. 14/479,169, filed on Sep. 5, 2014.
Application No. 14/479,169 is a continuation-in-part of application No. 14/106,279, filed on Dec. 13, 2013.
Application No. 14/106,279 is a continuation-in-part of application No. 14/106,360, filed on Dec. 13, 2013, now Pat. No. 8,914,837.
Application No. 14/106,360 is a continuation-in-part of application No. 14/464,435, filed on Aug. 20, 2014.
(60) Provisional application No. 61/737,506, filed on Dec. 14, 2012.
(60) Provisional application No. 61/759,621, filed on Feb. 1, 2013.
(60) Provisional application No. 61/858,518, filed on Jul. 25, 2013.
(60) Provisional application No. 61/872,603, filed on Aug. 30, 2013.
(60) Provisional application No. 61/874,903, filed on Sep. 6, 2013.
(60) Provisional application No. 61/877,928, filed on Sep. 13, 2013.

(51) Int. Cl. H04N 5/232

(52) U.S. Cl. CPC H04N 5/23206
USPC 348/207.11

(57) ABSTRACT

Novel tools and techniques are provided for enabling or implementing presence detection and/or automatic content filtering of media content based on detected presence of users. In some embodiments, media content—including, without limitation, movies, television programs, music, video games, and/or the like—may be presented to a user(s) via a presence detection device (“PDD”). The PDD and/or a server over a network may collect presence information of a user(s), and may determine, based on the presence information of the user(s), whether (and how) at least one portion of the media content should be filtered or censored. Based on a determination that at least one portion of the media content should be filtered or censored, the PDD and/or the server might implement filtering or censoring of the at least one portion of the media content prior to presentation of (the at least one portion of) the media content to the user(s).

### CROSS-REFERENCES TO RELATED APPLICATIONS

This application is a continuation-in-part of U.S. patent application Ser. No. 14/106,263, filed on Dec. 13, 2013 by Shoemake et al. and titled “Video Capture, Processing and Distribution System” (attorney docket no. 0414.06, referred to herein as the “'263 application”), which claims the benefit of provisional U.S. Patent Application No. 61/737,506, filed Dec. 14, 2012 by Shoemake et al. and titled “Video Capture, Processing and Distribution System” (attorney docket no. 0414.06-PR, referred to herein as the “'506 application”). This application is also a continuation in part of U.S. patent application Ser. No. 14/170,499, filed on Jan. 31, 2014 by Shoemake et al. and titled “Video Mail Capture, Processing and Distribution” (attorney docket no. 0414.07, referred to herein as the “'499 application”), which claims the benefit of provisional U.S. Patent Application No. 61/759,621, filed Feb. 1, 2013 by Shoemake et al. and titled “Video Mail Capture, Processing and Distribution” (attorney docket no. 0414.07-PR, referred to herein as the “'621 application”). This application is also a continuation-in part of U.S. patent application Ser. No. 14/341,009, filed on Jul. 25, 2014 by Shoemake et al. and titled “Video Calling and Conferencing Addressing” (attorney docket no. 0414.08, referred to herein as the “'009 application”), which claims the benefit of provisional U.S. Patent Application No. 61/858,518, filed Jul. 25, 2013 by Shoemake et al. and titled “Video Calling and Conferencing Addressing” (attorney docket no. 0414.08-PR, referred to herein as the “'518 application”). This application is also a continuation in part of U.S. patent application Ser. No. 14/472,133, filed on Aug. 28, 2014 by Ahmed et al. and titled “Physical Presence and Advertising” (attorney docket no. 0414.10, referred to herein as the “'133 application”), which claims the benefit of provisional U.S. Patent Application No. 61/872,603, filed Aug. 30, 2013 by Ahmed et al. and titled “Physical Presence and Advertising” (attorney docket no. 0414.10-PR, referred to herein as the “'603 application”). This application is also a continuation in part of U.S. patent application Ser. No. 14/479,169, filed on Sep. 5, 2014 by Shoemake et al. and titled “Virtual Window” (attorney docket no. 0414.11, referred to herein as the “'169 application”), which claims the benefit of provisional U.S. Patent Application No. 61/874,903, filed Sep. 6, 2013 by Shoemake et al. and titled “Virtual Window” (attorney docket no. 0414.11-PR, referred to herein as the “'903 application”). This application is also a continuation in part of U.S. patent application Ser. No. 14/106,279, filed on Dec. 13, 2013 by Ahmed et al. and titled “Mobile Presence Detection” (attorney docket no. 0414.12, referred to herein as the “'279 application”), which claims the benefit of provisional U.S. Patent Application No. 61/877,928, filed Sep. 13, 2013 by Ahmed et al. and titled “Mobile Presence Detection” (attorney docket no. 0414.12-PR, referred to herein as the “'928 application”). This application is also a continuation-in-part of U.S. patent application Ser. No. 14/106,360, filed on Dec. 13, 2013 by Ahmed et al. and titled “Distributed Infrastructure” (attorney docket no. 0414.13, referred to herein as the “'360 application”). This application is also a continuation-in-part of U.S. patent application Ser. No. 14/464,435, filed Aug. 20, 2014 by Shoemake et al. and titled “Monitoring, Trend Estimation, and User Recommendations” (attorney docket no. 0414.09, referred to herein as the “'435 application”).

This application may also be related to provisional U.S. Patent Application No. 61/987,304, filed May 1, 2014 by Shoemake et al. and titled “Virtual Remote Functionality” (attorney docket no. 0414.15-PR, referred to herein as the “'304 application”).

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to content filtering, and, more particularly, to tools and techniques for sensing the presence of a user in a room and/or for filtering/censoring/replacing content (including offensive language, violent content, sexual content, etc. in media content being presented) based on the sensed presence.

### BACKGROUND

The proliferation of capable user devices, pervasive communication, and increased bandwidth has provided opportunity for many enhanced services for users. One example is video calling. Once the domain of high-end, dedicated systems from vendors such as POLYCOM®, video calling has become available to the average consumer at a reasonable cost. For example, the Biscotti™ device, available from Biscotti, Inc., provides an inexpensive tool to allow video calling using a high-definition television and an Internet connection. More generally, a class of devices, which have been described as “video calling devices” but are referred to herein as video communication devices (“VCDs”) can be simultaneously connected to a display (such as a television, to name one example) and a source of content (such as a set-top box (“STB”), to name an example) in a pass-through configuration and can have a network connection and/or sensors such as a camera, a microphone, infrared sensors, and/or other suitable sensors. Such devices present a powerful platform for various applications. Examples include, without limitation, video calling, instant messaging, presence detection, status updates, media streaming over the Internet, web content viewing, gaming, and DVR capability. Another example of such value added services is the introduction of online gaming. Rather than playing a game by him- or herself, a user now can play most games in a multiplayer mode, using communication over the Internet or another network.

Enabling such services is a new class of user device, which generally features relatively high-end processing capability (which would have been unthinkable outside supercomputing labs just a few years ago), substantial random access memory, and relatively vast non-transient storage capabilities, including hard drives, solid state drives, and the like. Such user devices can include, without limitation, the VCDs mentioned above, the presence detection devices (“PDDs”) described in the '279 application, various video game consoles, and the like. Such devices generally have a reliable, and relatively high-speed, connection to the Internet (to enable the value added services) and significant amounts of downtime, in which the processing and other capabilities of the devices are unused.

In the context of censoring content deemed obscene, indecent, and/or profane, conventional techniques have utilized time delayed broadcasting to enable human censors to detect foul words (for example) and “bleeping” out such foul words in broadcast television. To that end, the Federal Communications Commission (“FCC”) have provided guidelines on prohibition of certain words in broadcast television and radio. In general, there are certain words and images that may be viewed by certain individuals or groups as being foul, profane, and/or obscene. Such individuals and groups may take action via the government to limit the display or presentation of these images and sounds in public or through the public airwaves. For example, in the United States, there are prohibitions on the broadcast of certain images and words.

One problem is that what one individual or group may view as being obscene, profane, or indecent may be viewed by others as being artistic. If a group of individuals uses the government to enforce a ban on a particular work or image, there are naturally questions about individual and Constitutional rights being violated or infringed. The nature of outlawing certain language or images may suppress rights that were fought for with blood. Also, these differences in opinion may not be as black and white as it may seem. For example, one individual may view El Greco's Opening of the Fifth Seal as art, while another may view it as unacceptable nudity. Yet another individual may view the word “piss” as a non-offensive substitute for “urinate,” while some may view the word as being so hideous that it must be blocked from broadcast on the public airwaves. In broadcast of television over the public airwaves, the method of enforcing prohibitions on images and words is quite coarse in that any prohibition affects all. This is an issue, as coarse prohibition may infringe upon the rights of individuals and minorities within certain communities. Although the examples above are directed to broadcast content, other types of content may be subject to censorship as well.

Hence, there is a need for solutions that allow for more flexible and robust content filtering functionalities based on presence information of a user, and some such solutions can employ the powerful user devices already resident in many users' homes.

### BRIEF SUMMARY

A set of embodiments provides tools and techniques to sense the presence of one or more users in a room. In some embodiments, an inline camera can be used to sense such presence; in an aspect, such devices can sense the number of people present in the room and/or can identify one or more of the people present in the room. In some cases, such devices can sense whether a user is actively engaged with (e.g., watching) a display or other television. In an aspect of certain embodiments, such information can be used for a variety of purposes, including without limitation identifying content (including, merely by way of example, potentially offensive or objectionable content) that should be filtered based on such information and based on presence information of the detected and/or identified people.

In some embodiments, media content—including, without limitation, movies, television programs, music, video games, and/or the like—may be presented to a user(s) via a presence detection device (“PDD”). The PDD and/or a server over a network may collect presence information of a user(s), and may determine, based on the presence information of the user(s), whether (and how) at least one portion of the media content should be filtered or censored. Based on a determination that at least one portion of the media content should be filtered or censored, the PDD and/or the server might implement filtering or censoring of the at least one portion of the media content prior to presentation of (the at least one portion of) the media content to the user(s).

According to some embodiments, inline cameras (which in some cases can be a stand-alone device or a device embodied in another suitable device including, but not limited to, a PDD as discussed above, or a video calling device, and/or the like) can also contain cameras, microphones, and other sensors. These sensors, in conjunction with the internal processing capability of the device allow the device to know when someone is in room. Additionally, the devices can also recognize who is in the room. They can also tell if users are actually looking at the television. These capabilities allow for very customized content filtering based on whether someone is in the room, the identity of the person(s) in the room, and if they are looking at the TV. For example, the ability to determine whether someone is looking at the TV is a very useful tool for filtering or censoring content that that person (or perhaps a parent of that person) deems to be offensive, objectionable, and/or inappropriate for that person. Inline cameras can use this to customize content filtering or censoring for a particular user and to gauge the effectiveness of the content filtering process (both determination of whether and which portions of media content to filter, and how to filter such portions of the media content).

In some embodiments, inline cameras can also determine the content of the audio/visual (“A/V”) stream that is coming from a set-top box (“STB”) or other local content source. This can be done in a number of ways. One way in which content can be identified is to search for watermarks that are often embedded in the audio/video stream itself. Watermark identification can be accomplished by using the processor in the inline camera to search for a known audio and/or video pattern that is embedded in the stream. The watermarks may be designed to be perceptible or imperceptible to users that may be watching the content. Once the watermark is identified, the channel or content that the STB is set to can be identified. Another approach to determining the content of the STB is classify the source of the content in the A/V stream itself by searching either for keywords, phrases that can be used for identification purposes or by “fingerprinting” the A/V stream and comparing the fingerprint against a database of fingerprints that are either local to the inline camera or on a network (such as on a control server, as described below). By determining the content coming from the STB, inline cameras can overlay or replace portions of the media content with replacement content coming from the STB. For example, if a child user is watching a movie (either with or without an adult present), and the movie contains inappropriate content—including, without limitation, one or more of nudity, sexual content, violent content, and/or offensive language—, the inappropriate content may be automatically identified and automatically replaced with replacement content that either blocks the inappropriate content or presents appropriate substitute content.

With the techniques described herein, implementation of censorship of potentially offensive or objectionable content (e.g., obscene, profane, and/or indecent content) would shift to the end users. This allows broadcasters (or other content providers) to provide, broadcast, or send video, images, audio, games, etc. to users as they please, thus their freedoms are protected. At the same time, the recipient of the audio and video may implement their own custom censorship to protect themselves from words, images, or other content they deem to be offensive or objectionable.

The techniques described herein can also be employed in a variety of video calling environments, and with a variety of different hardware and software configurations. Merely by way of example, these techniques can be used with video calling devices and systems described in detail in U.S. patent application Ser. No. 12/561,165, filed Sep. 16, 2009 by Shoemake et al. and titled “Real Time Video Communications System” (issued as U.S. Pat. No. 8,144,182) and in the '304, '360, '279, '928, '169, '903, '133, '603, '435, '009, '518, '499, '621, '263, and '506, applications, each of which is incorporated by reference, as if set forth in full in this document, for all purposes.

The tools provided by various embodiments include, without limitation, methods, systems, and/or software products. Merely by way of example, a method might comprise one or more procedures, any or all of which are executed by an image capture device (“ICD”), a PDD, and/or a computer system. Correspondingly, an embodiment might provide an ICD, a PDD, and/or a computer system configured with instructions to perform one or more procedures in accordance with methods provided by various other embodiments. Similarly, a computer program might comprise a set of instructions that are executable by an ICD, a PDD, and/or a computer system (and/or a processor therein) to perform such operations. In many cases, such software programs are encoded on physical, tangible, and/or non-transitory computer readable media (such as, to name but a few examples, optical media, magnetic media, and/or the like).

In an aspect, a method might comprise receiving, with a first device, first media content from a local content source and presenting, with the first device, the received first media content. The method might also comprise collecting, with a presence detection device, presence information of a user, estimating characteristics of the user, with a first computer, based at least in part on information derived from at least a portion of the presence information, and determining, with a second computer, whether at least one portion of the received first media content should be filtered based at least in part on the estimated characteristics of the user. The method might further comprise, based on a determination that at least one portion of the received first media content should be filtered, filtering the at least one portion of the received first media content prior to presenting the at least one portion of the received first media content.

In some embodiments, the first media content might comprise media content type selected from a group consisting of television program content, movie content, music content, gaming content, news-related content, sports-related content, video clip content, advertisement content, and Internet-based media content. In some cases, at least two of the first device, the presence detection device, the first computer, and/or the second computer might be the same device. In some instances, at least one of the first computer or the second computer might be a control server in communication with the presence detection device over a network.

According to some embodiments, estimating characteristics of the user, with the first computer, based at least in part on information derived from at least a portion of the presence information might comprise estimating, with the first computer, one or more of age, gender, and/or demographics of the user, based at least in part on the information derived from at least a portion of the presence information. In some instances, estimating characteristics of the user, with the first computer, based at least in part on information derived from at least a portion of the presence information might comprise identifying the user, with the first computer, based at least in part on the information derived from at least a portion of the presence information

Merely by way of example, in some embodiments, the presence detection device might comprise a video input interface to receive video input from the local content source, an audio input interface to receive audio input from the local content source, a video output interface to provide video output to a display device, an audio output interface to provide audio output to an audio receiver, an image capture device to capture at least one of image data or video data, an audio capture device to capture audio data, a network interface, at least one processor, and a storage medium in communication with the at least one processor. In some cases, the presence information might comprise at least one of an image captured by the image capture device, a video segment captured by the image capture device, an audio sample captured by the audio capture device, and/or a detected presence of a user device in proximity to the first presence detection device.

According to some embodiments, collecting the presence information might comprise capturing one or more images of at least a portion of a room with the image capture device. The one or more images might, in some instances, comprise a video stream, and collecting the presence information might comprise analyzing the one or more images. In some cases, analyzing the one or more images might comprise determining a number of people in the room. In some embodiments, analyzing the one or more images might comprise determining a collective demographic of a plurality of people in the room. In some instances, analyzing the one or more images might comprise determining an identity of at least one person in the room, using facial recognition technology. In some cases, analyzing the one or more images might comprise determining that a person is watching a display device, using eye tracking technology.

In some embodiments, filtering the at least one portion of the received first media content might comprise receiving at least one filtered portion of the first media content and inserting the at least one filtered portion of the first media content in a media stream comprising the first media content. In some cases, inserting the at least one filtered portion of the first media content in the media stream might comprise replacing the at least one portion of the received first media content with the at least one filtered portion of the first media content. In some instances, the at least one filtered portion of the first media content might comprise at least one of one or more colored polygons, one or more pixelated images, one or more blurred images, one or more smiley faces, one or more predetermined images, one or more random images, one or more audio tones, one or more audio blanks (i.e., no sound portions), one or more replacement words, and/or one or more video scenes. According to some embodiments, the one or more replacement words might comprise replacement words matching one or more of gender, age, nationality, accent, and/or characteristics of a speaker of words that are being replaced by the one or more replacement words.

In some cases, the method might further comprise determining, with the second computer, whether at least one portion of the received first media content should be filtered based at least in part on analyzing the first media content to identify specific one or more of video content, image content, game content, or audio content that are indicated in a database as being potentially objectionable, using one or more of pattern recognition technology and/or object recognition technology. In some instances, filtering the at least one portion of the received first media content might comprise replacing the identified specific one or more of video content, image content, game content, or audio content with at least one of the one or more colored polygons, the one or more pixelated images, the one or more blurred images, the one or more smiley faces, the one or more predetermined images, and/or the one or more random images. According to some embodiments, inserting the at least one filtered portion of the first media content in the media stream might comprise overlaying the media stream with the at least one filtered portion of the first media content. In some cases, filtering the at least one portion of the received first media content might further comprise adding latency to the first media content during presentation of the first media content.

According to some embodiments, filtering the at least one portion of the received first media content might comprise at least one of blocking the at least one portion of the received first media content from being presented; pausing presentation of the at least one portion of the received first media content; hiding the at least one portion of the received first media content during presentation of the received first media content; skipping the at least one portion of the received first media content during presentation of the received first media content; removing the at least one portion from the received first media content; or replacing the at least one portion of the received first media content with replacement content. In some instances, the replacement content comprises a different version of the first media content (or the at least one filtered portion of the first media content, as described above).

In some embodiments, determining, with a second computer, whether at least one portion of the received first media content should be filtered based at least in part on the estimated characteristics of the user might comprise determining that the user is a child user and that the at least one portion of the received media content is media content inappropriate for the child user, and filtering the at least one portion of the received first media content might comprise at least one of pausing and/or blanking the at least one portion of the received first media content. In some instances, determining that the user is a child user and that the at least one portion of the received media content is media content inappropriate for the child user might comprise receiving one or more of a verbal command, from a second user, indicating that the at least one portion of the received media content should be censored, a gesture command, from the second user, indicating that the at least one portion of the received media content should be censored, and/or instructions based on user profiles associated with the child user indicating that media content similar to the at least one portion of the received media content should be censored. In some cases, the method might further comprise determining, with the presence detection device, that the child user is no longer present, and, based on a determination that the child user is no longer present, resuming presentation of the received first media content. In some embodiments, determining, with the presence detection device, that the child user is no longer present might comprise one or more of a verbal command, from the second user, indicating to resume presentation of the at least one portion of the received media content, a gesture command, from the second user, indicating to resume presentation of the at least one portion of the received media content, and/or instructions based on analysis of current presence information of the child user indicating that the child user is no longer physically present.

According to some embodiments, the method might further comprise identifying the user, with the first computer, based at least in part on identifying information derived from at least a portion of the presence information. In some cases, identifying the user might comprise determining an identity of the user, using one or more of facial recognition technology and/or voice recognition technology. In some embodiments, the method might further comprise determining, with the second computer, whether at least one portion of the received first media content should be filtered based on profile information of each of the identified at least one person in the room. In some instances, collecting presence information of a user might comprise collecting presence information the user over a period of time, and the method might further comprise updating, with the presence detection device, a user profile associated with the user with updated identifying information based on a determination that one or more of an appearance and/or a voice pattern of the user has changed. In some cases, the method might further comprise receiving user input from the user indicating desired custom level of content filtering and updating a user profile associated with the user, based at least in part on the received user input.

In some instances, determining, with a second computer, whether at least one portion of the received first media content should be filtered based at least in part on the estimated characteristics of the user might comprise determining, with a second computer, whether at least one portion of the received first media content should be filtered based at least in part on a determination as to whether one or more users whose presence are presently detected are of an estimated age appropriate to view, listen to, or play the first media content based at least in part on content ratings of the first media content.

In some embodiments, the method might further comprise monitoring, with the presence detection device, information associated with the first media content and sending, with the presence detection device, the monitored information associated with the first media content to the second computer over a network. In some instances, the information associated with the first media content might comprise media content-based information comprising at least one of information pertaining to one or more portions of the first media content containing one or more of video scenes of nudity and/or images of nudity; information pertaining to one or more portions of the first media content containing one or more of video scenes of suggestive sexual content and/or images of suggestive sexual content; information pertaining to one or more portions of the first media content containing one or more of video scenes of explicit sexual content and/or images of explicit sexual content; information pertaining to one or more portions of the first media content containing one or more of video scenes of violence and/or images of violence; and/or information pertaining to one or more portions of the first media content containing one or more of audio of violence, audio of sexual content, and/or audio of coarse or offensive language.

The method might further comprise determining, with a second computer, whether at least one portion of the received first media content should be filtered based at least in part on at least one of one or more first locations containing the media-content based information in the first media content that are monitored by the presence detection device; one or more second locations containing the media-content based information in the first media content that are marked by the user using user input; and/or one or more third locations containing the media-content based information in the first media content that are monitored by the presence detection device in compiled information received from a database over a network. The compiled information might comprise locations containing the media-content based information in the first media content that are marked by at least one of a plurality of users who are unassociated with the user (and/or unknown to the user) or a plurality of users who are known to the user (e.g., known friends, known family members, social media friends, etc.).

In some cases, each of the information associated with the first media content might comprise audience-based information comprising at least one of number of audience members present during presentation of particular portions of the first media content, identity of each audience member, gender of each audience member, age of each audience member, demographic group to which each audience member belongs, viewing patterns of each audience member, specific reactions of each audience member during presentation of particular portions of the first media content, overall reactions of each audience member throughout presentation of the first media content, consistency of audience member reactions of each audience member compared with personal preferences of the audience member, and/or consistency of audience member reactions of each audience member compared with past reactions of the audience member. In some embodiments, each of the specific reactions or the overall reactions might comprise reactions selected from a group consisting of vocal expressions, facial expressions, hand gestures, body gestures, eye movement, eye focus, and/or shift in proximity with respect to the presence detection device. In some instances, the audience-based information might be monitored using one or more of facial recognition techniques, facial expression recognition techniques, mood recognition techniques, emotion recognition techniques, voice recognition techniques, vocal tone recognition techniques, speech recognition techniques, eye movement tracking techniques, eye focus determination techniques, and/or proximity detection techniques.

According to some embodiments, the method might further comprise determining, with a second computer, whether at least one portion of the received first media content should be filtered based at least in part on analysis of one or more of identification of each person in a room in which the presence detection device is located, identification of each person viewing the first media content being displayed on a display device communicatively coupled to a video output interface of the presence detection device, and/or identification of each person listening to the first media content being presented over a speaker communicatively coupled to an audio receiver that is communicatively coupled to an audio output interface of the presence detection device.

In another aspect, an apparatus might comprise a non-transitory computer readable medium having encoded thereon a set of instructions executable by one or more processors to cause the apparatus to perform one or more operations. The set of instructions might comprise instructions for receiving presence information from a presence detection device and instructions for determining whether at least one portion of a first media content should be filtered during presentation of the first media content, based at least in part on the presence information.

In yet another aspect, a system might comprise a computer and a presence detection device. The computer might comprise one or more first processors and a first non-transitory computer readable medium in communication with the one or more first processors. The first non-transitory computer readable medium might have encoded thereon a first set of instructions executable by the one or more first processors to cause the computer to perform one or more operations. The first set of instructions might comprise instructions for receiving presence information of a user from the presence detection device, instructions for determining whether at least one portion of a first media content should be filtered during presentation of the first media content, based at least in part on the presence information, and instructions for, based on a determination that at least one portion of the first media content should be filtered, sending at least one filtered portion of the first media content corresponding to the at least one portion of the first media content.

The presence detection device might be configured to collect the presence information. The presence detection device might comprise a video input interface to receive video input from a local content source, an audio input interface to receive audio input from the local content source, a video output interface to provide video output to a display device, an audio output interface to provide audio output to an audio receiver, an image capture device to capture at least one of image data or video data, an audio capture device to capture audio data, a network interface, one or more second processors, and a second non-transitory computer readable medium in communication with the one or more second processors. The second non-transitory computer readable medium might have encoded thereon a second set of instructions executable by the one or more second processors to control operation of the presence detection device. The second set of instructions might comprise instructions for controlling the image capture device to capture one of a video stream or at least one image of the user, instructions for controlling the audio capture device to capture an audio stream, instructions for encoding the captured video stream and the captured audio stream to produce a series of data packets comprising presence information of the user, and instructions for transmitting, using the network interface, the series of data packets comprising presence information of the user, for reception by the computer. The second set of instructions might further comprise instructions for receiving the first media content, instructions for receiving, from the computer, the at least one filtered portion of the first media content, instructions for presenting the first media content, and instructions for replacing, during presentation of the first media content, each of the at least one portion of the first media content with a corresponding one of the at least one filtered portion of the first media content, based on the determination that at least one portion of the first media content should be filtered.

In still another aspect, an image capture device might be configured to be accessible over a network. The image capture device might comprise an image sensor to capture at least one of image data or video data, a communication system, one or more processors, and a computer readable medium in communication with the one or more processors. The computer readable medium having encoded thereon a set of instructions executable by the computer system to cause the image capture device to perform one or more operations. The set of instructions might comprise instructions for collecting presence information of a user and instructions for sending the collected presence information to a computer over a network to determine whether at least one portion of a first media content should be filtered during presentation of the first media content, based at least in part on profile information of the user.

In some embodiments, the set of instructions might further comprise instructions for identifying the user, based at least in part on identifying information derived from at least a portion of the presence information. The instructions for sending the collected presence information to the computer might comprise instructions for sending information pertaining to an identification of the user. In some cases, the set of instructions might further comprise instructions for presenting the first media content and instructions for replacing, during presentation of the first media content, each of the at least one portion of the first media content with a corresponding one of at least one filtered portion of the first media content, based on a determination that the at least one portion of the first media content should be filtered.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a block diagram illustrating a system for enabling or implementing presence detection and/or automatic content filtering of media content based on detected presence of users, in accordance with various embodiments.

FIGS. 2A and 2B are process flow diagrams illustrating various methods of enabling or implementing presence detection and/or automatic content filtering of media content based on detected presence of users, in accordance with various embodiments.

FIGS. 3A and 3B are process flow diagram illustrating various other methods of enabling or implementing presence detection and/or automatic content filtering of media content based on detected presence of users, in accordance with various embodiments.

FIG. 4 is a process flow diagram illustrating yet another method of enabling or implementing presence detection and/or automatic content filtering of media content based on detected presence of users, in accordance with various embodiments.

FIG. 5 is a block diagram illustrating another system for enabling or implementing presence detection and/or automatic content filtering of media content based on detected presence of users, in accordance with various embodiments.

FIG. 6 is a generalized schematic diagram illustrating a computer system, in accordance with various embodiments.

FIG. 7 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

### Features Provided by Various Embodiments

Presence Detection Functionalities

Presence Detection Devices (“PDDs”) or Image Capture Devices (“ICDs”) provided by various embodiments can contain or communicate with, inter alia, cameras, microphones, and/or other sensors (including, without limitation, infrared (“IR”) sensors). These sensors, in conjunction with the internal processing capability of the device, can allow the device to detect when a person is in the room. Additionally, through means such as facial recognition and voice detection, or the like, the devices also can automatically recognize who is in the room. More specifically, such devices can detect the presence of a particular individual. In some aspects, ICDs might contain or communicate with, inter alia, image capture devices for capturing images or video of the person or people in the room. In some cases, ICDs might also contain or communicate with, inter alia, microphones, and/or other sensors (including, without limitation, infrared (“IR”) sensors). According to some embodiments, some ICDs might have similar functionality as PDDs.

In various embodiments, presence detection can be local and/or cloud based. In the case of local presence detection, the PDD or ICD itself might keep a list of all user profiles and will attempt to match an individual against its local list of all users. In cloud based detection, the functionality of user detection can be moved into servers in the cloud. A cloud based approach allows detection of a user's presence to be mobile among various devices (whether or not owned by, and/or associated with, the user). That same user can be detected on his or her device or on any other device that has the same capability and that is tied into the same cloud infrastructure.

The ability to automatically detect the presence of an individual on any device presents a powerful new paradigm for many applications including automation, customization, content delivery, gaming, video calling, advertising, and others. Advantageously, in some embodiments, a user's content, services, games, profiles (e.g., contacts list(s), social media friends, viewing/listening/gaming patterns or history, etc.), videomail, e-mail, content recommendations, determined advertisements, preferences for advertisements, and/or preferences (e.g., content preferences, content recommendation preferences, notification preferences, and/or the like), etc. can follow that user from device to device, including devices that are not owned by (or previously associated with) the individual, as described in detail in the '279 application (already incorporated herein). Alternatively, or in addition, presence detection functionality can also allow for mobile presence detection that enables remote access and control of ICDs over a network, following automatic identification and authentication of the user by any device (e.g., PDD, ICD, or other device) so long as such device has authentication functionality that is or can be tied to the access and control of the ICDs, regardless of whether or not such device is owned or associated with the user. In other words, the ability to remotely access and control one's ICDs over a network can follow the user wherever he or she goes, in a similar manner to the user's content and profiles following the user as described in the '279 application. Such remote control of ICDs, as well as post-processing of video and/or image data captured by the ICDs, is described in detail in the '263 application (which is already incorporated by reference herein).

Various sensors on a PDD or an ICD (and/or a video calling device) can be used for user detection. Facial recognition can be used to identify a particular individual's facial characteristics, and/or voice detection can be used to uniquely identify a person. Additionally, PDDs, ICDs, and/or video calling devices may also have local data storage. This local data storage can be used to store a database of user profiles. The user profiles can contain the various mechanisms that can be used to identify a person, including username and password, facial characteristics, voice characteristics, etc. When sensors detect the facial features or capture the voice of a particular individual, that captured presence information can be compared against the characteristics of the users on the local storage. If a match is found, then the individual has been successfully identified by the device. (As used herein, the term “presence information” can be any data or information that can be used to determine the presence of a user, and/or to identify and/or authenticate such a user. As such, presence information can include raw image, video, or audio data, analyzed data (e.g., video or image data to which preliminary facial recognition procedures, such as feature extraction, have been employed, as well as verification of audio self-identification or verification of audio challenge/response information), the results of such analysis, and even the end result of the detection process—i.e., a notification that a user is present and/or an identification of the user.)

Detection of a user's presence can also be performed via proximity of a PDD, an ICD, and/or a video calling device to another device. For example, if a user's mobile phone, smart phone, tablet, or PC is near the PDD, the ICD, and/or the video calling device, that person is automatically detected. In some instances, a unique device identifier for each of a user's devices might have previously been associated with the user's profile in a cloud database or the like (i.e., making the user's devices “known devices”), and detection of such unique device identifiers might serve as a basis for identifying the user, or might streamline the identification process by verifying whether the person with the device owned by or associated with the known device is the user or simply someone in possession of the device(s) (whether lawful or unlawful). Such verification might comprise one or more of facial recognition, voice recognition, audio challenge/response verification, biometric analysis, or the like. In some cases, audio challenge/response verification might include analysis of sub-vocal responses from the person challenged, to prevent undesired casual overhearing of audio passwords, audio keyphrases, or the like. In some instances, biometric analysis might include analysis of any suitable biometric (aside from facial and voice recognition) selected from a group consisting of fingerprint, iris, pupil, height, unique scar(s), other unique physical characteristics, and/or any combination of these biometrics. To capture biometric information such as fingerprints, iris, pupil, height, scar, or other unique physical characteristics, which might be image-based biometrics (which might be captured by a high resolution image capture device of the PDD, the ICD, and/or the video calling device), the PDD, the ICD, and/or the video calling device might prompt the person being detected to position himself or herself so that his or her fingerprints, iris, pupil, full body, scar, or other unique physical characteristics, respectively, are appropriately facing the image capture device of the PDD and/or the ICD.

In some embodiments, with detection of known devices and with automatic detection/identification processes being enabled, it may be possible for the system to identify persons not normally associated with a known device being in possession of the known device. In such a case, the system might notify the original user (via e-mail or other forms of communication indicated in the user's profile, or the like) of the situation. In some instances, the user might indicate that the unknown person does have authority or permission to use, or be in possession of, the user's device. In other cases, where the user indicates that the user does not have authority or permission to use the device, the user may be given options to proceed, including, without limitation, options to lock data, options to lock device functions, options to activate location tracking (including, without limitation, global positioning system (“GPS”), global navigation satellite system (“GNSS”), etc.) of the device (in case the system loses track of the device; e.g., in the case the device moves outside the range of the system's sensor/detection/communications systems), options to contact the unknown person, options to activate speakers to emit sirens, options to activate displays or lights (e.g., light emitting diodes (“LEDs”), organic LEDs (“OLEDs”), liquid crystal displays (“LCDs”), etc.), and/or options to notify authorities (e.g., police or other law enforcement personnel) of the situation and/or the location of the device (e.g., GPS coordinates, or the like), etc.

Additionally and/or alternatively, proximity detection can be done using GNSS location tracking functionality, which can be found in many electronic devices and authenticating the user when the secondary device is within a predefined distance of the PDD, the ICD, and/or the video calling device. Proximity detection can also be done wirelessly via Bluetooth or WiFi. With respect to Bluetooth, if the secondary device pairs with the PDD, the ICD, and/or the video calling device, the user can be considered detected. With respect to WiFi, one approach could be to see if the secondary device associates with the same WiFi access point to which the PDD, the ICD, and/or the video calling device is connected. Another approach to proximity detection is the use of near-field communications (“NFC”) commonly found in many electronic devices. When the secondary device is within range of the PDD, the ICD, and/or the video calling device, a NFC detector can be used to determine that the user is in the room. From these examples, a skilled reader should appreciate that many different techniques can be used to detect presence based on device proximity.

According to some embodiments, regardless of the specific manner in which the user's electronic device, personal device, or user device is detected, presence may be determined or inferred by knowing the location of the personal device (which might include, without limitation, at least one of a laptop computer, a smart phone, a mobile phone, a portable gaming device, a desktop computer, a television, a set-top box, or a wearable computing device, and/or the like). When the personal device is close to the display device (or the PDD, ICD, and/or video calling device), it may be determined that the personal device (and hence the user associated with the personal device) is present. Based on the presence of the user and information about the user, advertisement content (which may be determined to be relevant to the user) may be sent to the display device. In this manner, a highly targeted advertising may be implemented (which may be embodied, in some cases, as a highly targeted form of television advertisement, which may be thought of as being similar to what is done on web browsers today, but much more targeted). From the user's perspective, when he or she is in the room, the advertisements on the display device (e.g., a TV or the like) may become customized to him or her (based on detection of the presence of the user and/or based on detection of the presence of his or her personal device, and, in some cases, based also on the user's profile, other information about the user, and/or the like). In some embodiments, the PDD/ICD/video calling device may be one of the personal device itself, a computer/server in the cloud, and/or the personal device in conjunction with some computer/server in the cloud, or the like. The advertisement may be sent to a local content source (e.g., an STB or the like) or another PDD/ICD/video calling device that has the ability to control content being played or sent to the display device (and/or, of course, to receive the advertisement from a content server). Such a method or apparatus may allow for the targeted presentation (or selling) of advertisements directly to the display device (e.g., TV or the like), based on characteristics of the user. In some cases, among other information about the user that can be taken into account, determination of advertisements to send to the display device might be based on, or might otherwise take into account, the user's Internet browsing history, the user's Internet browsing patterns, the user's Internet browser bookmarks/favorites, and/or the like.

In some embodiments, detection of an individual can be fully automatic and might (in some instances) require no user interaction. For example, the system can characterize an individual's facial features (and/or unique physical characteristics or other biometrics) automatically, detect the presence of a secondary device, characterize an individual's voice print automatically, etc. Several detection methods can be used in combination to reduce errors in the detection process. For example, if the system detects a person in the room and first identifies that person's facial features, it can then prompt them for voice (e.g., “Bob, is that you?”). Once the user's voice is captured, that audio sample can be compared against the stored voice characteristics for that user, to reduce false detection. Another approach for the second step may be to prompt the user to speak a PIN or password to be compared against what is stored in the user profile. Using this approach, the characteristics of the speech (e.g., user's voice, cadence, syntax, diction) and the content of the speech (e.g., a PIN or password) can be jointly used to reduce false detections. To prevent eavesdropping of passwords or PINs, the audio capture device might be configured to capture sub-vocalizations of the passwords or PINs, for analysis. Alternatively and/or additionally, the system can prompt the user to position his or her body so as to allow the image capture device to face one or more of the user's fingers (e.g., for fingerprint analysis), the user's eyes (e.g., for iris and/or pupil analysis), the user's full body (e.g., for height analysis), portions of the user's body (e.g., for analysis of scars or other unique physical characteristics, or the like), etc.

In some embodiments, physical geography can be used as a metric in detection to reduce the possibility of errors. For example, if a user is known to use the system in Dallas, Tex., and then is detected in Madrid, Spain, the system can weigh detection in Spain lower than detection in Dallas. Additionally, if the user is detected in Spain, a secondary authentication method may optionally be invoked to reduce false detection. According to some embodiments, in the case that the system has access to profile or other personal information of the user such as communications, calendar items, contacts list, travel/itinerary information, or the like that might indicate that the user might be visiting a friend or relative in Spain having a similar PDD, ICD, and/or video calling device linked to a common network or cloud server, the system might determine that the user is or will be in Spain. In such a case, the user's profiles, media content, preferences, content recommendations, determined advertisements, preferences for advertisements, or the like (or access thereto) might be sent to the friend's or relative's device in Spain or to a local data center or the like to allow the user to access the user's own content or profiles on the friend's or relative's device during the visit; in particular embodiments, the user's profiles might include access and control information for remotely accessing and controlling the user's ICDs over a network, while the user's content might include image data and/or video data captured by the user's ICDs (either in raw or processed form). After the scheduled visit, it may be determined using any combination of the user's personal information, the user's devices (including the user's PDD, ICD, and/or video calling device, mobile devices, etc.), and/or the friend's or relative's device whether the user has left the friend's or relative's location (in this example, Spain). If so determined, the content and profiles (or access thereto, as the case may be) might be removed from the friend's or relative's device (and/or from the data center or the like that is local to said device).

In particular embodiments, a PDD, an ICD, and/or a video calling device can also be connected to a network, such as the Internet. In such a scenario, the database of user profiles, including identifiable facial and/or voice characteristics, as well as other identifying information (e.g., passwords, identifying information for other devices owned by the user, etc.), can be stored on servers located in the cloud, i.e., on the network or in a distributed computing system available over the network. In some cases, the distributed computing system might comprise a plurality of PDDs, a plurality of ICDs, and/or a plurality of video calling devices in communication with each other either directly or indirectly over the network. The distributed computing system, in some instances, might comprise one or more central cloud servers linking the plurality of PDDs, the plurality of ICDs, and/or the plurality of video calling devices and controlling the distribution and redundant storage of media content, access to content, user profiles, user data, content recommendations, determined advertisements, preferences for advertisements, and/or the like. When an individual's facial features are detected by a PDD, an ICD, and/or a video calling device, those features (and/or an image captured by the PDD, the ICD, and/or the video calling device) can be sent to a server on the network. The server then can compare the identifiable facial features against the database of user profiles. If a match is found, then the server might inform the device of the identity of the user and/or might send a user profile for the user to the device.

User profiles, including facial characteristics, can be stored both locally on the device and on a server located in the cloud. When using both device-based and cloud-based databases, user identification can be performed by first checking the local database to see if there is a match, and if there is no local match, then checking the cloud-based database. The advantage of this approach is that it is faster for user identification in the case where the user profile is contained in the local database. In some embodiments, the database on the device can be configured to stay synchronized with the database in the cloud. For example, if a change is made to a user profile on the device, that change can be sent to the server and reflected on the database in the cloud. Similarly, if a change is made to the user profile in the cloud-based database, that change can be reflected on the device database.

Matching presence information or identifying information with an individual having a user profile can be a form of authentication in some embodiments. User profiles can also contain information necessary for many authentication mechanisms. Such information may include challenge/response pairs (such as username and password combinations, security question/pass phrase combinations, or the like), facial recognition profiles, voice recognition profiles, and/or other biometric information, such as fingerprints, etc. An individual may be authenticated using any combination of such techniques.

In some cases, the system can also determine when a user is no longer present. Merely by way of example, a PDD, an ICD, and/or a video calling device might continually (or periodically) monitor for the user's presence. For instance, in the case of facial recognition, the device can continually check to detect whether a captured image includes the user's face. With voice recognition, after a period of inactivity, the device might prompt the user if they are there (e.g., “Bob, are you still there?”).

According to some embodiments, user profiles can work across heterogeneous networks. Not all user devices need to be the same. Some user devices might be PDDs, ICDs, and/or video calling devices. Other user devices might be computers, tablets, smart phones, mobile phones, etc. Each device can use any appropriate method (based on device capabilities) to determine the presence of, identify, and/or authenticate the user of the device with a user profile.

In an aspect, this automated presence detection can be used to provide user information (e.g., content, content recommendations, determined advertisements, preferences for advertisements, and/or services) to an identified user. With a PDD, an ICD, and/or a video calling device, when a user enters the room, and the camera sensors detect that user's facial features (or other biometric features) and authenticates the individual, the content associated with that user profile (including, without limitation, profile information for handling media content, for handling content recommendations, for handling notification of content recommendations, for handling determination of advertisements, for handling presentation of advertisements, and/or the like) can automatically become available to that individual. Additionally, with the cloud-based authentication approach described herein, that user's content, content recommendations, determined advertisements, preferences for advertisements, and/or profiles can become available on any device. More specifically, if a user is identified by another PDD, ICD, and/or video calling device, then his or her content (e.g., media content, and/or the like), content recommendations, determined advertisements, preferences for advertisements, profiles, etc., become available to him or her even if the PDD, ICD, and/or video calling device that he or she is in front of is not the user's own device. This functionality allows a new paradigm in which the user's content, content recommendations, determined advertisements, preferences for advertisements, and/or profiles follow the user automatically. Similarly, when upgrading PDDs, ICDs, and/or video calling devices, detection, identification, and authentication of the user on the new device can allow automatic and easy porting of the user's content, content recommendations, determined advertisements, preferences for advertisements, and/or profiles to the new device, allowing for an ultimate type of “plug-and-play” functionality, especially if the profiles include information on configurations and settings of the user devices (and interconnections with other devices).

PDDs, ICDs, and/or video calling devices also are capable of handling, transmitting, and/or distributing image captured content, which can include, but is not limited to, video mail and/or video mail data captured or recorded by the video calling devices. In some cases, the video mail and/or video mail data might be raw data, while in other cases they might be post-processed data. Video mail and/or video mail data can be stored on servers in the cloud, on PDDs, ICDs, and/or video calling devices in the cloud, and/or locally on a particular user device. When accessing video mail and/or video mail data from another device, the first PDD and/or video calling device that has the video mail and/or video mail data stored thereon needs to serve the video mail and/or video mail data to the new device that the user is using. In order to do this, the new PDD, ICD, and/or video calling device might need to get a list of video mail and/or video mail data that is stored on the first PDD and/or video calling device. This can, in some embodiments, be facilitated via a server that is in the cloud that all PDDs, ICDs, and/or video calling devices are always or mostly connected to. The server can communicate with all PDDs, ICDs, and/or video calling devices and help send messages between PDDs, ICDs, and/or video calling devices. When a user is authenticated with a new PDD, ICD, and/or video calling device, the new device can request the list of video mail and/or video mail data from the first device. If the user requests video mail and/or video mail data from the new device, then the first PDD, ICD, and/or video calling device (or the other user device) can serve the video mail and/or video mail data to the new device. This can be done either directly in a peer-to-peer fashion or can be facilitated by the server. In some embodiments, this communication can be accomplished by using protocols such as XMPP, SIP, TCP/IP, RTP, UDP, etc. Videomail capture, processing, and distribution is described in detail in the '499 application, which is already incorporated herein by reference.

As discussed above, identification and authentication of a user by a PDD, an ICD, and/or a video calling device (whether or not associated with or owned by the user) can provide the user with remote access and control of the user's PDD(s), ICD(s), and/or video calling device(s) over a network (e.g., by porting the user's profiles associated with remote access and control of the user's device(s), and/or the like to the current PDD, ICD, and/or video calling device in front of which the user is located). This functionality allows the user to remotely access media content, to remotely access and modify settings for content recommendations, to remotely access and modify settings for advertisements, and to remotely access and modify user profiles, and/or the like.

Master Account

Some embodiments employ a master account for access to a video calling device. In an aspect, a master account can be created on a per user basis. This master account might serve as the top-level identifier for a particular user. In some cases, the master account may be used to manage, control, and monitor a user's camera(s) and/or other device functionalities (whether hardware and/or software-based). Additionally, the master account can be used to control any account or device level services that are available.

For example, an email account and password can be used as a master account to manage a user's settings for accessing media content, for accessing and modifying settings for content recommendations, for accessing and modifying settings for advertisements, and for accessing and modifying user profiles, and/or the like.

Device Association

For proper management and control of a PDD, ICD, and/or video calling device, some embodiments provide the ability to reliably associate a PDD, ICD, and/or video calling device with a master account (i.e., assign the device to the master account). When a PDD, ICD, and/or video calling device is associated with an account, then it can be managed and controlled from within the master account. Association ensures that a PDD, ICD, and/or video calling device is being controlled by the appropriate user and not an unauthorized user.

A PDD, ICD, and/or video calling device may be associated with a particular master account at the time of the device setup. During device setup, the user is prompted to enter a master account and password. When doing so, a secure communications channel may be opened up between video calling device and servers. Then, a unique and difficult to guess key can be sent from the device to the server. Servers that have a master list of all keys then can associate that particular device, via its serial number, to a particular master account. A feature of this approach is that a user only needs to enter a password at the time of device setup. The user never needs to enter a password again, and in fact, passwords do not need to be stored on the device at all, making them very secure.

Device Management and Remote Configuration

Once a device has been associated with a master account, it may be managed from the master account via an interface such as a web interface, in accordance with some embodiments. The communication link between the device and server may, in some cases, be always encrypted and authenticated. This ensures that messages between device and server are secure and ensures that the device knows it is communicating with the server on behalf of the appropriate master account. Once the secure and authenticated link is established, devices can connect to the server and are able to send and receive commands.

The device and server can have a common set of command codes and responses. Servers can send commands down to the camera(s) to enact specific behavior. For example, the server can send remote configuration commands. These commands can be items such as changing the device address, changing the nickname that is associated with the device, changing the avatar image associated with the device. In addition to configuration, the commands can be used to enact specific behavior on the device, such as running network tests, or taking a live image(s) from the video calling device. New commands and features can be added by extending the set of command codes on the device and server.

Media Content Recommendation

PDDs, ICDs, and/or video calling devices also are capable of determining and/or generating media content recommendations, based on a number of factors. In some cases, the factors might include, without limitation, what the user is viewing, listening to, and/or playing, what friends of the user (e.g., known friends, social media friends, and/or the like) are viewing, listening to, and/or playing, trending media content, reactions of the user to media content, etc.

By analyzing what users are viewing, the various systems are able to determine what programs and television stations are of particular interest to particular users. This information can then be provided to the particular users, thereby helping them to find programs that are most interesting to them, in a timely fashion. The various embodiments include various methods and systems for determining what users are watching, various methods and systems for analyzing the collected data to determine trends, and/or various methods and systems for providing information to users to help guide their viewing, listening, and/or gaming experience.

In some embodiments, a PDD might connect to a server via an Internet connection. The server may be thought of as being in the cloud. In some cases, the PDD might also provide a pass-through connection between a set top box (“STB”; or other local content source) and a display device (e.g., a television or TV; which in some cases might have audio output capabilities), in some instances via high-definition multimedia interface (“HDMI”) cable connections or similar cable connections; that is, media content that is received from the STB is sent to the PDD and the PDD then passes that media content to the TV. In some cases, the PDD might modify the signals carrying the media content to enhance or add additional content and/or information prior to output of the media content. The PDD might monitor content coming from the STB and might determine what the content is. Alternatively, or additionally, the PDD might monitor content received through the network (e.g., Internet), which may not necessarily be sent from the STB. The PDD might subsequently provide the monitored data or information to the server for analysis. The server might analyze the monitored data or information from many PDDs and might form or generate recommendations of media content. These recommendations might then be provided to individual PDDs, which might make the recommendations to the user (i.e., by displaying or otherwise presenting the recommendations to the user). In some cases, the recommendation to the user may be via audio and/or video notice, and the recommendation may be made by passing the audio and/or video notice to the TV. Alternatively, or additionally, the recommendation to the user may be via e-mail message, text message, chat message, short message service (“SMS”) message, multi-media messaging service (“MMS”) message, videomail message, voicemail message, and/or other messaging communications.

Media content recommendations and generation thereof (in some cases, based on trend estimation) is described in detail in the '435 application, which is already incorporated herein by reference.

Advertising Based on Physical Presence

Various methods allow for analyzing programming to determine advertisements based on presence information of a user. Further, by analyzing what users are viewing, the various systems are able to determine what programs and television stations are of particular interest to particular users. This information can then be provided to advertisers, thereby helping them to find, generate, or create advertisements that are most interesting to the user, preferably in a timely fashion (so as to not be out of date with what the user is currently interested in). The various embodiments include various methods and systems for determining what users are watching, various methods and systems for analyzing the collected data to determine trends, and/or various methods and systems for determining and providing advertisements to users that are relevant to the user.

In some embodiments, a PDD might connect to a server via an Internet connection. The server may be thought of as being in the cloud. In some cases, the PDD might also provide a pass-through connection between a set top box (“STB”; or other local content source) and a display device (e.g., a television or TV; which in some cases might have audio output capabilities), in some instances via high-definition multimedia interface (“HDMI”) cable connections or similar cable connections; that is, media content that is received from the STB is sent to the PDD and the PDD then passes that media content to the TV. In some cases, the PDD might modify the signals carrying the media content to enhance or add additional content (including advertisements) and/or information prior to output of the media content. The PDD might monitor content coming from the STB and might determine what the content is. Alternatively, or additionally, the PDD might monitor content received through the network (e.g., Internet), which may not necessarily be sent from the STB. The PDD might subsequently provide the monitored data or information to the server for analysis. The server might analyze the monitored data or information from many PDDs and might determine advertisements that are relevant to the user. These advertisements might then be provided to individual PDDs, which might present the advertisements to the user (i.e., by displaying or otherwise presenting the advertisements to the user). In some cases, the advertisements may be presented via audio and/or video notice, and the advertisements may be made by passing the audio and/or video notice to the TV. Alternatively, or additionally, the advertisements may be presented via e-mail message, text message, chat message, short message service (“SMS”) message, multi-media messaging service (“MMS”) message, videomail message, voicemail message, and/or other messaging communications.

While the analysis function may be performed in the PDD, it is most typically performed in the server that is connected to the PDD over the Internet or other network. In some cases, there may be multiple PDDs (although multiple PDDs is not a requirement). The PDDs have the ability to monitor programming from their respective STB or local content source. The PDDs may also monitor content that are played directly from the Internet (e.g., from YouTube™ or some other media content source (e.g., an audio, video, and/or gaming content source)).

In some embodiments, data from the PDDs (some of which might be monitored by the PDDs) may be stored in a database, and the data may be accessed by the server (which might include an analysis server(s)). The server may then take into account various factors to calculate, determine, or generate an advertisement(s) that is(are) customized to a user or a group of users. Example factors might include, without limitation, age factor of a media content, trending quotient or characteristic of the media content, geographical factor of the media content, topic of the media content, and so on.

In some cases, the factors might include other media content-based information, audience-based information, and/or the like. In some embodiments, other media content-based information might include, without limitation, at least one of type of media content of the media content that is presented to the user and monitored by the PDD (herein, referred to as “first media content”), genre of media content of the first media content, duration of media content of the first media content, time of day that the first media content is received and/or presented (which may be determined using network time protocol (“NTP”) or the like), performers (e.g., actors, actresses, singers or vocalists, band members, musicians, orchestras, voice artists, etc.) associated with the first media content, producers (e.g., directors, film/video/music/game producers, game developers, artists, etc.) associated with the first media content, year of release of the first media content, reviews (e.g., by industry-based critics or by average viewers/listeners/gamers/etc.) of the first media content, and/or other media content related to the first media content. In some instances, audience-based information might include, but is not limited to, at least one of number of audience members present during presentation of particular portions of the first media content, identity of each audience member, gender of each audience member, age of each audience member, demographic group to which each audience member belongs (i.e., other than age or gender, which might include, without limitation, at least one of ethnicity, culture, language-proficiency, location, socio-economic grouping, income, political leanings, and/or the like), viewing patterns of each audience member, specific reactions of each audience member during presentation of particular portions of the first media content, overall reactions of each audience member throughout presentation of the first media content, consistency of audience member reactions of each audience member compared with personal preferences of the audience member, consistency of audience member reactions of each audience member compared with past reactions of the audience member, and/or the like.

Although a number of factors are listed above, not all these listed factors need be taken into account. In some instances, different weightings might be given to one or more of these factors, as appropriate or as desired. In some cases, the different weightings might be determined through iterative processes based on past decisions by the user, viewing/listening/playing patterns of the user, and/or the like, in order to better tailor or otherwise more effectively determine advertisements relevant to the user.

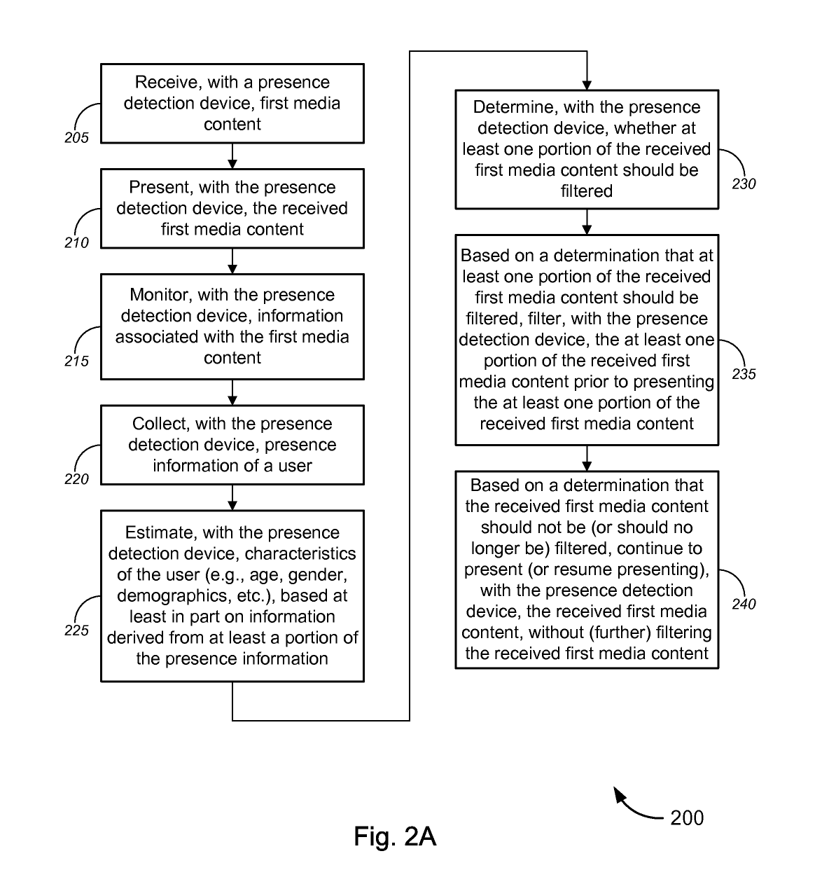

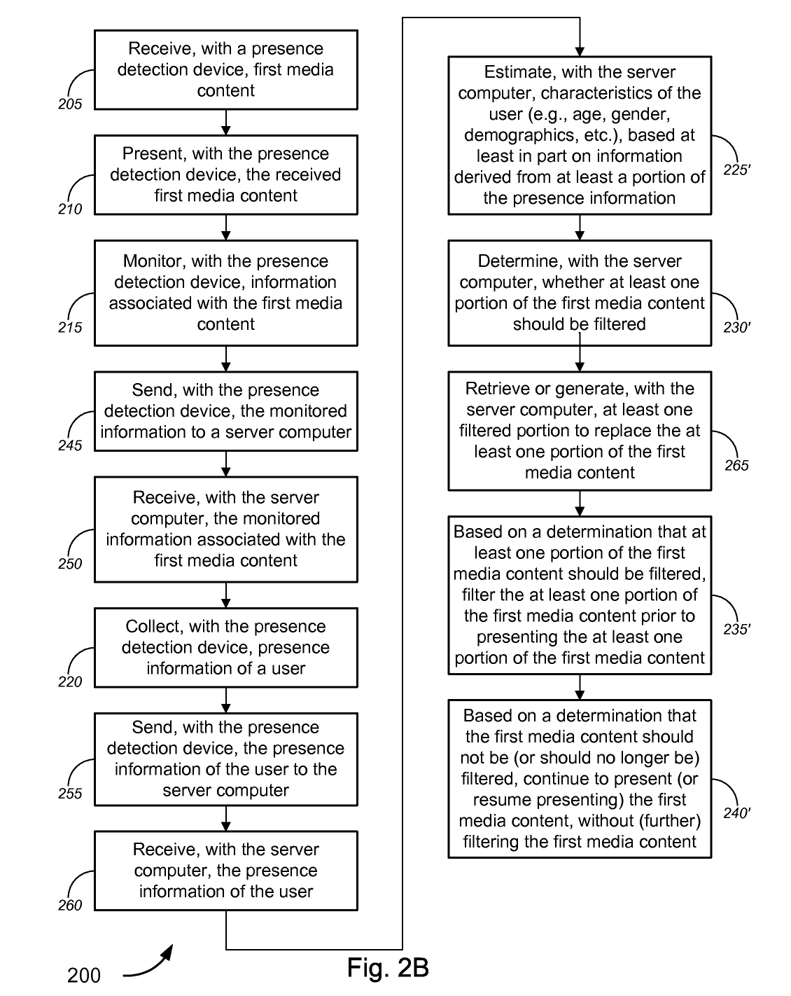

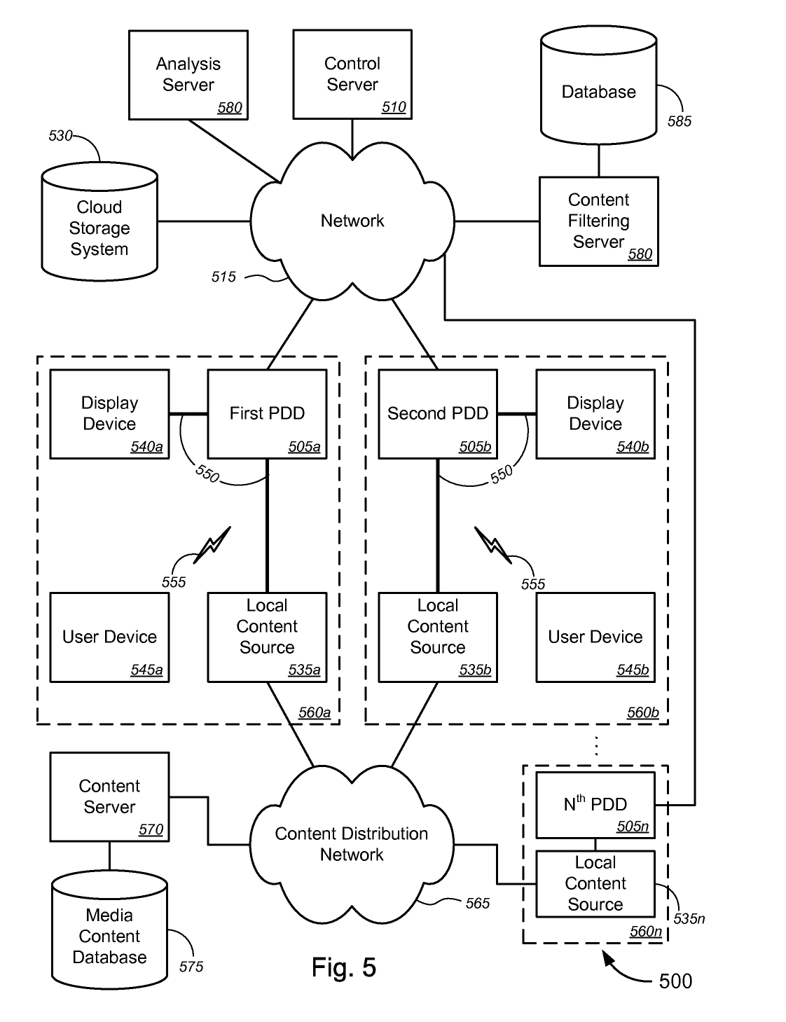

After determining the advertisements, the advertisements may be sent to the PDD and may be presented to the user. In some cases, the advertisements may be displayed on the TV by overlaying video on top of the video coming from the STB. Various configurations for such overlay is described in detail with respect to FIGS. 2 and 5 below. In some instances, audio advertisements may similarly be sent to the TV or other audio output device (e.g., speakers, etc.), either in conjunction with or separate from the video advertisements. According to some cases, any audio advertisements may be overlaid on top of currently presented audio, overlaid on top of a muted currently presented audio, played instead of currently or normally presented audio, or the like.

In some cases, the PDD might present advertisements together with an audio prompt (in some instances, accompanied by a video prompt). The PDD might play these audio prompts (possibly using text-to-speech technology) via the TV, via an audio output device (e.g., speaker) on the PDD, and/or via some other connected audio output device. Using a microphone (which, in some cases, might be built into the PDD), the device can obtain feedback from the user, and such feedback can be sent to advertisers and/or stored by the system to enhance future determinations of advertisements for the user.

In some embodiments, the PDD may also interface with (or have integrated therein) a camera or other video/image capture device. The camera may be used to determine the number of people in the room, as well as the mood, gender, age, identity, etc., of each person. As discussed above, these characteristics may be used to determine (or in some cases, optimize determinations of) advertisements.

Merely by way of example, in some embodiments, as part of the user's profile or options in the user's profile, the user may be given the option to opt in or opt out of having his or her data monitored or otherwise used in the determination of advertisements for him/her and/or for others.

According to some embodiments, inline cameras (which in some cases can be a stand-alone device or a device embodied in another suitable device including, but not limited to, a PDD as discussed above, or a video calling device, and/or the like) can also contain cameras, microphones, and other sensors. These sensors, in conjunction with the internal processing capability of the device allow the device to know when someone is in room. Additionally, the devices can also recognize who is in the room. They can also tell if users are actually looking at the television. These capabilities allow for very customized advertising based on whether someone is in the room, the identity of the person(s) in the room, and if they are looking at the TV. For example, the ability to determine whether someone is looking at the TV is a very useful tool for advertising, as it allows for feedback and the ability to determine whether advertising is effective. Inline cameras can use this to customize advertising for a particular user and to gauge the effectiveness of ads for advertisers.

In some embodiments, inline cameras can also determine the content of the audio/visual (“A/V”) stream that is coming from a set-top box (“STB”) or other local content source. This can be done in a number of ways. One way in which content can be identified is to search for watermarks that are often embedded in the audio/video stream itself. Watermark identification can be accomplished by using the processor in the inline camera to search for a known audio and/or video pattern that is embedded in the stream. The watermarks may be perceptible or imperceptible to users that may be watching the content. Once the watermark is identified, the channel or content that the STB is set to can be identified. According to some embodiment, rather than (or in addition to) the audio and/or video watermarks embedded in the stream, the watermarks might include digital watermarks that might be embedded in the stream; such digital watermarks might include headers, footers, or data packets embedded between headers and footers that provide identification information regarding the A/V stream and/or content source.

Another approach to determining the content of the STB is classify the source of the content in the A/V stream itself by searching either for keywords, phrases that can be used for identification purposes or by “fingerprinting” the A/V stream and comparing the fingerprint against a database of fingerprints that are either local to the inline camera or on a network (such as on a control server, as described below). By determining the content coming from the STB, inline cameras can overlay advertising that is relevant to the A/V source that is coming from the STB. For example, if a user is watching a football game, then advertising relevant to the situation (i.e., the name of a local pizza shop that delivers to the user's home, deals for football memorabilia or team merchandise for the user's preferred team(s), etc.) can be displayed.

In other embodiments, inline cameras with cameras (or other sensors) also have an advantage over typical broadcast type advertising. The sensors on such devices know when users are in the room. The timing of when advertising can be set specifically to when someone is known (or detected and identified) to be in the room. In this manner, the likelihood of ads being viewed is much higher than broadcast advertisers are typically accustomed to. Further, inline cameras with cameras can determine not only that someone is in the room, but they can also determine who is in the room, using their sensors and facial recognition capability, or the like. This information allows for much more targeted type of advertising, because a particular user's profile and personal preferences can be used for advertising. For example, an adult male watching a football game can be shown a particular ad, while a female child watching the same show can be shown something entirely different. Additionally, when groups of people are in the room, ads that best fit the demographic of the people in the room can be shown. For example, when a device detects 3 adult females in the room and 2 male children, the system might determine to target the adult females.

In another aspect, some inline cameras can also determine whether or not a user is actually watching the television using its cameras and the facial recognition/eye tracking technology. This capability can be used to determine whether or not a user is watching or has watched a particular advertisement that is being displayed. This type of feedback is invaluable to advertisers, as it provides information that can be gathered and analyzed. The statistics can be given or sold back to advertisers who can then gauge the effectiveness of their ads. Somewhat similarly, inline cameras can also use the fact that they know when someone is watching to help determine when to display ads. The timing of ads can be done based on whether someone is actually watching the television or based on who is watching the television. For example, ads can be displayed when anyone is watching a particular show, or only when adults over the age of 40 are watching a particular show, and so on.

Physical presence can also be used to create enhanced placements for TV ads. Ads placements can be sold to advertisers based on (i) whether users are confirmed to be in the room or not, (ii) based on the number of users in the room, (iii) demographic profile of user in the room, (iv) number of users in the room, (v) whether a particular individual is in front of their TV, (vi) whether a user has watched a particular ad or not, (vii) what content a user is watching, (viii) time of day an ad is played, etc.

Determination and/or generation of advertisement deemed relevant to a user(s) (in some cases, based on trend estimation) is described in detail in the '133 and '603 applications, which have already been incorporated herein by reference.

Automatic Content Filtering

PDDs, ICDs, and/or video calling devices also are capable of detecting or collecting presence information of one or more users for the purposes of content filtering or censoring. Based on such presence information, a server and/or the PDDs, ICDs, and/or video calling devices can determine whether at least one portion of the content should be filtered. Such determination may be based on any combination of the following: (a) user preferences in user profiles of each detected and/or identified user; (b) identified specific portions of media content (i.e., video content, image content, game content, and/or audio content, or the like) that are indicated in a database as being potentially offensive or objectionable (either to the specific detected and/or identified users, to a demographic group(s) to which the users belong, or to people within certain communities, localities, or regions, or the like); (c) user input (either prior to or contemporaneous with presentation of the media content; e.g., including, button inputs on a remote controller, gesture control, or voice input (e.g., “Computer, Pause!”; “Biscotti, Censor!”; “Biscotti, Stop!”; and/or a preset keyphrase; or the like)), from a detected user or another user (e.g., a parent or guardian of the detected user), who may or may not be present or detected, indicating that the at least one portion of the media content should be filtered; (d) analysis by the system of the media content being presented to identify potentially offensive or objectionable content (either prior to presentation of the media content or as the media content is being presented); and/or the like. In some cases, the database might store marked locations of potentially offensive content as identified by the user or marked locations of potentially offensive content as compiled from a plurality of users (not unlike a crowd-sourced compilation of information or the like). Herein, “filtering” media content may refer to (and can include without limitation) any form of modification in the presentation of the media content including, but not limited to, blocking, filtering, pausing, replacing, hiding, skipping, removing, and/or the like, at least portions of the media content.

Based on a determination that at least one portion of the media content should be filtered, the server and/or the PDDs, ICDs, and/or video calling devices may implement filtering of the at least one portion of the media content. In some embodiments, implementing filtering of content can include, but is not limited to one or more of: (i) blanking determined portions of video or game content, while audio content (if not inappropriate or offensive) continues to be presented; (ii) pausing portions of video or game content just prior to the determined portions of video or game content, while audio content (if not inappropriate or offensive) continues to be presented; (iii) replacing entire scenes in video or game content with replacement scenes that do not include offensive or objectionable content (in some cases, using a “clean version” of the content provided by the content provider rather than the “uncut version” or the like); (iv) skipping entire scenes in video or game content rather than presenting potentially offensive or objectionable content; (v) replacing portions of video content, image content, audio content, and/or game content with replacement content; and/or the like. In some cases, replacement content might include, without limitation, polygons (which may be colored as appropriate to standout or to blend with the remainder of the content), pixelated images, blurred images, smiley faces, predetermined images (which may or may not be customized to the media content, to subject matter related to the media content, to the user, etc.), random images, tones (e.g., 1 kHz tone or the like), bleeps, muted audio clips (i.e., clips in which the sound has been lowered in volume, within a range of minimally lowered through lowered to a point of imperceptibility by a human), audio blanks (i.e., soundless or quiet audio clips; which differs from muted audio clips in that the clip of the audio blanks contains no sound, as compared with adjustably lowered sound volume level, or a set (or pre-set) sound volume level, as in muted audio clips), replacement words, and/or the like. In some instances, replacement words may be matched, in terms of the gender, age, nationality, accent, and/or characteristics of a speaker of the potentially offensive words. For example, a male character in a movie having a French accent might say a potentially offensive word (e.g., a swear word or other foul language). In such a case, replacement words might be modulated or generated to mimic the male character's French accent and vocal characteristics to substitute the offensive word with a more acceptable (i.e., less offensive or non-offensive) word.

In some embodiments, inline cameras can also determine the content of the audio/visual (“A/V”) stream that is coming from a set-top box (“STB”) or other local content source. This can be done in a number of ways. One way in which content can be identified is to search for watermarks that are often embedded in the audio/video stream itself. Watermark identification can be accomplished by using the processor in the inline camera to search for a known audio and/or video pattern that is embedded in the stream. The watermarks may be perceptible or imperceptible to users that may be watching the content. Once the watermark is identified, the channel or content that the STB is set to can be identified. According to some embodiment, rather than (or in addition to) the audio and/or video watermarks embedded in the stream, the watermarks might include digital watermarks that might be embedded in the stream; such digital watermarks might include headers, footers, or data packets embedded between headers and footers that provide identification information regarding the A/V stream and/or content source. In some embodiments, markers, other than watermarks, may be included in video, audio, and/or side channels or streams to indicate portions of the content as being one or more of content to be filtered for a first group of users (e.g., child users or the like), content to be filtered for a second group of users (e.g., adult users that have indicated in user profiles and/or past actions that certain content should be filtered), replacement content, alternative replacement content, and/or the like. In some cases, watermarks, whether perceptible or imperceptible, may be a type of marker.

Another approach to determining the content of the STB is classify the source of the content in the A/V stream itself by searching either for keywords, phrases that can be used for identification purposes or by “fingerprinting” the A/V stream and comparing the fingerprint against a database of fingerprints that are either local to the inline camera or on a network (such as on a control server, as described below). By determining the content coming from the STB, inline cameras can overlay advertising that is relevant to the A/V source that is coming from the STB. For example, if a user is watching a football game, then advertising relevant to the situation (i.e., the name of a local pizza shop that delivers to the user's home, deals for football memorabilia or team merchandise for the user's preferred team(s), etc.) can be displayed. In some cases, “fingerprinting” may be a type of marker.

In some embodiments, markers may indicate the nature of (the portion of) the media content at any point in time. For example, markers can indicate ratings (e.g., PG-13, PG, M, R, etc.) for the overall media content and/or for each of particular portions of the media content. Markers, according to some embodiments, can also include a more fine grained indicator indicating the nature (and not simply an abstract rating) of the content for each of particular portions of the media content and/or at any point in time. In some instances, the nature of the content being indicated by the marker might include, without limitation, suggestive sexual content, explicit sexual content, partial nudity, full nudity, violent content, coarse or offensive language, and/or the like. In some embodiments, if the markers are not concurrently presented with the media content or not embedded in the media content, the particular portions and particular locations in the media content of the different natures of the portions of the media content may also be included. In some cases, such markers (including, without limitation, overall rating, particular rating, and/or fine grained indicator, etc.) may be used to convey information about at least portions of the media content, and in some cases, might be implemented in side channels or streams that are concurrently broadcast or streamed together with the channel or stream in which the media content is broadcast or streamed. In some cases, these markers (e.g., overall rating, particular rating, and/or fine grained indicator, etc.) may be imbedded within the media content being presented.

In some embodiments, it may further be determined whether to stop filtering the media content. For example, when a child user's presence is detected, filtering may be determined and implemented. However, when the child user leaves the room, and no other person left in the room would be offended by the potentially offensive content, then presentation of the original unfiltered media content may be resumed, without further filtering of the media content (unless the child user returns or someone known to be offended by the content enters the room, to name a few non-limiting examples). In some cases, resumption of presentation of the unfiltered content may be automatic, while in alternative cases the remaining user(s) might enter user inputs to resume presentation (e.g., voice input (such as “Computer, resume!”; “Biscotti, unfilter!”; or other preset keyphrases; or the like); button input on a remote controller; gesture input; and/or the like). Alternatively, although it may be determined that a majority of the people in a particular community might find a particular word to be offensive, and filtering may be appropriate for those people, a person whose presence is detected by the system might have previously indicated that she does not find that particular word to be offensive. Based on such determination, if no potentially offended person's presence is also detected, presentation of the media content containing that particular word may be presented (from the beginning or as a whole) without any filtering of the media content to censor that particular word.

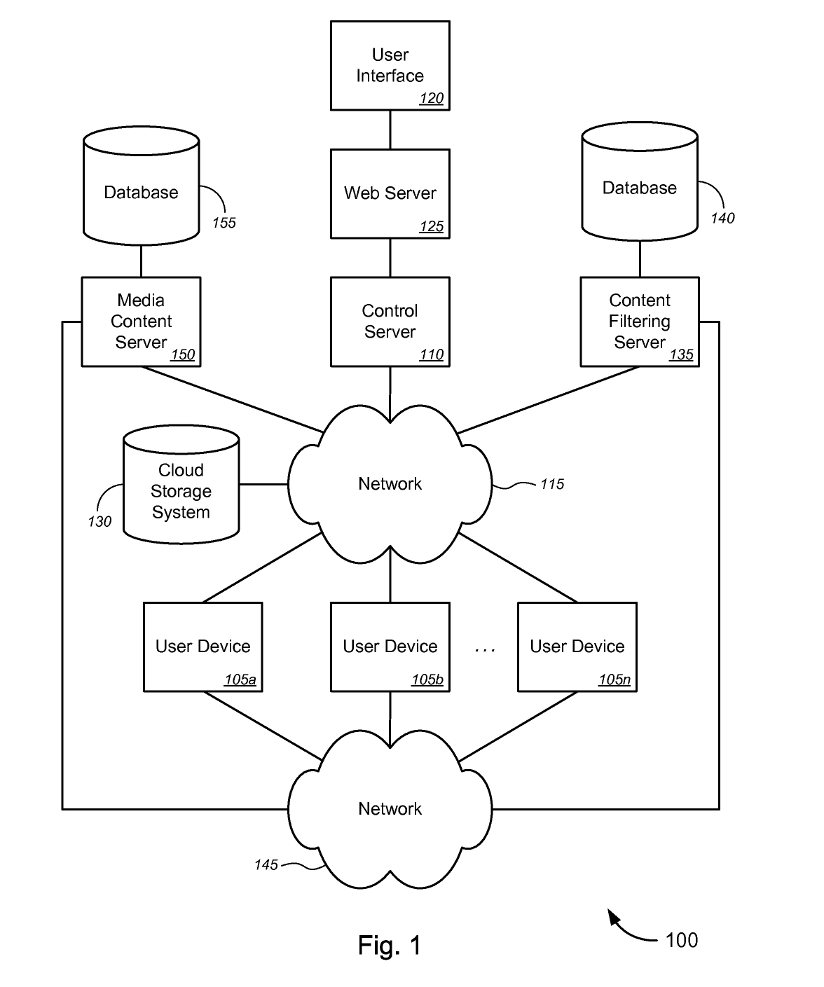

These and other content filtering techniques and implementations are described in detail below with respect to FIGS. 1-7.

### Exemplary Embodiments

FIGS. 1-7 illustrate exemplary embodiments that can provide some or all of the features described above. The methods, systems, and apparatuses illustrated by FIGS. 1-7 may refer to examples of different embodiments that include various components and steps, which can be considered alternatives or which can be used in conjunction with one another in the various embodiments. The description of the illustrated methods, systems, and apparatuses shown in FIGS. 1-7 is provided for purposes of illustration and should not be considered to limit the scope of the different embodiments.

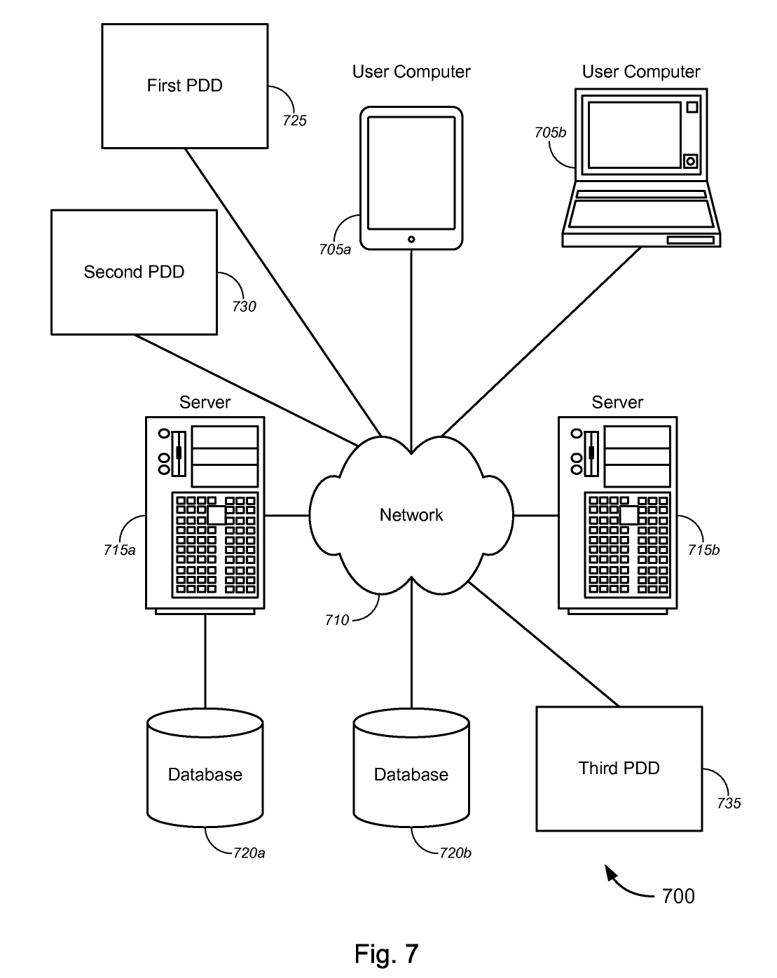

FIG. 1 illustrates a functional diagram of a system 100 for controlling one or more presence detection devices (“PDDs”), one or more image capture devices (“ICDs”), and/or one or more video calling devices (labeled user devices 105 in FIG. 1 for ease of illustration, but described herein as PDDs, ICDs, or video calling devices, each of which can be considered a type of user device). The skilled reader should note that the arrangement of the components illustrated in FIG. 1 is functional in nature, and that various embodiments can employ a variety of different structural architectures. Merely by way of example, one exemplary, generalized architecture for the system 100 is described below with respect to FIG. 7, but any number of suitable hardware arrangements can be employed in accordance with different embodiments.

An ICD 105, a video calling device 105, or a PDD 105 can be any device that is capable of communicating with a control server 110 over a network 115 and can provide any of a variety of types of advertisement determination functionality, content recommendation functionality, video communication functionality, presence detection functionality, content filtering determination functionality, content filtering functionality, and/or the like. Merely by way of example, in some aspects, an ICD 105, a video calling device 105, or a PDD 105 can be capable of providing pass through video/audio to a display device (and/or audio playback device) from another source (such as a local content source), and/or overlaying such video/audio with additional content generated or received by the ICD 105, the video calling device 105, or the PDD 105. In other aspects, an ICD 105, a video calling device 105, or a PDD 105 can comprise one or more sensors (e.g., digital still cameras, video cameras, webcams, security cameras, microphones, infrared sensors, touch sensors, and/or the like), and/or can be capable, using data acquired by such sensors, of sensing the presence of a user, identifying a user, and/or receiving user input from a user; further, an ICD 105, a video calling device 105, or a PDD 105 can be capable of performing some or all of the other functions described herein and/or in any of the Related Applications. Hence, in various embodiments, an ICD 105, a video calling device 105, or a PDD 105 can be embodied by a video calling device, such as any of the video communication devices (“VCDs”) described in the '182 patent, a video game console, a streaming media player, to name a few non-limiting examples.

In one aspect of certain embodiments, as described more fully with respect to FIG. 5 below (or as described in the Related Applications), an ICD 105, a video calling device 105, or a PDD 105 can be placed functionally inline between a local content source and a display device. A local content source can be any device that provides an audio or video stream to a display device and thus can include, without limitation, a cable or satellite set-top box (“STB”), an Internet Protocol television (“IPTV”) STB, devices that generate video and/or audio, and/or acquire video and/or audio from other sources, such as the Internet, and provide that video/audio to a display device; hence, a local content source can include devices such as a video game console, a Roku® streaming media player, an AppleTV®, and/or the like. When situated functionally inline between a local content source and a display device, the ICD, the video calling device, or the PDD can receive an audiovisual stream output from the local content source, modify that audiovisual stream in accordance with the methods described herein, in the '182 patent, and/or in the '279 application, and provide the (perhaps modified) audiovisual stream as input to the display device. It should be noted, however, that, in some cases, the functionality of a local content source can be incorporated within an ICD, a video calling device, or a PDD, and/or the functionality of an ICD, a video calling device, or a PDD can be incorporated within a local content source; further, it should be appreciated that an ICD, a video calling device, or a PDD (which might or might not include local content source functionality) can be disposed inline with one or more other local content sources or one or more other video calling devices/PDDs. Hence, for example, an ICD, a video calling device, or a PDD with some local content source functionality (such as a video game console) might be disposed inline between one or more other local content sources or one or more other ICDs/video calling devices/PDDs (such as a cable STB, satellite STB, IPTV STB, and/or a streaming media player) and a display device.

In an aspect of some embodiments, the system can include a software client that can be installed on a computing device (e.g., a laptop computer, wireless phone, tablet computer, etc.) that has a built-in camera and/or has a camera attached (e.g., a USB webcam). This client can act as an interface to allow remote control of the built-in and/or attached camera on the computing device. In some embodiments, the computing device might have a built-in microphone(s) and/or has a microphone(s) attached (e.g., a table-top microphone, a wall-mounted microphone, and/or a microphone removably mountable on a television, on the ICD, on the video calling device, on the PDD, and/or on some other suitable user device, or the like). The software client can alternatively and/or additionally act as an interface to allow remote control of the built-in and/or attached microphone on the computing device. In some cases, the camera and/or microphone can be automatically or autonomously controlled to obtain optimal video and/or audio input. Remote control of the video calling device and/or PDD is described in detail in the '263 application (already incorporated herein), and may be similarly applicable to remote control of the ICD.

The system 100 can further include a control server 110, which can have any suitable hardware configuration, and an example of one such configuration is described below in relation to FIG. 7. In one aspect, the control server 110 is a computer that is capable of receiving user input via a user interface 120 and/or performing operations for utilizing the ICD(s) 105, the video calling device(s) 105, and/or the PDD(s) 105 to perform one or more of receiving (and relaying) media content (either directly from media content server 150 or database 155 via network 115 or network 145, indirectly via a local content source (e.g., an STB or the like), directly from cloud storage system 130, and/or the like), monitoring the media content presented to the user(s), monitoring the user(s), sending the monitored data to the control server 110, determining (with the control server 110 and/or with one or more of the user devices 105) whether at least one portion of the media content should be filtered, filtering (with the control server 110 and/or with one or more of the user devices 105) the at least one portion of the media content based on such determination, and/or the like.

In some cases, the control server 110 might handle all of the processes for identifying and authenticating users and for providing access to the user(s)'s profiles, content, information, recommendations, advertisements, preferences (including, without limitation, preferences for types of content to filter, preferences for how to filter content, and other user preferences, etc.), as well as handling the processes involved with determining whether at least one portion of media content should be filtered or filtering the at least one portion of the media content based on such determination. Alternatively, or additionally, the processes involved with determining whether at least one portion of media content should be filtered or filtering the at least one portion of the media content based on such determination might be handled by a separate server computer (denoted Content Filtering Server 135 in FIG. 1), which might store determined, generated, and/or collected information in database 140. In other instances, control server 110 and content filtering server 135 might split the processing tasks in any suitable manner, as appropriate. In some cases, content filtering server 135 might also generate filtered content (for replacing potentially offensive or objectionable content), and such generated filtered content may be stored in database 140.

Merely by way of example, in some embodiments, the control server 110 can detect user presence, identify/authenticate users, and/or enable the user to remotely access the user's master account, user preferences, media content, recommendations of media content, advertisements, preferences for advertisements, preferences for what type of content to filter or censor, preferences for how to filter or censor content, preferences for filtering content for particular members of the user's family, and/or the like. In other cases, the control server 110 can receive and/or store user input and/or user preferences that can specify whether and how presence information should be used, whether and how the user's ICD(s), video calling device(s), and/or PDD(s) may be used in a distributed infrastructure, whether and how the user's content and profiles should be handled under certain situations, and/or the like.

For example, preferences might specify which account information, content, profile information, personal communications (e.g., videomail, voicemail, e-mail, etc.), media content, media content recommendations, determined advertisements, preferences for advertisements, preferences for what type of content to filter or censor, preferences for how to filter or censor content, preferences for filtering content for particular members of the user's family, and/or the like should be delivered to a user when present at a device not owned by the user, whether presence information should be collected for that user at all (and/or where such information should be collected); for example, a user might specify that his presence should only be monitored in selected locations or from selected devices, and the control server 110 might remove that user's profile from the search universe when provided with presence information from a device not at the selected location or from a device other than one of the selected devices. More generally, the user preference can include any types of parameters related to collecting presence information, using presence information, handling media content recommendations, handling advertisements, serving content/information (including, without limitation, user account information, user content, user profile information, user's personal communications (e.g., videomail, videomail, voicemail, e-mail, etc.), media content, advertisements, and/or the), and/or content filtering and content filtering options. These preferences might be stored in a user profile at the control server 110, which might also include other user-specific information, such as the user's normal location(s), identifying information (such as MAC address, etc.) of other user devices owned by or associated with the user, lists of or links to content owned by the user, lists of or links to media content recommendations, lists of or links to preferences for handling media content recommendations, lists of or links to advertisements, lists or links to products or services associated with advertisements, lists of or links to preferences for handling advertisements, lists of or links to preferences for types of content to filter, lists of or links to preferences for how to filter certain types of content, lists of or links to preferences for filtering content for child users in the user's family (which might include how filtering of content for child users should be handled as the child users grow older, etc.), and/or the like.

In some embodiments, user preferences might specify how the user would like his or her user devices to participate (or not) in a distributed infrastructure arrangement. For instance, the user preferences might include, without limitation, preferences indicating whether or not to allow a user device owned by the user to be used for distributed infrastructure; preferences indicating what type of software applications, customer data, media content (of other user device users and/or subscribers of a cloud service), and/or advertisements are permitted to be hosted on a user device owned by the user; and/or preferences indicating amount of resources of a user device to dedicate to the distributed infrastructure; etc. In some embodiments, in addition to indicating how a user's user device may be used in distributed infrastructure implementation, user preferences might allow a user to indicate how the user's own applications, data, and/or media content may be hosted on other users' user devices. For example, the user might be given the option to encrypt any and/or all personal data, any and/or all personal applications, any and/or all files or lists indicating which media content are associated with the user, any and/or all files or lists pertaining to media content recommendations and/or preferences thereof, and/or any and/or all files or lists pertaining to advertisements and/or preferences thereof. Common media content (which might include popular media content, or any other media content) may remain unencrypted for common usage by any number of users on any number of user devices, subject only to any subscription, rental, or purchase restrictions on the particular media content as associated with any user and/or any user device. On the other hand, the user's personal communications (including, e.g., videomail messages and/or the like), preferences for media content recommendations, past decisions/patterns/history with regard to media content viewed/listened to/played by the user, preferences for advertisements, preferences for what type of content to filter or censor, preferences for how to filter or censor content, preferences for filtering content for particular members (e.g., children, spouse, parents, etc.) of the user's family, and/or the like may be encrypted.

The control server 110 can provide a user interface (which can be used by users of the ICDs 105, the video calling devices 105, and/or the PDDs 105, and/or the like). The control server 110 might also provide machine-to-machine interfaces, such as application programming interfaces (“APIs”), data exchange protocols, and the like, which can allow for automated communications with the video calling devices 105 and/or the PDDs 105, etc. In one aspect, the control server 110 might be in communication with a web server 125 and/or might incorporate the web server 125, which can provide the user interface, e.g., over the network to a user computer (not shown in FIG. 1) and/or a machine-to-machine interface. In another aspect, the control server 110 might provide such interfaces directly without need for a web server 125. Under either configuration, the control server 110 provides the user interface 120, as that phrase is used in this document. In some cases, some or all of the functionality of the control server 110 might be implemented by the ICD 105, the video calling device 105, and/or the PDD 105 itself.

In an aspect, the user interface 120 allows users to interact with the control server 110, and by extension, the ICDs, the video calling devices 105, and/or the PDDs 105. A variety of user interfaces may be provided in accordance with various embodiments, including, without limitation, graphical user interfaces that display, for a user, display fields on display screens for providing information to the user and/or receiving user input from a user.

Merely by way of example, in some embodiments, the control server 110 may be configured to communicate with a user computer (not shown in FIG. 1) via a dedicated application running on the user computer; in this situation, the user interface 120 might be displayed by the user computer based on data and/or instructions provided by the control server 110. In this situation, providing the user interface might comprise providing instructions and/or data to cause the user computer to display the user interface. In other embodiments, the user interface may be provided from a web site, e.g., by providing a set of one or more web pages, which might be displayed in a web browser running on the user computer/device and/or might be served by the web server 125. As noted above, in various embodiments, the control system 110 might comprise the web server and/or be in communication with the web server 125, such that the control server 110 provides data to the web server 125 to be incorporated in web pages served by the web server 125 for reception and/or display by a browser at the user computer/device.

The network 115, specific examples of which are described below with regard to FIG. 7, can be any network, wired or wireless, that is capable of providing communication between the control server 110 and the ICDs 105, the video calling devices 105, and/or the PDDs 105, and/or of providing communication between the control server 110 (and/or the web server 125) and a user computer. In a specific embodiment, the network 115 can comprise the Internet, and/or any Internet service provider (“ISP”) access networks that provide Internet access to the control server 110, the user computer, and/or the ICDs 105, the video calling devices 105, and/or the PDDs 105.

In some embodiments, the system 100 can include a cloud storage system 130, which can be used, as described in further detail below, to store advertisements, presence information, images, video, videomail messages, media content, media content recommendations, determined advertisements, preferences for advertisements, preference information of users, past viewing/listening/playing patterns or decisions of users, preferences for what type of content to filter or censor, preferences for how to filter or censor content, preferences for filtering content for particular members (e.g., children, spouse, parents, etc.) of the user's family, and/or the like that are monitored/captured, downloaded, streamed, and/or uploaded by the ICDs 105, the video calling devices 105 and/or the PDDs 105, and/or the like. In some cases, the cloud storage system 130 might be a proprietary system operated by an operator of the control server 110. In other cases, the cloud storage system 130 might be operated by a third party provider, such as one of the many providers of commercially available cloud services. In yet a further embodiment, the cloud storage system 130 might be implemented by using resources (e.g., compute, memory, storage network, etc.) shared by a plurality of video calling devices, and/or by a plurality of PDDs, that are distributed among various users of the system. Merely by way of example, as described in further detail below and in the '360 application (already incorporated by reference herein), a plurality of user video calling devices and/or PDDs might each have some dedicated resources (such as a storage partition), which are dedicated for use by the system, and/or some ad hoc resources (such as network bandwidth, memory, compute resources, etc.) that are available to the system when not in use by a user. Such resources can be used as cloud storage and/or can be used to provide a distributed, cloud-like platform on which a control server can run as a virtual machine, cloud container, and/or the like.

According to some embodiments, ICD 105, video calling device 105, and/or PDD 105 might comprise a first video input interface to receive first video input from a first local content source (which in some embodiments can include a STB and/or the like) and a first audio input interface to receive first audio input from the first local content source. Video calling device 105 might further comprise a first video output interface to provide first video output to a first video display device and a first audio output interface to provide first audio output to a first audio receiver (and/or to a speaker system). In some cases, the first video display device and the first audio receiver might be embodied in the same device (e.g., a TV with built-in speaker system, or the like). With the input and output interfaces, video calling device 105 might provide pass-through capability for video and/or audio between the first local content source and the first display device. In some instances, high-definition multimedia interface (“HDMI”) cables or other suitable HD signal cables may be used to provide the interconnections for the pass-through. Video calling device 105 may, in some cases, comprise a first image capture device to capture at least one of first image data or first video data and a first audio capture device to capture first audio data. Video calling device 105 may also comprise a first network interface, at least one first processor, and a first storage medium in communication with the at least one first processor.

In some aspects, a plurality of ICDs, PDDs, or video calling devices 105 might be communicatively coupled together in a network (e.g., network 115), each ICD, PDD, or video calling device being located in one of a plurality of customer premises. For implementing distributed infrastructure for cloud computing, cloud-based application hosting, and/or cloud-based data storage, a computer might establish one or more ICDs, PDDs, or video calling devices 105 of the plurality of ICDs, PDDs, or video calling devices 105 as distributed infrastructure elements and might provide at least one of one or more software applications, customer data, and/or media content to the one or more video calling devices 105 for hosting on the one or more video calling devices 105. These and other functionalities of the video calling devices related to distributed infrastructure are described in greater detail in the '360 application (already incorporated by reference herein).

Merely by way of example, in some aspects, a user can remotely access one or more ICDs, PDDs, or video calling devices 105 and/or remotely access at least one of the user's master account, the user's user preference, the user's profiles, any videomail messages addressed to the user, the user's media content, media content recommendations for the user, determined advertisements, preferences for advertisements, preferences for types of content to filter, preferences for content filtering options, preferences for filtering content for particular family members or friends, and/or the like over a network. For example, in a web-based implementation, a user could log into the user's master account by accessing a website hosted on a web server (e.g., web server 125, which might be hosted on a cloud server, hosted on distributed PDDs, hosted on distributed video calling devices, and/or the like) and entering commands into a user interface (e.g., user interface 120) associated with remotely accessing the user's video calling device(s) 105 and/or associated with remotely accessing at least one of the user's master account, the user's user preference, the user's profiles, any videomail messages addressed to the user, the user's media content, media content recommendations for the user, determined advertisements of the user, the user's preferences for advertisements, the user's preferences for types of content to filter, the user's preferences for content filtering options, the user's preferences for filtering content for particular family members or friends, and/or the like. In some instances, the user might access and interact with the user interface over the network (e.g., network 115) by using a user computer selected from a group consisting of a laptop computer, a desktop computer, a tablet computer, a smart phone, a mobile phone, a portable computing device, and/or the like. In an application-based (or “app-based”) implementation, the user might interact with a software application (or “app”) running on the user's user device, which might include, without limitation, a laptop computer, a desktop computer, a tablet computer, a smart phone, a mobile phone, a portable computing device, and/or the like. The app might include another user interface (similar to the web-based user interface) that might allow for access of the user's video calling device(s) (or any paired video calling device(s)) over the network (e.g., network 115) and/or that might allow for access to at least one of the user's master account, the user's user preferences, the user's profiles, any videomail messages addressed to the user, the user's media content, media content recommendations for the user, determined advertisements for the user, the user's preferences for advertisements, the user's preferences for content filtering options (e.g., type of content to filter, how to filter certain types of content, how to filter for particular users associated with the user's account, etc.), and/or the like.

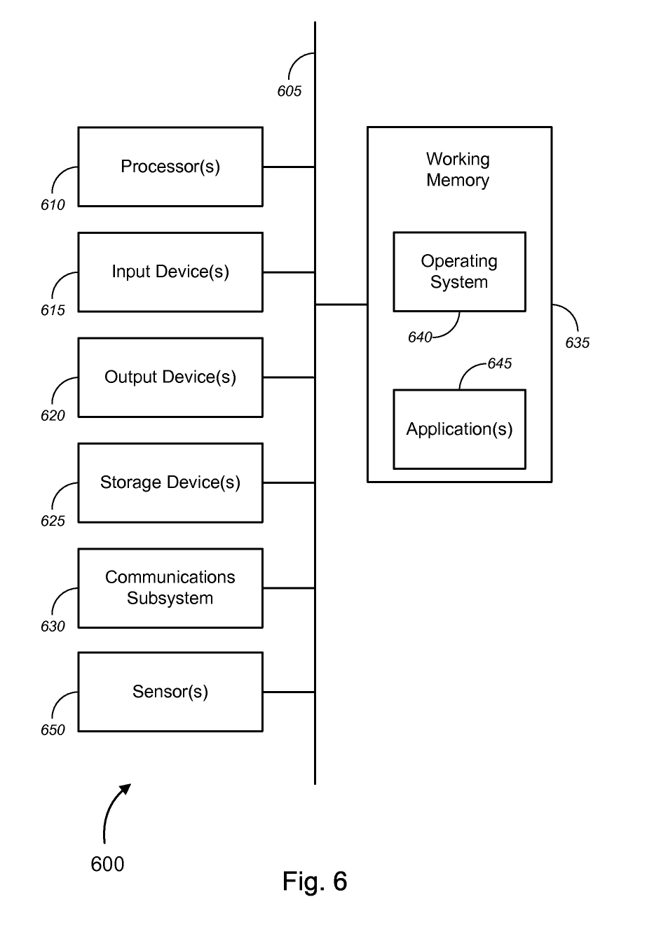

According to some embodiments, control server 110, which can have any suitable hardware configuration (an example of which is described below with respect to FIG. 6), might be a computer that is capable of receiving user input via a user interface 120 and/or performing operations for controlling the user device(s) 105 (which in some cases might comprise inline camera(s), which in turn might comprise cameras or other sensors, and the like). Merely by way of example, however, the control server 110 can determine presence and/or identity of the user(s), determine whether at least one portion of media content should be filtered based on detected presence (or identification) of the user(s), obtain or generate replacement content or otherwise filter the at least one portion of the media content based on a determination that at least one portion of the media content should be filtered, and/or the like. In other cases, the control server 110 can receive and/or store user input and/or user preferences that can specify whether and how presence information should be used. For example, preferences might specify that presence information for identified adults and children can be used for filtering content in media content being presented, that presence information for identified adults can be used for advertising purposes, but that presence information about children should not be provided to advertisers. Alternatively and/or additionally, the preferences might specify which types of third parties (e.g., advertisers, content providers, etc.) can receive presence information, which types of content should be filtered based on presence information, how content should be filtered (e.g., replaced with what types of replacement content, paused, censored, blocked, skipped, removed, etc.), and/or any other type of parameter related to collecting presence information, using presence information, and/or the like.

In an aspect of some embodiments, the user might log onto his or her master account at the control server in order to access and/or control inline cameras assigned to that account. The user device 105 and/or the control server 110 might authenticate the user with a set of credentials associated with the master account (e.g., with any of several known authentication schemes, such as a userid/password challenge, a certificate exchange process, and/or the like). Once the user has been authenticated, the user interface can present the user with a variety of different information, including without limitation information about status of inline cameras (or user devices 105 comprising the inline cameras) assigned to the master account to which the user has logged on, options for controlling such inline cameras, and or the like.

Thus, in some aspects, the user device 105 and/or the control server 110 might receive user preferences (e.g., via a network, such as the Internet, to name one example), and in particular user preferences relating to the collection and/or use of presence information, including without limitation preferences such as those described above. The user device 105 and/or the control server 110 can further control and/or configure the inline camera, based at least in part on the user preferences. Merely by way of example, the user might have specified that the inline camera (of the user device 105) should not be used to collect presence information at all, in which case that feature might be turned off at the inline camera. Alternatively and/or additionally, the user might have specified some limitations on the collection of presence information (such as about whom such information may be collected, times at which information can be collected, and/or purposes for which information may be collected, to name a few examples). Of course, in some embodiments, these preferences can be set directly at the inline camera, e.g., through a menu system displayed on a video device. It should also be recognized that some preferences (such as with whom presence information can be shared) might not affect the inline camera and might be saved and/or operated on at the control server instead.

The amount of control imposed by the control server 110 can vary according to embodiment and implementation. Merely by way of example, as noted above, in some embodiments, there might be no control server, and the inline camera (of the user device 105) might incorporate all the functionalities described herein with regard to the control server 110. In other embodiments, the control server 110 might provide fairly fine-grained control over the inline camera (of the user device 105), such as instructing the camera to capture images for purposes of determining presence, and/or the control server 110 may receive the images directly and perform the present determination procedures at the controls server. The division of responsibility between the control server 110 and the inline camera or user device 105 can fall anywhere along this spectrum. In some cases, for instance, the control server 110 might provide the user preferences to the inline camera or the user device 105, which then is responsible for collecting presence information in accordance with those preferences and transmitting the presence information to the control server 110, which takes the appropriate action in response to the presence information, such as, determining whether at least a portion of media content should be filtered and, based on such determination, filtering the at least one portion of media content, and/or the like. Alternatively and/or additionally, the inline camera (or user device) itself might be responsible for taking such actions.

In some cases, the user device or inline camera might collect presence information. A variety of operations might be involved in the collection of presence information. For example, in some cases, the inline camera captures one or more images of at least a portion of a room where it is located. Such images can be digital still images, a digital video stream, and/or the like. Collecting presence information can further comprise analyzing one or more of the images. Merely by way of example, the images might be analyzed with facial recognition software, which can be used to determine the number of people in the room with the inline camera and/or to identify any of such people (e.g., by determining a name, an age range, a gender, and/or or other identifying or demographic information about a user, based on the output of the facial recognition software). Alternatively and/or additionally, analyzing the images can comprise determining that a person is watching a display device, for example using eye-tracking software to identify a focus area of the person's eyes and correlating that focus area with the location of a television. In some cases, if the number of people and the identities (or at least demographic characteristics) of each of the people in the room can be determined, analyzing the images can further include determining a collective demographic of the people in the room (based, for example on the demographic characteristics of a majority of people in the room).

In some embodiments, the user device (or inline camera) 105 and/or the control server 110 can determine, for particular user(s), whether at least one portion of media content (being presented or to be presented) should be filtered or censored, and (based on a determination that at least one portion of the media content should be filtered) filtering the at least one portion of the media content. In some cases, this will comprise inserting replacement content (which might be transmitted from the control server to the inline camera/user device 105, or from content filtering server 135 to the inline camera/user device 105) into a video stream received by the inline camera from a STB (or game console, etc.) and output to a television screen, or simply replacing determined portions of the media content with the replacement content prior to presentation of the (portions of the) media content.

Other techniques can be used to filter media content, however. For example, filtering media content, other than replacing at least portions of media content, can further include, without limitation, blocking, pausing, hiding, skipping, removing, and/or the like, at least portions of the media content. Here, “blocking” at least portions of the media content might include preventing the at least portions of the media content from being presented to the user. “Pausing” at least portions of the media content can be implemented in one of multiple ways, including, without limitation, buffering in the user device (or inline camera) 105 and/or the control server 110, sending instructions to a set-top-box (“STB”) or the like to pause presentation of the at least portions of the media content (e.g., using digital video recorder (“DVR”) functionality or the like), and/or similar functionality. “Hiding” at least portions of the media content might include, without limitation, covering or censoring at least portions of the media content; in some cases, covering or censoring might include replacing the at least portions of media content with, or overlaying the at least portions of media content with, at least one of one or more colored polygons, one or more pixelated images, one or more blurred images, one or more smiley faces, one or more predetermined images, one or more random images, one or more audio tones, one or more audio blanks (i.e., no sound portions or soundless or quiet clips), one or more replacement words, and/or the like, each of which might be retrieved from local storage and/or from cloud storage or the like. “Skipping” at least portions of media content might include, but is not limited to, jumping past particular scenes in a video content or game content (i.e., not presenting such particular scenes, but instead presenting the next scene in the media content), skipping over particular words in video, game, and/or audio content, skipping over particular images in image, video, or game content (i.e., not presenting particular images in image, video, or game content), and/or the like. In some cases, “skipping” at least portions of media content might include fast-forwarding through the at least portions of the media content (i.e., fast-forwarding through particular scenes in a video content or game content, through particular words in video, game, and/or audio content, through particular images in image, video, or game content, and/or the like. In some cases, “filtering” at least portions of media content might generally refer to removing the at least portions of the media content, which might, in some cases, have the same effect (if not necessarily the same implementation) as one or a combination of “blocking,” “hiding,” and/or “skipping” at least portions of the media content, as described above.

In some embodiments, the content provider might have produced various versions of the media content (which are sensitive to different groups having different levels of tolerance to potentially offensive or objectionable content; e.g., people who are averse to particular types of violent content, people who are averse to particular types of nude or sexual content, people who are averse to particular offensive language, people who would like to shield their children from certain types of content (e.g., nude content, violent content, sexual content, offensive language, and/or the like), child users, themselves, who should be protected from such content, etc.), and the user device (or inline camera) 105 and/or the control server 110 can determine, for particular user(s), which portions of one of the media content (if not the entire one of the media content) should be replaced with which other version of the media content during presentation of the media content, based on presence information collected by the inline device or user device. The other version might be retrieved from local storage or from cloud storage, or the like.

In some embodiments, the user device (or inline camera) 105 can collect and/or provide feedback to the content providers (or another third party) and/or to the service provider offering such content filtering functionalities. Merely by way of example, the inline camera or user device might capture audio and/or video while the media content is being presented, which can indicate user reaction to the media content. This audio/video can be used to infer user acceptance (or rejection) of the types of content in the media content, and these inferences (and/or the raw audio/video itself) can be provided to the content providers (or a third party) and/or to the service provider offering such content filtering functionalities to improve the effectiveness of future content filtering.

In some aspects, server 110 might perform the methods described in detail with respect to FIGS. 2-5 below, while data associated with user account(s) or preferences, data associated with monitored user(s), and/or data associated with monitored media content might be collected by the one or more user devices 105, by server 110, by server 135, or by any combination of these computing devices. The database 130 (and/or database 140) might store some or all of these collected data.

Aside from the presence detection, content filtering determination, and/or content filtering implementation functionalities described above, the user devices 105, control server 110, and other components of system 100 may possess other functionalities and operations, which are described in greater detail in the Related Applications, and briefly mentioned below.

In some embodiments, the control server 110 can detect user presence, identify/authenticate users, and/or enable the user to remotely access the user's master account, user preferences, videomail messages, media content, media content recommendations, advertisements, preferences for advertisements, and/or the like. In other cases, the control server 110 can receive and/or store user input and/or user preferences that can specify whether and how presence information should be used, whether and how the user's ICD(s), video calling device(s), PDD(s), and/or user device(s) may be used in the distributed infrastructure, whether and how the user's content and profiles should be handled under certain situations, how to handle media content recommendations, how to determine advertisements relevant to particular users, and/or the like.

For example, preferences might specify which account information, content, profile information, personal communications (e.g., videomail, voicemail, e-mail, etc.), media content, media content recommendations, determined advertisements, preferences for advertisements, and/or the like should be delivered to a user when present at a device not owned by the user, whether presence information should be collected for that user at all (and/or where such information should be collected); for example, a user might specify that his presence should only be monitored in selected locations or from selected devices, and the control server 110 might remove that user's profile from the search universe when provided with presence information from a device not at the selected location or from a device other than one of the selected devices. More generally, the user preference can include any types of parameters related to collecting presence information, using presence information, handling media content recommendations, handling advertisements, and/or serving content/information (including, without limitation, user account information, user content, user profile information, user's personal communications (e.g., videomail, videomail, voicemail, e-mail, etc.), media content, media content recommendations, advertisements, and/or the like). These preferences might be stored in a user profile at the control server 110, which might also include other user-specific information, such as the user's normal location(s), identifying information (such as MAC address, etc.) of other user devices owned by or associated with the user, lists of or links to content owned by the user, lists of or links to videomail messages addressed to the user, lists of or links to recommended media content, lists of or links to determined advertisements, lists of or links to preferences for media content recommendations and/or for advertisements, and/or the like. Videomail capture, processing, and distribution is described in greater detail in the '499 and '621 applications (already incorporated herein). Media content delivery and media content recommendation generation are described in detail in the '435 application (also already incorporated herein). Physical presence and advertising based on detected presence are described in detail in the '133 and '603 applications (which are also already incorporated herein).

In some aspects, a plurality of video calling devices 105 might be communicatively coupled together in a network (e.g., network 115), each video calling device being located in one of a plurality of customer premises. For implementing distributed infrastructure for cloud computing, cloud-based application hosting, and/or cloud-based data storage, a computer might establish one or more video calling devices 105 of the plurality of video calling devices 105 as distributed infrastructure elements and might provide at least one of one or more software applications, customer data, and/or media content to the one or more video calling devices 105 for hosting on the one or more video calling devices 105. These and other functionalities of the video calling devices related to distributed infrastructure are described in greater detail in the '360 application (already incorporated by reference herein).

In some embodiments, user preferences might specify how the user would like his or her user devices to participate (or not) in a distributed infrastructure arrangement. For instance, the user preferences might include, without limitation, preferences indicating whether or not to allow a user device owned by the user to be used for distributed infrastructure; preferences indicating what type of software applications, customer data, and/or media content (of other user device users and/or subscribers of a cloud service) are permitted to be hosted on a user device owned by the user; and/or preferences indicating amount of resources of a user device to dedicate to the distributed infrastructure; etc. In some embodiments, in addition to indicating how a user's user device may be used in distributed infrastructure implementation, user preferences might allow a user to indicate how the user's own applications, data, and/or media content may be hosted on other users' user devices. For example, the user might be given the option to encrypt any and/or all personal data, any and/or all personal applications, any and/or all files or lists indicating which media content are associated with the user, and/or any and/or all files or lists pertaining to videomail messages that are addressed to the user (including the videomail messages themselves). Common media content (which might include popular media content, or any other media content) may remain unencrypted for common usage by any number of users on any number of user devices, subject only to any subscription, rental, or purchase restrictions on the particular media content as associated with any user and/or any user device. On the other hand, the user's personal communications (including, e.g., videomail messages and/or the like) may be encrypted.

In some examples, the user might indicate that her user device may be used for distributed processing, but not distributed cloud-based data storage, or vice versa. Alternatively, the user might indicate that her user device may be used for both distributed processing and distributed cloud-based data storage. In some embodiments, the user might allow the hosting, on his or her user device, of at least portions of software applications that are published by known and reputable software companies or published by companies on behalf of governmental agencies, or the like, while blocking hosting of software applications associated with marketing, spam, data mining, and/or potential copyright violations, etc. These and other preferences related to distributed infrastructure functionality, as well as distributed infrastructure implementation of user devices, are described in greater detail in the '360 application (which is already incorporated herein by reference).

In some embodiments, the system 100 can include a cloud storage system 130, which can be used, as described in further detail below, to store user addresses in at least one protocol (e.g. HTTP, SIP, XMPP, PSTN protocol, etc.); user preferences regarding call conferencing, conference addressing, etc.; and/or the like. In some instances, the cloud storage system 130 might further store media content, advertisements, presence information, images, video, and/or videomail messages that are captured and uploaded by the video calling devices 105 and/or the user devices 105, and/or the like.

In some embodiments, access of one or more video calling device(s) and/or access to at least one of the user's master account, the user's user preference, the user's profiles, any videomail messages addressed to the user, and/or the like may be permitted in response to identification and/or authentication of the user by a presence detection device (“PDD”), as described in detail herein and in the '279 application. In some embodiments, a user device 105 might comprise a second video input interface to receive second video input from a second local content source (which, in some embodiments, might include a STB and/or the like) and a second audio input interface to receive second audio input from the second local content source. User device 105 might further comprise a second video output interface to provide second video output to a second video display device and a second audio output interface to provide second audio output to a second audio receiver. In some cases (as with video calling device 105 or user device 105 above), the second video display device and the second audio receiver might be embodied in the same device (e.g., a TV with built-in speaker system, or the like). With the input and output interfaces, user device 105 might provide pass-through capability for video and/or audio between the second local content source and the second display device. In some instances, high-definition multimedia interface (“HDMI”) cables or other suitable HD signal cables may be used to provide the interconnections for the pass-through. User device 105 may, in some cases, comprise a second image capture device to capture at least one of second image data or second video data, and a second audio capture device to capture second audio data. User device 105 might also comprise a second network interface, at least one second processor, and a second storage medium in communication with the at least one second processor. Similar to the video calling devices 105, a plurality of user devices 105 may be communicatively coupled together in a network (e.g., network 115), as distributed infrastructure elements for implementing distributed infrastructure for cloud computing, cloud-based application hosting, and/or cloud-based data storage.

Once a user has been automatically identified and/or authenticated by a user device having identification and/or authentication functionality (e.g., by a PDD as described herein or as described in the '279 application), regardless of whether or not the user is associated with (or owns) such user device, the user may be provided with access to the video calling device(s) over the network and/or remote access to at least one of the user's master account, the user's user preference, the user's profiles, any videomail messages addressed to the user, the user's media content, media content recommended for the user, advertisements determined to be relevant to the user, and/or the like. Such access (as discussed above) may be in the form of web-based user interfaces, app-based user interfaces, or other suitable user interfaces. Such user interfaces might be customized automatically based on the user preferences (i.e., based on the video mail capture, processing, and distribution user preferences discussed above). In some instances, the user interfaces might be configured to allow addition, modification, and/or deletion of such user preferences. According to some embodiments, the user interfaces might provide the user with options for uploading, locally storing, cloud storing, distributing/sharing, processing, and/or otherwise handling recorded videomail messages from the video calling device(s). Some of these options may be preselected (or established as default settings) in the user preferences. In some cases, processing of videomail messages from the video calling device(s) might include, without limitation, formatting, sharpening, and/or otherwise manipulating the videomail messages.

In some cases, the user device (e.g., PDD) might be configured to determine whether the user is no longer present. Based on such a determination, access to the video calling device(s) over the network, as well as access to at least one (if not all) of the user's master account, the user's user preference, the user's profiles, any videomail messages addressed to the user (whether in the raw or processed state), media content, media content recommendations, advertisements determined to be relevant to the user, and/or the like, may be blocked. Blocking such access may include automatically logging out of the web-based or app-based user interface, or the like.

These and other functionalities are described in detail in the Related Applications.

FIGS. 2A and 2B (collectively, “FIG. 2) illustrate various methods 200 of enabling or implementing presence detection and/or automatic content filtering of media content based on detected presence of users, in accordance with one set of embodiments. FIG. 2A illustrates an example method in which the PDD or ICD itself determines and provides advertisement based on a number of factors, while FIG. 2B illustrates an alternative method in which the PDD or ICD sends monitored information associated with a first media content to a server computer (e.g., server computer 135 in FIG. 1) and the server computer determines and provides advertisement based on a number of factors. While the techniques and procedures are depicted and/or described in a certain order for purposes of illustration, it should be appreciated that certain procedures may be reordered and/or omitted within the scope of various embodiments. Moreover, while the method illustrated by FIG. 2 can be implemented by (and, in some cases, are described below with respect to) the systems 100, 600, and/or 700 of FIGS. 1, 6, and/or 7, respectively (or components thereof), such methods may also be implemented using any suitable hardware implementation. Similarly, while each of the system 100 (and/or components thereof) of FIG. 1, the system 600 (and/or components thereof) of FIG. 6, and/or the system 700 (and/or components thereof) of FIG. 7 can operate according to the method illustrated by FIG. 2 (e.g., by executing instructions embodied on a computer readable medium), the system 100 can also operate according to other modes of operation and/or perform other suitable procedures.

At block 205, method 200 might comprise receiving, with a presence detection device (e.g., a PDD or ICD 105 as shown in FIG. 1, or the like), first media content. In some cases, the presence detection device might receive the first media content from a local content source (e.g., local content source 535 as shown in FIG. 5 or the like) or from a remote content source (e.g., media content server 150 via network 115 and/or 145, and perhaps also via control server 110, as shown in FIG. 1). In some cases, the presence detection device might comprise a video input interface to receive video input from the local content source, an audio input interface to receive audio input from the local content source, a video output interface to provide video output to a video display device, an audio output interface to provide audio output to an audio receiver, an image capture device to capture at least one of image data or video data, an audio capture device to capture audio data, a network interface, at least one processor, and a storage medium in communication with the at least one processor. Method 200 might further comprise presenting, with the presence detection device, the received first media content (block 210). In some embodiments, presenting the received first media content might include, without limitation, displaying video, image, or game content, presenting audio content, and/or the like.

The method 200, at block 215, might comprise monitoring, with the presence detection device, information associated with the first media content. In some embodiments, the information associated with the first media content might include at least one of media content-based information and/or audience-based information. In some cases, monitoring media content-based information might comprise analyzing the media content as it is passed through the presence detection device, to determine the media content-based information. Additionally, or alternatively, monitoring media content-based information might comprise analyzing identification information that is sent together with the media content, the identification information including general information, bibliographical information, or other information regarding the media content. In other cases, monitoring media content-based information might comprise querying the source of the media content for media content-based information. According to some embodiments, monitoring audience-based information might include monitoring persons in the same room as the presence detection device using at least one of the image capture device, the audio capture device, another sensor (e.g., infrared sensor, other heat sensor, motion sensor, electronic device communications link (e.g., Bluetooth communications device, Wi-Fi communications device, near-field communications device, and/or the like)), and/or the like. In some cases, monitoring audience-based information might include querying one or more databases, which might collect information about the persons monitored by the presence detection device, or persons associated therewith.

Media content-based information might comprise at least one of type of media content of the first media content, genre of media content of the first media content, duration of media content of the first media content, time of day that the first media content is received and/or presented, performers associated with the first media content, producers associated with the first media content, year of release of the first media content, reviews of the first media content, and/or other media content related to the first media content. The type of media content might include, without limitation, television program content, movie content, music content, gaming content, news-related content, sports-related content, video clip content, advertisement content, and Internet-based media content.

The genre of the media content might be classified in terms of movie/TV genres, music genres, video game genres, and so on. For example movie/TV genres might include, but is not limited to, dramas, comedies, thriller, suspense, science fiction, fantasy, honor, action, adventure, animated, children's shows, or the like, or any combination of these genres. Music genres might include, without limitation, pop, rock, rap, R&B, punk, jazz, alternative, electronic, folk, hip hop, ska, country, classical, instrumental, and so on, or any combination of these genres. Video game genres might include, but are not limited to, first-person perspective games (e.g., first-person shooter games, first-person slasher games, first-person fighting games, first-person adventurer games, and/or the like), third-person perspective games (e.g., third-person shooter games, third-person slasher games, third-person fighting games, third-person adventurer games, and/or the like), fighting games (e.g., one-on-one combat games, arena combat games, mascot fighting games, multiplayer online batter arena games, and/or the like), action-adventure games, puzzle games, role-playing games (e.g., fantasy role-playing games, tactical role-playing games, action role-playing games, open world or sandbox role-playing games, massively multiplayer online role-playing games (“MMORPGs”), and/or the like), simulation games (e.g., construction and management simulation games, life simulation games, vehicle simulation games, etc.), strategy games (e.g., real-time strategy games, real-time tactics games, tower defense games, massively multiplayer online real-time strategy games, turn-based strategy games, turn-based tactics games, wargames, and/or the like), sports games (e.g., racing games, single-player sports games, team-based sports games, etc.), and/or the like.

The performers associated with the first media content might include, without limitation, actors, actresses, singers or vocalists, band members, musicians, orchestras, voice artists, etc. The producers associated with the first media content might include, but are not limited to, directors, film/video/music/game producers, game developers, artists, etc. The reviews of the first media content can include, without limitation, reviews given by industry-based critics or by average viewers/listeners/gamers/etc.

In some embodiments, media content-based information might further comprise at least one of information pertaining to one or more portions of the first media content containing one or more of video scenes of nudity and/or images of nudity; information pertaining to one or more portions of the first media content containing one or more of video scenes of suggestive sexual content and/or images of suggestive sexual content; information pertaining to one or more portions of the first media content containing one or more of video scenes of explicit sexual content and/or images of explicit sexual content; information pertaining to one or more portions of the first media content containing one or more of video scenes of violence and/or images of violence; and/or information pertaining to one or more portions of the first media content containing one or more of audio of violence, audio of sexual content, and/or audio of coarse or offensive language; or the like.

Audience-based information might comprise at least one of number of audience members present during presentation of particular portions of the first media content (or portions of the advertisement), identity of each audience member, gender of each audience member, age of each audience member, demographic group to which each audience member belongs (i.e., other than age or gender, which might include, without limitation, at least one of ethnicity, culture, language-proficiency, location, socio-economic grouping, income, political leanings, and/or the like), viewing patterns of each audience member, specific reactions of each audience member during presentation of particular portions of the first media content (or particular portions of the advertisement), overall reactions of each audience member throughout presentation of the first media content (or presentation of the advertisement), consistency of audience member reactions of each audience member compared with past reactions and/or with personal preferences of the audience member, consistency of audience member reactions of each audience member compared with past reactions of the audience member, and/or the like.

In some cases, each of the specific reactions or the overall reactions might comprise reactions selected from a group consisting of vocal expressions, facial expressions, hand gestures, body gestures, eye movement, eye focus, and/or shift in proximity with respect to the presence detection device, or the like. In some instances, the audience-based information might be monitored using one or more of facial recognition techniques, facial expression recognition techniques, mood recognition techniques, emotion recognition techniques, voice recognition techniques, vocal tone recognition techniques, speech recognition techniques, eye movement tracking techniques, eye focus determination techniques, proximity detection techniques, and/or the like.

At block 220, method 200 might comprise collecting, with the presence detection device, presence information of a user. A variety of operations might be involved in the collection of presence information of a user. For example, in some cases, the presence detection device might capture one or more images of at least a portion of a room where it is located and/or of a user present in the room. Such images can be digital still images, a digital video stream, and/or the like. In other cases, the method can include capturing audio samples, identifying devices (such as those known to be associated with the user) in proximity to the capturing device, and/or the like.

Method 200, at block 225, might comprise estimating, with the presence detection device, characteristics of the user (including, without limitation, age, gender, demographics, and/or the like), based at least in part on information derived from at least a portion of the presence information. In some cases, estimation of age, gender, demographics, and/or the like might include, but is not limited to, comparing image, video, and/or audio presence information of the user with image, video, and/or audio information of people having known age, gender, demographics, and/or the like that may be stored in a database and/or may be accessed via a network (e.g., local area network, Internet, wide area network, etc.). Method 200 might further comprise determining, with the presence detection device, whether at least one portion of the received first media content should be filtered (block 230). In some embodiments, determining whether at least one portion of the received first media content might be based at least in part on one or more of information in a user profile of the user (or each user whose presence is detected), analyzing the first media content to identify specific video content, image content, game content, audio content, etc. that are indicated in a database as being potentially objectionable, receiving user input from at least one of the users (whose presence is detected) indicating that the at least one portion of the media content should be filtered, analysis of the first media content being presented for potentially objectionable or potentially offensive content (in some cases, prior to presentation or, in other cases, as it is being presented), and/or analysis of information about the group of users whose presence is detected.

At block 235, method 200 might comprise, based on a determination that at least one portion of the received first media content should be filtered, filtering, with the presence detection device, the at least one portion of the received first media content prior to presenting the at least one portion of the received first media content. In some cases, where the at least one portion of the received first media content is video content or game content, filtering the at least one portion of the received first media content might include, without limitation, one or more of blanking the video or game content, replacing scenes or images in scenes of the video or game content with replacement content, and/or the like. In some instances, blanking the video or game content might include replacing potentially offensive portions of the video or game content with a blank screen until such portions have passed. Alternatively, blanking the video or game content might include pausing potentially offensive portions of the video or game content at a non-offensive portion of the video or game content (prior to the potentially offensive portions), while audio (if non-offensive) continues to play, and when such portions have passed, resuming presentation of the video or game content (which would be matched with the audio presentation). In yet another alternative, blanking the video or game content might include skipping potentially offensive scenes of the video or game content (including audio (whether offensive or not)). In some embodiments, replacement content might include, without limitation, replacement scenes, polygons (which may be colored, as appropriate), pixilation or pixelated images, blurred images, smiley face(s), predetermined images, random images, and/or the like. The polygons, pixelated images, blurred images, smiley face(s), predetermined images, random images, and/or the like might replace potentially offensive images within scenes of the video or game content.

In a similar manner, where the at least one portion of the received first media content is image content, filtering the at least one portion of the received first media content might include, but is not limited to, blanking at least portions of the image content, replacing at least portions of the image content with replacement image content, and/or the like. Here, replacement image content might include, without limitation, polygons (which may be colored, as appropriate), pixilation or pixelated images, blurred images, smiley face(s), predetermined images, random images, and/or the like. The polygons, pixelated images, blurred images, smiley face(s), predetermined images, random images, and/or the like might replace potentially offensive portions of the image content.

Where the at least one portion of the received first media content is audio content, filtering the at least one portion of the received first media content might include, without limitation, muting potentially offensive language or disturbing sounds, replacing potentially offensive language or disturbing sounds with replacement audio content, and/or the like. In some instances, replacement audio content might include, but is not limited to, replacement words, a tone (e.g., 1 kHz tone or the like), a muted audio clip, etc. In some cases, replacement words might include replacement words matching one or more of gender, age, nationality, accent, and/or characteristics of a speaker of words that are being replaced by the replacement words. For example, a character in a video or gaming content might have a British accent, and might say an offensive word (e.g., “piss,” which to some people might be deemed offensive); the replacement word (e.g., “urinate,” which to some people might be deemed less offensive) might be modulated or otherwise generated to mimic the British accent.

Although the media content described above is with respect to, for example, broadcast, streamed, downloaded, or other types of pre-produced video, game, image, and/or audio content, the various embodiments are not so limited, and some embodiments may allow for real-time or near-real-time filtering of content that is presented through the user device (e.g., user device 105, including, without limitation, video calling device, PDD, ICD, and/or the like). For example, during a video call, if a child user is present (for instance), any inappropriate language spoken by a call participant whose video and audio are being presented to the child user (and any accompanying user) might be automatically filtered (and in some cases, might be replaced with words generated or modulated to mimic the accent and other vocal characteristics of the call participant). In some cases, the call participant might have a movie, television program, or game being presented on a display device, which might be within the field of view of the camera of the call participant's video calling device. If potentially offensive or inappropriate material or content (e.g., nudity, sexual content, violent content, and/or foul language, etc.) is being presented on that display device, the child user on the other end of the video call might otherwise be exposed to it. With the techniques described herein, such potentially offensive or inappropriate content (although captured by a camera of the call participant's video calling device) may still be automatically filtered when the video and audio of the call participant (and her display device) are presented to the child user on the other end of the video call. In another non-limiting example, if ICDs are relaying real-time video of an area via a network to a display device through a PDD, and a child user's presence is detected in front of the PDD and/or display device, any inappropriate content captured by the ICDs (in real-time) may in real-time or near-real-time be automatically filtered, in a manner similar to that as described above.

Method 200, at block 240, might comprise, based on a determination that the received first media content should not be filtered, continuing to present, with the presence detection device, the received first media content, without filtering the received first media content. In some cases, one or more portions of the first media content might have already been filtered and presented, and subsequently, it may be determined that filtering is no longer necessary. Based on a determination that the received first media content should no longer be filtered, method 200 might comprise resuming presenting, with the presence detection device, the received first media content, without further filtering the received first media content. For example, if initial filtering is due to detection of presence of a child user during presentation of media content that contains content that is inappropriate for the child user, and the presence detection device subsequently determines that the child user is no longer present, then the presence detection device might determine that filtering is no longer necessary, and might resume presenting an unfiltered (i.e., uncensored) version of the first media content.

Although FIG. 2A as described above is directed to the presence detection device determining whether at least a portion of the first media content should be filtered, the various embodiments are not so limited, and determination as to whether at least a portion of the first media content should be filtered may be performed by a server over a network (e.g., server 110 or content filtering server 135 in FIG. 1, or the like), which is shown with respect to FIG. 2B.

In FIG. 2B, the processes at blocks 205-220 are similar, if not identical to those at blocks 205-220 shown and described with respect to FIG. 2A, and thus the descriptions above with respect to the processes at these blocks in FIG. 2A are applicable to those at the corresponding blocks in FIG. 2B, and are omitted here for simplicity and to avoid excessive repetition.

With respect to FIG. 2B, method 200 might further comprise blocks 245-265, and might further modify blocks 225-240 in FIG. 2A (denoted as blocks 225′-240′ in FIG. 2B). At block 245, after the process at block 215, method 200 might comprise sending, with the presence detection device, the monitored information associated with the first media content to a server computer (e.g., control server 110 and/or content filtering server 135 of FIG. 1 or the like) over a network (e.g., network 115 or 145 of FIG. 1, the network 710 of FIG. 7, or the like). Method 200, at block 250, might comprise receiving, with the server computer, the monitored information associated with the first media content. Method 200 might further comprise, after the process at block 220, sending, with the presence detection device, the presence information of the user to the server computer (block 255) and receiving, with the server computer, the presence information of the user (block 260).

Thereafter, method 200 might further comprise, at block 225′, estimating, with the server computer, characteristics of the user, based at least in part on information derived from at least a portion of the presence information of the user. At block 230′, method 200 might comprise determining, with the server computer, whether at least one portion of the first media content should be filtered. The processes of blocks 225′ and 230′ are similar to those of blocks 225 and 230, except that here the server computer is performing these processes rather than the presence detection device. Accordingly, the descriptions above for processes in blocks 225 and 230 of FIG. 2A are otherwise applicable to those in blocks 225′ and 230′, respectively.

In some embodiments, method 200 might further comprise retrieving (from a database) or generating, with the server computer, at least one filtered portion to replace the at least one portion of the first media content (block 265). The at least one filtered portion might include any of the replacement content described above, for example.

At block 235′, method 200 might comprise, based on a determination that at least one portion of the first media content should be filtered, filtering the at least one portion of the first media content prior to the at least one portion of the first media content being presented. Filtering, in some cases, may be performed by one or both of the presence detection device and/or the server computer. Otherwise, block 235′ is identical to block 235 of FIG. 2A, and descriptions thereof are similarly applicable to the process in block 235′ of FIG. 2B. Method 200, at block 240′, might comprise, based on a determination that the first media content should not be (or should no longer be filtered), continuing to present (or resuming presentation of) the first media content, without (further) filtering the first media content. Here also, resuming presentation may be performed by the presence detection device (which would result in a process identical to that at block 240 of FIG. 2A), or might be performed by the server computer, which either would instruct the presence detection device to continue or resume presenting the first media content without (further) filtering the first media content, or would forego sending instructions to the presence detection device, thereby allowing the presence detection device to continue presenting the first media content without further filtering the first media content.

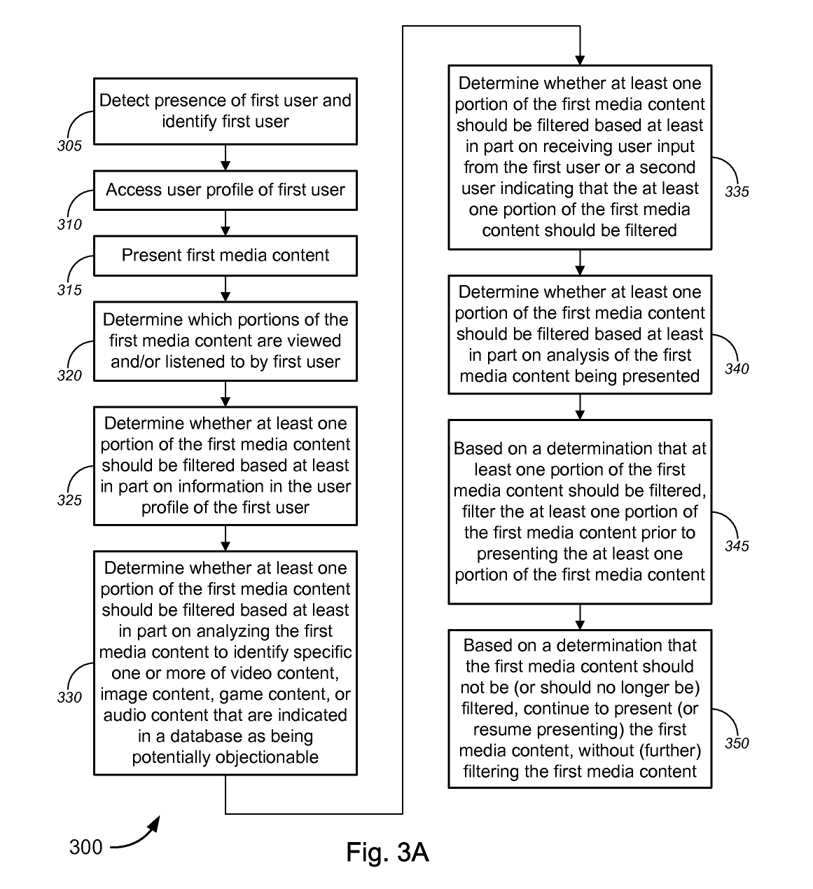

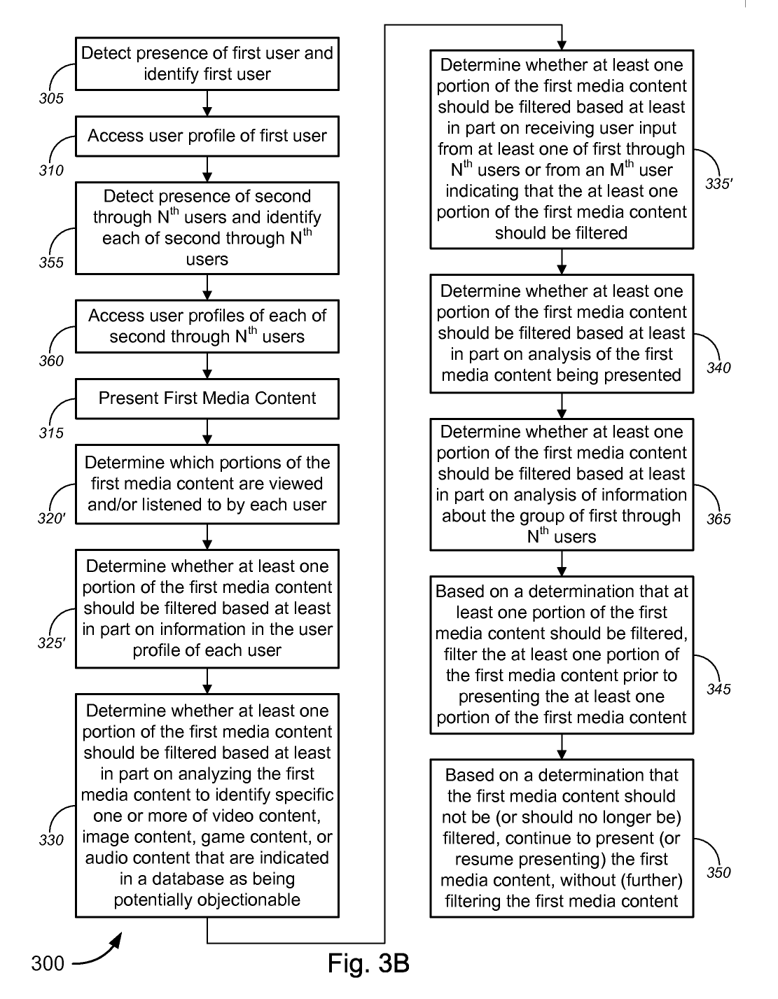

We now turn to FIGS. 3A and 3B (collectively, “FIG. 3”), which illustrate various methods 300 of enabling or implementing presence detection and/or automatic content filtering of media content based on detected presence of users, in accordance with one set of embodiments. FIG. 3A illustrates an example method in which a single user is present and the PDD or ICD detects, identifies, and determines whether to filter at least portions of the media content for the single user, while FIG. 3B illustrates an alternative method in which multiple users are present and the PDD or ICD detects, identifies, and determines whether to filter at least portions of the media content for the group of multiple users. In both cases, the PDD/ICD and/or the server computer filters at least portions of the media content or resumes presenting the media content to the user(s), based on various determinations as outlined in FIG. 2 above.

While the techniques and procedures are depicted and/or described in a certain order for purposes of illustration, it should be appreciated that certain procedures may be reordered and/or omitted within the scope of various embodiments. Moreover, while the method illustrated by FIG. 3 can be implemented by (and, in some cases, are described below with respect to) the systems 100, 600, and/or 700 of FIGS. 1, 6, and/or 7, respectively (or components thereof), such methods may also be implemented using any suitable hardware implementation. Similarly, while each of the system 100 (and/or components thereof) of FIG. 1, the system 600 (and/or components thereof) of FIG. 6, and/or the system 700 (and/or components thereof) of FIG. 7 can operate according to the method illustrated by FIG. 3 (e.g., by executing instructions embodied on a computer readable medium), the system 100 can also operate according to other modes of operation and/or perform other suitable procedures. In some embodiments, method 300 might be implemented complementary to method 200 of FIG. 2, while in other embodiments, method 200 may be implemented independently, separately, or otherwise without implementing method 300.

With reference to FIG. 3A, the method 300 might comprise detecting presence of the first user and identifying the first user (block 305). At block 310, method 300 might comprise accessing a user profile(s) of (or associated with) the first user. In some cases, the user profile(s) might be stored locally in a presence detection device (“PDD”), an image capture device (“ICD”), or user device associated with the first user, locally in a data store communicatively coupled (but external) to the PDD or ICD, remotely in a data store (e.g., database 130, 140, and/or 155 of FIG. 1, or the like), and/or the like. The PDD, ICD, or user device might present the first media content to the user (block 315). The PDD, ICD, or user device might monitor the first media content being presented and/or the first user during presentation of the first media content. For example, method 300 might comprise determining which portions of the first media content are viewed and/or listened to by the first user (block 320) and/or monitoring reactions (either specific reactions or overall reactions) of the first user.

In some embodiments, each of the specific reactions or the overall reactions might include, without limitation, vocal expressions, facial expressions, hand gestures, body gestures, eye movement, eye focus, and/or shift in proximity with respect to the presence detection device, or the like. In some instances, the audience-based information might be monitored using one or more of facial recognition techniques, facial expression recognition techniques, mood recognition techniques, emotion recognition techniques, voice recognition techniques, vocal tone recognition techniques, speech recognition techniques, eye movement tracking techniques, eye focus determination techniques, proximity detection techniques, and/or the like.

According to some embodiments, level of interest of the first user may be gauged by determining how much time the first user is actually viewing, listening to, or playing the media content, whether or not the first user replays one or more portions of the media content, the first user's proximity to display screen or speaker system, etc. For example, the eye movement tracking, eye focus determination, proximity detection, voice recognition, facial recognition techniques, and/or the like may be used to determine when the first user is paying attention to the media content being presented and to which portions the attention of the first user is drawn (e.g., the first user leaning in toward the display screen, the first user screaming or pumping his or her arms in encouragement of actions by a character in the media content, the first user shouting words like “awesome,” “cool,” or “whoa,” the first user staring intently (e.g., without blinking, etc.) at certain portions of the display screen corresponding to actions or characters in the media content, etc.). In a similar manner, media content and/or scenes of media content that the user is not interested in or is repulsed by may be determined or identified using similar techniques (e.g., the first user cringing when presented with a gruesome scene of carnage or torture in a movie or video game, the first user exhibiting signs of wanting to throw up when presented with scenes of utter disgust, the first user backing away from the display screen, the first user forcefully closing his or her eyes or otherwise purposely looking away, etc.).

Monitoring of the presentation of the media content may be used to determine whether the user is replaying at least portions of the media content, and to determine which portions are being replayed. Similarly, monitoring of the presentation of the media content may also be used to determine whether the first user is skipping or fast-forwarding through scenes, and which portions of the media content are being skipped or fast-forwarded. The results of these determinations based on monitoring of the first user's reactions and monitoring of the media content (particular the determinations as to what the user is not interested in or is repulsed by, or determinations as to what the user is skipping or fast-forwarding through, or the like) might serve to indicate types of content that should be filtered for the user in similar media content in the future.

These detection techniques might utilize one or more of an image or image capture device, an audio capture device, a proximity detection device, a motion sensing device, a heat sensing device (e.g., an infrared sensor, a thermosensor, or the like), a communications device (e.g., Bluetooth communications device, Wi-Fi communications device, or near-field communications device, or the like), and/or the like.

At block 325, method 300 might comprise determining whether at least one portion of the first media content should be filtered based at least in part on information in the user profile of the first user. For example, the first user might have included in, modified, or updated his or her user profile to indicate the types of content (e.g., one or more of sexually explicit content, sexually implicit content, violent content, certain offensive words or language, etc.) in particular types of media content (e.g., video clips, movies, television programs, video games, music clips, music videos, etc.) to filter when presenting media content to the user, as well as indicating the manner that the first user prefers the content to be filtered (e.g., by blanking, by pausing, by skipping, by replacing with any of the replacement content described above, etc.). In some cases, the user profile of the first user might be automatically updated by the presence detection device, the server computer, or other device based on information gathered and associated with the first user (including, but not limited to, monitoring and determining what types of content the user is not interested in, is repulsed by, skips, or fast-forwards through, etc.).

Alternatively, or additionally, method 300, at block 330, might comprise determining whether at least one portion of the first media content should be filtered based at least in part on analyzing the first media content to identify specific video content, image content, game content, audio content, or the like that are indicated in a database as being potentially objectionable or offensive. In some embodiments, the specific video content, image content, game content, audio content, or the like might be identified by the first user, while, in some cases, these specific content might be identified by a second user. In some instances, the second user might be a known friend or family member of the first user. In other instances, the second user might be a social media friend of the first user, or someone who is unknown to the first user. According to some embodiments, the second user might be a plurality of users who are unassociated with the first user. In one set of embodiments, crowd-sourcing efforts might be implemented to use information provided by the plurality of users (who are unassociated with the first user) to identify specific video content, image content, game content, audio content, or the like as being potentially objectionable or offensive. In some cases, the plurality of users might also mark specific locations, times, and/or durations of segments of the potentially objectionable or offensive content within particular media content. Such markings of the locations, times, and/or durations of the particular media content can subsequently be used to filter these potentially objectionable or offensive content.

Alternative, or additional, to the above determinations at blocks 325 and 330, method 300 might further comprise determining whether at least one portion of the first media content should be filtered based at least in part on receiving user input from the first user or another user (who may or may not be present during presentation of the first media content; e.g., a parent, guardian, or other adult, etc.) indicating that the at least one portion of the first media content should be filtered (block 335). In one non-limiting example, a parent might have previously set up parental control options for his or her children, in order to automatically filter content that the parent deems to be inappropriate for the children (e.g., nude content, sexual content, violent content, offensive language, scenes involving use of tobacco, alcohol, and/or drugs, etc.). In some cases, the parent might set up age brackets for eventually loosening filtering controls for each child. For example, the parent might set up the filtering options so that certain ones (if not all) of these types of inappropriate content might be lifted when the child reaches a certain age (e.g., age of majority, etc.). According to some embodiments, the presence detection device or other user device might determine that the presence information of the child user (or other user) has changed over certain periods of time, and, based on such determination, might update the child user's (or other user's) user profile with the updated presence information. In this way, a user's appearance, voice, or other personal characteristics, which may change over time, might be tracked to provide for better presence detection and/or identification of the user (such as in subsequent access attempts and/or in the future in general). In some cases, an adult user might help to set up filtering controls for his or her spouse, sibling, parent, other relative, or friend to filter out content that might be deemed offensive to his or her spouse, sibling, parent, other relative, or friend.

Alternatively, or additionally, method 300, at block 340, might comprise determining whether at least one portion of the first media content should be filtered based at least in part on analysis of the first media content being presented for potentially objectionable or potentially offensive content (in some cases, prior to presentation or, in other cases, as it is being presented). In some embodiments, such analysis might include, without limitation, comparing at least portions of the first media content with known potentially offensive content. For example, for video content, game content, or image content, image recognition or image identification techniques may be used to recognize or identify nudity, sexual content, gun violence, knife violence, gore, blood, violent acts, use of drugs, alcohol, and/or tobacco, and/or the like. For audio content, sound recognition, word identification, and/or similar techniques may be used to recognize or identify offensive words or phrases. In some cases, sound recognition, word identification, and/or similar techniques may be used to generate appropriate or non-offensive synonyms of identified offensive words or phrases, while matching gender, tone, accent, or other speaker characteristics.

At block 345, method 300 might comprise, based on a determination that at least one portion of the first media content should be filtered (e.g., based on one or more determinations at blocks 325-340), filtering the at least one portion of the first media content prior to presenting the at least one portion of the first media content to the first user. This filtering process is similar, if not identical, to the filtering process as described in detail above with respect to blocks 235 or 235′ of FIG. 2. Method 300, at block 350, might comprise, based on a determination that the first media content should not be (or should no longer be) filtered, continuing to present (or resuming presentation of) the first media content, without (further) filtering the first media content. Block 350 is similar, if not identical, to the process at blocks 240 or 240′ of FIG. 2.

Although FIG. 3A as described above is directed to basing determinations of whether at least one portion of media content should be filtered (and how filtering should be implemented) on a single user and on information relevant to the single user (e.g., information in the user profile of the user, information regarding what the single user's friends have indicated as being potentially offensive or objectionable, information regarding what the user has previously indicated (either explicitly or implicitly by actions of the user) as being offensive or objectionable, etc.), the various embodiments are not so limited, and the determination of whether at least one portion of media content should be filtered (and how filtering should be implemented) may be based on two or more users simultaneously or concurrent, as well as on information relevant to each user (e.g., information in the user profile of each user, information regarding what each user's friends have indicated as being potentially offensive or objectionable, information regarding what each user has previously indicated (either explicitly or implicitly by actions of the user) as being offensive or objectionable, etc.), which is shown with respect to FIG. 3B.

In FIG. 3B, the processes at blocks 305-315, 330, and 340-350 are similar, if not identical to those at blocks 305-315, 330, and 340-350 shown and described with respect to FIG. 3A, and thus the descriptions above with respect to the processes at these blocks in FIG. 3A are applicable to those at the corresponding blocks in FIG. 3B, and are omitted here for simplicity and to avoid excessive repetition.

With respect to FIG. 3B, method 300 might further comprise detecting presence of second through N^{th} users and identifying each of the second through N^{th} users (block 355), and accessing a user profile(s) of each user from the second through N^{th} users (block 360). The processes at blocks 320′-335′ are modified for each of the plurality of users, rather than just the first user, but are otherwise similar to blocks 320-335 in FIG. 3A, respectively, while the processes at blocks 330 and 340-350 remain the same or similar to blocks 330 and 340-350 of FIG. 3A. At block 320′, method 300 might comprise determining which portions of the first media content are viewed and/or listened to by each user—rather than by only the first user, as in block 320 of FIG. 3A. Method 300, at block 325′, might comprise determining whether at least one portion of the first media content should be filtered based at least in part on information in the user profile of each user—rather than being based at least in part on information in the user profile of only the first user, as in block 325 of FIG. 3A. Similarly, method 300, at block 335′, might comprise determining whether at least one portion of the first media content should be filtered based at least in part on receiving user input from at least one of first through N^{th} users or from an M^{th} user indicating that the at least one portion of the first media content should be filtered; in the embodiment of FIG. 3A, N=1 and M=2, however, in the embodiment of FIG. 3B, N can be any number >1, while M=N+1.

Method 300 might further comprise, prior to filtering the media content (if at all) at blocks 345-350, determining whether at least one portion of the first media content should be filtered based at least in part on analysis of information about the group of first through N^{th} users (block 365). For example, in some cases, this might include determining commonalities or differences among the first through N^{th} users in terms of what the users deem offensive or objectionable content. In some instances, this might include determining group demographics for the first through N^{th} users, and determining what may be deemed offensive or objectionable content based on the determined group demographics (which may be compared with known determinations of offensive or objectionable content by other similar demographic groups). If conflicting determinations of portions of the first media content for filtering arise, then it may be determined that the most restrictive filtering might be implemented. For example, if at least one child user is present, content deemed inappropriate for the at least one child user may be determined as being content to be filtered (and subsequently filtered accordingly). In cases where there are no child users, the most restrictive filtering may still be applied to ensure that no one present and viewing/listening to/playing the media content is offended. Alternatively, where no child user is present, a majority rule for filtering might apply, such that the filtering options of a common majority of present users might be implemented. In yet another alternative, where no child user is present and no common majority exists, a determination as to what types of content to filter might be based on considerations of each user's preferences and levels of tolerance with respect to potentially offensive or objectionable content; in such cases, some users may still end up being offended, while others are less (or not) offended by presentation of the first media content, but an overall balance of considerations might still be taken into account.

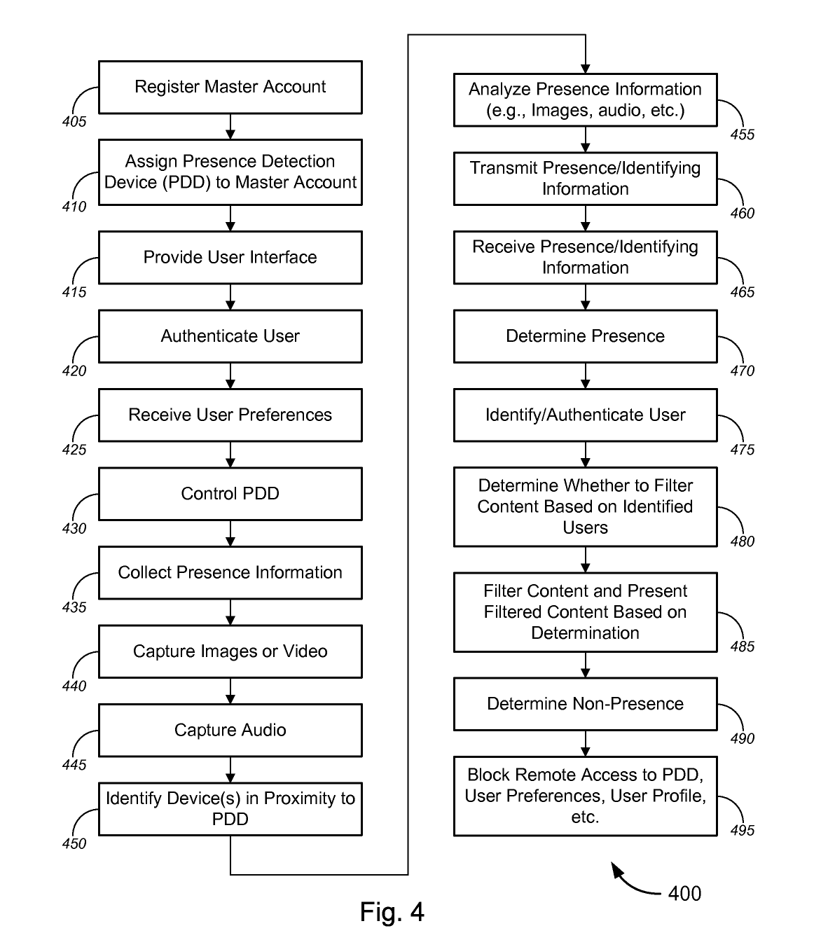

FIG. 4 illustrates a method 400 of enabling or implementing presence detection and/or automatic content filtering of media content based on detected presence of users, in accordance with one set of embodiments. While the techniques and procedures are depicted and/or described in a certain order for purposes of illustration, it should be appreciated that certain procedures may be reordered and/or omitted within the scope of various embodiments. Moreover, while the method illustrated by FIG. 4 can be implemented by (and, in some cases, are described below with respect to) the systems 100, 600, and/or 700 of FIGS. 1, 6, and/or 7, respectively (or components thereof), such methods may also be implemented using any suitable hardware implementation. Similarly, while each of the system 100 (and/or components thereof) of FIG. 1, the system 600 (and/or components thereof) of FIG. 6, and/or the system 700 (and/or components thereof) of FIG. 7 can operate according to the method illustrated by FIG. 4 (e.g., by executing instructions embodied on a computer readable medium), the system 100 can also operate according to other modes of operation and/or perform other suitable procedures. In some embodiments, method 400 might be implemented complementary to method 200 of FIG. 2 and/or method 300 of FIG. 3, while in other embodiments, each of method 200 or method 300 may be implemented independently, separately, or otherwise without implementing method 400.

Turning to FIG. 4, the method 400 might comprise registering a master account for a user (block 405). In accordance with various embodiments, registering a master account for a user can comprise a variety of operations. Merely by way of example, registering a master account can comprise creating a database entry for a particular user and/or assigning authentication credentials to that user; these credentials can be used to access the master account, as described in further detail below.

The method 400 can also include assigning one or more PDDs or ICDs (e.g., user devices 105 in FIG. 1) to the master account (block 410). As discussed above, the one or more PDDs or ICDs can be embodied by a video calling device, such as any of the video calling devices described herein, the VCDs described in the '182 patent, the video calling devices or users devices described in any of the Related Applications, a laptop computer, a desktop computer, a mobile phone, a smart phone, a tablet computer, a video game console, and/or a streaming media player, to name a few non-limiting examples. For instance, the user might identify any PDDs or ICDs that the user owns (or is otherwise associated with; e.g., members of the user's family might be associated with the devices owned by the user), and the system can assign those PDDs or ICDs to the user's master account. According to some embodiments, the user's master account might include any suitable number of sub-accounts. In one example, each member of the user's family might be associated with a sub-account linked with the master account. In some instances, the user (or some members of his or her family) might have a work/school sub-account and a home sub-account, the former being associated with profiles and/or media content appropriate for school or work, while the latter being associated with all, or all other, profiles and/or media content. In some embodiments, the master account and the plurality of sub-accounts might be organized as a hierarchy, with the master account (being at the top of the hierarchical structure) having full access to profiles and media content of each sub-account, the sub-accounts at the next level having access to profiles and/or media content of only those sub-accounts that the master account has given access to, and the sub-accounts at lower levels having limited access to profiles and/or media content. For example, the user's master account might have access to all profiles and/or media content associated with the master account and the sub-accounts. The user can provide his or her spouse with a sub-account having the same access to profiles and/or media content, while providing limited access to profiles and/or media content to each of the user's children's sub-account(s). In some instances, the user and/or the user's spouse might impose limits on access to profiles and/or media content for each of their work sub-accounts.

In some cases, each PDD or ICD might have an identifier, such as a hardware identifier, IP address, nickname, and/or the like, by which the system can address the PDD or ICD, and assigning a PDD or an ICD to the master account can comprise associating that identifier with the master account. When a PDD or an ICD is assigned to a master account, the user of that account will be able to access, configure, and/or control the PDD or ICD through the control server, for example as described in further detail below. In some cases, the user might own a plurality of PDDs or ICDs and might wish to control all of the PDDs or ICDs from a single master account. In an aspect, a user can identify such devices through a user interface to the control server.

In another aspect, as described briefly above, the assignment process can be simplified. When the user first configures a PDD or an ICD (usually locally, but perhaps over the network), the user can provide credentials to the PDD that associate the device with the master account. Thereafter, the PDD or ICD might be configured to communicate with the control server and identify itself using those credentials; at that point, the control server can assign the PDD or ICD to the master account, and no credentials need to be stored on the PDD or ICD from that point forward (other than perhaps the PDD's or ICD's own identifying information).

Hence, the method 400, in the illustrated embodiment, might further comprise providing a user interface to allow interaction between the user and the control server (block 415). For example, the user interface can be used to output information for a user, e.g., by displaying the information on a display device, printing information with a printer, playing audio through a speaker, etc.; the user interface can also function to receive input from a user, e.g., using standard input devices such as mice and other pointing devices, motion capture devices, touchpads and/or touchscreens, keyboards (e.g., numeric and/or alphabetic), microphones, etc. The procedures undertaken to provide a user interface, therefore, can vary depending on the nature of the implementation; in some cases, providing a user interface can comprise displaying the user interface on a display device; in other cases, however, in which the user interface is displayed on a device remote from the computer system (such as on a client computer, wireless device, etc.), providing the user interface might comprise formatting data for transmission to such a device and/or transmitting, receiving, and/or interpreting data that is used to create the user interface on the remote device. Alternatively and/or additionally, the user interface on a client computer (or any other appropriate user device) might be a web interface, in which the user interface is provided through one or more web pages that are served from a computer system (and/or a web server in communication with the computer system), and are received and displayed by a web browser on the client computer (or other capable user device). The web pages can display output from the computer system and receive input from the user (e.g., by using Web-based forms, via hyperlinks, electronic buttons, etc.). A variety of techniques can be used to create these Web pages and/or display/receive information, such as JavaScript, Java applications or applets, dynamic Hypertext Markup Language (“HTML”) and/or Asynchronous JavaScript and XML (or extensible markup language) (“AJAX”) technologies, to name but a few examples.

In many cases, providing a user interface will comprise providing one or more display screens each of which includes one or more user interface elements. As used herein, the term “user interface element” (also described as a “user interface mechanism” or a “user interface device”) means any text, image, or device that can be displayed on a display screen for providing information to a user and/or for receiving user input. Some such elements are commonly referred to as “widgets,” and can include, without limitation, text, text boxes, text fields, tables and/or grids, menus, toolbars, charts, hyperlinks, buttons, lists, combo boxes, checkboxes, radio buttons, and/or the like. While any illustrated exemplary display screens might employ specific user interface elements appropriate for the type of information to be conveyed/received by computer system in accordance with the described embodiments, it should be appreciated that the choice of user interface elements for a particular purpose is typically implementation-dependent and/or discretionary. Hence, the illustrated user interface elements employed by any display screens described herein should be considered exemplary in nature, and the reader should appreciate that other user interface elements could be substituted within the scope of various embodiments.

As noted above, in an aspect of certain embodiments, the user interface provides interaction between a user and a computer system. Hence, when this document describes procedures for displaying (or otherwise providing) information to a user, or to receiving input from a user, the user interface may be the vehicle for the exchange of such input/output. Merely by way of example, in a set of embodiments, the user interface allows the user to log on to a master account, access video calling devices, PDDs, or ICDs via the control server, access settings/preferences (e.g., viewing settings/preferences/histories, music or audio settings/preferences/histories, gaming settings/preferences/histories, videomail settings/preferences, preferences for types of content to filter in media content, preferences for how to filter content in media content, etc.), access videomail or other messages, and/or the like.

In an aspect of some embodiments, the user logs onto his or her master account at the control server in order to access and/or control PDDs or ICDs assigned to that account, and/or access settings/preferences, and/or the like. Accordingly, at block 420, the method 400 can include authenticating the user with a set of credentials associated with the master account (e.g., with any of several known authentication schemes, such as a userid/password challenge, a certificate exchange process, and/or the like, as well as authentication techniques, described in further detail below, that employ sensors on a PDD or an ICD, such as facial recognition, voiceprint analysis, gesture-based identification, spoken identifiers, and/or the like). Once the user has been authenticated, the user interface can present the user with a variety of different information, including without limitation information about status of PDDs or ICDs assigned to the master account to which the user has logged on, options for controlling such PDDs or ICDs, options for accessing media content, options for modifying user settings or preferences, and/or the like.

Thus, in some aspects, the method 400 might further comprise receiving (e.g., via a network, such as the Internet, to name one example) user preferences (block 425), and in particular user preferences relating to the collection and/or use of presence information, including, without limitation, preferences such as those described above. The method 400, then, can further include controlling and/or configuring the PDD or ICD, in some cases based at least in part on the user preferences (block 430). In some embodiments, the user preferences might include user preferences for collecting presence information, user preferences for monitoring people within a room (i.e., room in which the PDD or ICD is located), user preferences for determining whether or not to filter particular media content, user preferences for identifying types of content in media content to filter, user preferences indicating preferred ways to filter video, image, audio, and/or game content, user preferences for basing determinations of whether to filter media content on past viewing, listening, Internet browsing, or gaming history or patterns, user preferences for basing determinations of whether to filter media content on similar determinations by known friends, potential friends, and/or social media friends for particular media content or similar media content, and/or the like.

Merely by way of example, the user might have specified in the user preferences that the PDD or ICD should not be used to collect presence information at all, in which case that feature might be turned off at the PDD or ICD. In the case that the user preferences indicate that presence information should be turned off (e.g., privacy settings may be set high, either permanently or temporarily, and/or with respect to certain user-established and/or preset conditions, or the like), some embodiments might establish a blocking feature for the user when other PDDs or ICDs send presence information for comparison matching processes with database user biometrics, the effect of which being that no match can be made, and thus the user's profiles and/or media content (and/or access thereto) is not ported to the other PDDs or ICDs. Alternatively and/or additionally, the user might have specified some limitations on the collection of presence information (such as about whom such information may be collected, times at which information can be collected, and/or purposes for which information may be collected, to name a few examples). Of course, in some embodiments, these preferences can be set directly at the PDD or the ICD, e.g., through a menu system displayed on a video device. It should also be recognized that some preferences (such as with whom presence information can be shared) might not affect the PDD or ICD and might be saved and/or operated on at the control server instead.

The amount of control imposed by the control server can vary according to embodiment and implementation. Merely by way of example, as noted above, in some embodiments, there might be no control server, and the PDD or ICD might incorporate all the functionalities described herein with regard to the control server, including peer-to-peer functionality with other PDDs or ICDs. In other embodiments, the control server might provide fairly fine-grained control over the PDD or ICD, such as instructing the camera to capture images for purposes of determining presence, and/or the control server may receive the images directly and perform the presence determination, identification, and/or authentication procedures at the control server. The division of responsibility between the control server and the PDD or ICD can fall anywhere along this spectrum. In some cases, for instance, the control server might provide the user preferences to the PDD or ICD, which then is responsible for collecting presence information in accordance with those preferences and transmitting the presence information to the control server, which takes the appropriate action in response to the presence information, such as determining whether media content (either a particular one that is identified or being presented) should be filtered, etc. Alternatively and/or additionally, the PDD or ICD itself might be responsible for taking such actions. Likewise, for determining how a particular user or a group of users might prefer content to be filtered, either the PDD/ICD or the control server might perform such functionality. In some cases, the PDD or ICD might determine whether particular media content should be filtered based on local information (e.g., information associated with the user(s), preferences of the user(s), user input from the user(s), reactions of the user(s), preferences/history/patterns of the user, and/or the like), while the control server might determine whether particular media content should be filtered based on remote information (e.g., information associated with known friends, potential friends, and/or social media friends, information associated with demographic groups to which the user belongs, information associated with particular censoring groups (perhaps ones that are known to be in line with preferences of the user(s), or the like), and/or the like).

At block 435, the method 400 can comprise collecting presence information. A variety of operations might be involved in the collection of presence information. For example, in some cases, the PDD or ICD captures one or more images of at least a portion of a room where it is located and/or of a user present in the room (block 440). Such images can be digital still images, a digital video stream, and/or the like. In other cases, the method can include capturing audio samples (block 445), identifying devices in proximity to the capturing device (block 450), and/or the like (for example as described above).

The method 400 can further comprise analyzing one or more of the collected presence information (block 455), including one or more of the images, video samples, audio samples, etc. Merely by way of example, the images and/or video samples might be analyzed with facial recognition software and/or other biometric/physiological recognition software, which can be used to determine the number of people in the room with the PDD or ICD and/or to identify any of such people (e.g., by determining a name, an age range, a gender, and/or other identifying or demographic information about a user, based on the output of the facial recognition software and/or other biometric/physiological recognition software). Alternatively and/or additionally, analyzing the images can comprise determining that a person is watching a display device, for example using eye-tracking software to identify a focus area of the person's eyes and correlating that focus area with the location on a screen or display of a television (or other suitable display device). In some cases, if the number of people and the identities (or at least demographic characteristics) of each of the people in the room can be determined, analyzing the images can further include determining a collective demographic of the people in the room (based, for example, on the demographic characteristics of a majority of people in the room). In further cases, the method might analyze audio samples using voiceprint analysis, compare user responses to stored challenge/response information, and/or the like. As yet another example, a camera of a PDD or ICD might capture user gestures, which can be compared with stored gestures (e.g., a particular pattern of hand waving, a pattern of fingers displayed by the user, etc.) in a gesture-based identification and/or authentication scheme. It should be noted that many embodiments can use various combinations of such techniques (such as a combination of facial analysis and spoken, gestured, or typed identifiers, to name a few examples) to provide two-factor authentication. Moreover, such identification techniques may be used to monitor reactions of users, which can then be used as one of the bases for determining whether media content should be filtered and how, as described in detail above, or used as one of the bases for generating media content recommendations and for determining advertisements, as described in detail in the '435, '133, and '603 applications (which have already been incorporated herein by reference in their entirety).

The identification analysis described above can be performed at the PDD/ICD and/or at the control server. Accordingly, in some embodiments, the PDD or ICD will transmit presence information or other identifying information that can be used (in part or in whole) for identifying the user. Such identifying information can include raw or analyzed presence information, as well as information derived from the presence information, such as, to name some examples, extracted features from an image, audio segment, and/or video segment; an excerpted image, video, and/or audio segment; and/or the like. Such presence information and/or identifying information can be transmitted from the PDD or ICD to the control server (block 460), although as noted above, this is not necessary in some embodiments (e.g., where identifying the user or other analysis is performed at the PDD or ICD). Such transmission might comprise IP communications over the Internet, (perhaps over a secure channel, such as a virtual private network (“VPN”)), and, as noted above, the presence/identifying information can include a wide variety of different types of information that enable the control server to determine presence and/or identify/authenticate a user. Hence, at block 465, the control server (in a cloud-based presence detection scheme) might receive the transmitted presence information. In the case that raw presence information is received by the control server, the control server might analyze the raw presence information in a similar manner as described above at block 455. At block 470, the method 400 comprises detecting and/or determining presence of a user. This determination can be made by the PDD/ICD and/or by the control server. In one case, for example, the PDD or ICD might transmit raw video segments, raw images, raw audio samples, etc. to the server, which might perform all analysis and presence determination. In another case, the PDD or ICD might perform this analysis and might notify the control server that a user is present. Receiving such a notification at the control server can be considered to be the control server detecting presence of a user.

At block 475, the method 400 can include identifying and/or authenticating a user. In some cases, this identification and/or authentication can be implicit in the operation of detecting user presence. For example, in performing facial recognition to detect that a user is present, the PDD or ICD (and/or control server) might further analyze the same image to determine an identity of the present user. Alternatively, however, detection of user presence and identification/authentication of the user might be performed as discrete steps (and might depend on device capabilities). For example, a PDD or ICD might have sufficient capabilities to detect the presence of the user, and if so, might send identifying information (such as a captured image, video sample, audio sample, etc.) to the control server to actually identify the user. Alternatively, the PDD or ICD might be capable of identifying the user on its own and might merely send the identity of the user (i.e., data identifying the user, such as a name, username, etc.) to the server.

In some instances, the PDD/ICD and/or the control server (i.e., in a cloud-based presence scheme) might have access to the user's profile or other personal information of the user (including, without limitation, communications, calendar items, contacts list, travel/itinerary information, IP address of user's PDD(s) or ICD(s), or the like). Such profile or other personal information might indicate that the user is visiting a friend or relative in a different city, state, or country. In the case that the friend or family member has a similar PDD or ICD linked to a common network with the control server or other PDDs or ICDs (i.e., in a peer-to-peer or distributed computing scheme), the user's PDD/ICD and/or the control server (if present) might facilitate identification and/or authentication of the user at the friend's or relative's PDD or ICD (“other PDD” or “other ICD”), by, for example, sending the user's biometric/physiological information to the other PDD or ICD and/or to a data center local to the other PDD or ICD, so as to reduce comparison/matching times for identification/authentication of the user at the other PDD or ICD. Such proactive autonomous facilitation functionality might, in some cases, be subject to the user's selection of such option in the user preferences (e.g., at block 425 above). In some cases, the user might disable and/or limit such functionality (e.g., for privacy reasons, for security reasons, and/or the like). In some embodiments, the IP address of a PDD or an ICD at which a user attempts to log in might be analyzed to determine the city in which the PDD or ICD is located. If the city (or neighborhood or customer premises) of the last PDD or ICD at which the user logged in (or is otherwise authenticated by) is determined to be different from the city (or neighborhood or customer premises) of the current PDD or ICD, then it can be inferred that the user has moved, or is travelling. Such inference may be used, in some embodiments, to further infer a general direction in which the user is travelling (or to infer a potential destination(s), if sufficient numbers of data points/locations are determined), and can be used to send ahead the user's profile and/or content to control servers and/or PDDs/ICDs that are at or near the determined potential destination(s).

Once the present user has been identified and/or authenticated, the control server (and/or the PDD or ICD at which the user is present) might enable or implement determination of whether or not to filter/replace/censor/etc. content based on detection or identification of the user(s), in accordance with any or all of the processes in blocks 205-265, as described in detail above with respect to FIG. 2, and/or in blocks 305-365, as described in detail above with respect to FIG. 3.

According to some aspects, in response to determining the presence of the user (at block 470) and/or identifying and authenticating the user (at block 475), method 400, at block 480, might comprise determining whether at least a portion of media content should be filtered, based on detection or identification of the user(s), which is described in detail above with respect to FIGS. 1-3. At block 485, method 400 might comprise filtering and presenting the filtered media content based on such determination, in some cases, in response to determining the presence of the user (at block 470), identifying and authenticating the user (at block 475), and/or determining that at least a portion of the media content should be filtered (at block 480). Filtering and presenting the filtered media content based on such determination is also described in detail above with respect to FIGS. 1-3.

In some embodiments, the PDD, ICD, and the video calling device might be the same user device, in which case, the video calling device might detect presence of a user (as described in detail above with respect to the PDD or ICD), and might notify a computer about the detected presence of a user. Such a video calling device might then receive, over a network, control instructions from the computer to enable or implementing presence detection and/or automatic content filtering of media content, in response to the detected presence of the user.

In some embodiments, the method 400 might further comprise determining that a user is no longer present at the PDD or ICD (block 490). For example, as noted above, the system might continuously and/or periodically capture images and perform presence determination techniques (e.g., as described above) to determine whether the user is still present, and/or might actively query the user after some period of time to determine whether the user is still present. If the system determines that the user is no longer present, the system can block remote access (and control) of the PDD or ICD, remote access to user preferences, and remote access to the user profile, etc. over the network (block 495). For example, the system might delete any image or video content transmitted to the PDD or ICD, log out of any services for controlling remote PDDs or ICDs, revoke access to image and/or video content captured by the PDD(s) or ICD(s) (and/or post-processed using raw captured image data or raw captured video data from the PDD(s) or ICD(s)) stored in the cloud, revoke access to view or modify user preferences (including user preferences related to monitoring media content being presented, monitoring media content downloads, monitoring reactions of users, determining advertisements, sending notifications of determined advertisements, and/or the like), revoke access to view or respond to notifications of media content, and/or the like. This functionality is particularly useful and applicable to PDDs or ICDs (or other devices) that are neither owned nor associated with the user (e.g., a friend's or relative's device, devices at a vacation hotel or vacation rental property, etc.). Such determination and content/access removal might, in some instances, be based on a time-out system (e.g., 5, 15, 30, or 80 minutes, etc.), in which the system might account for the user's temporary absence from the room, while protecting the access to profiles (with which accessing and control of the PDD(s) or ICD(s) may be associated and/or with which user preferences may be associated), and/or content. In some cases, the user can select specific time-out periods, which can be stored in the user's profile, and such specific time-out periods can be universally applicable to some or all profiles, some or all media content, or some or all profiles and media content, or can be specific to particular profiles and/or media content. In some cases, user profiles might be associated with a much shorter time-out period (a time between 1-5 minutes) compared with media content (which might have a time-out period ranging from 15 minutes to 3 hours, or the like). The time-out system might be based on a counter or clock system that starts counting from the last time the system recognized that the user was in range of any of the sensors of the PDD or ICD. Any suitable techniques other than the time-out system described above may be implemented as appropriate. Of course, in response to detecting that the user is no longer present, the PDD(s) or ICD(s) might either stop presenting the at least one advertisement (if currently being presented) or not present the at least one advertisement (if not yet presented).

In some embodiments, the functionalities of block 490 might be applied to detection of non-presence of a child user (or other user who might find particular content offensive, compared with any remaining users). For example, if presence of a child user is detected and/or identified (at blocks 470 and/or 475), it may be determined at some portion of media content should be filtered (at block 480), in response of which determination those particular portions of media content would be filtered. However, if the child user leaves the room, for example, then it may be detected that the child user is no longer present (at block 490). In response to determining non-presence of the child user, if other inappropriate content of the media content (e.g., nude scene, violent scene, or sexually explicit/implicit scene in video or gaming content; offensive language in video, audio, or gaming content; image(s) containing nudity, sexually explicit/implicit content, violent content, offensive language, etc.; or the like) has yet to be presented, presentation of those other inappropriate content may resume or continue without further filtering, provided that continued non-presence of the child user is determined when those other inappropriate content are being presented.

The reader should note that a wide variety of presence-based functions (including, without limitation, those described in the Related Applications) can be performed by the system in conjunction with various techniques described as part of the methods 200, 300, and/or 400, and that such functions can be combined in any suitable way. Based on this disclosure, the skilled reader will understand that such techniques can be combined in a number of different ways.

FIG. 5 illustrates a functional diagram of a system 500 for enabling or implementing presence detection and/or automatic content filtering of media content based on detected presence of users, in accordance with one set of embodiments. The skilled reader should note that the arrangement of the components illustrated in FIG. 5 is functional in nature, and that various embodiments can employ a variety of different structural architectures. Merely by way of example, one exemplary, generalized architecture for the system 500 is described below with respect to FIG. 7, but any number of suitable hardware arrangements can be employed in accordance with different embodiments.

In FIG. 5, a PDD 505 might correspond to ICD 105, video calling device 105, and/or PDD 105, while user device 545 might correspond to non-ICD user device 105, non-video calling device user device 105, or non-PDD user device 105, as described in detail above with respect to FIG. 1. Control server 510, network 515, and cloud storage system 530, in the example of FIG. 5, might correspond to control server 110, network 115, and cloud storage system 130, respectively, as described in detail above with respect to FIG. 1.

System 500 might further comprise a local content source 535 (e.g., a local content source as described above), a display device 540 (including, without limitation, a television (“TV”) and/or the like), and high-definition (“HD”) data cables 550 (or any other suitable data transmission media). In some cases, the HD data cables 550 might include, without limitation, high-definition multimedia interface (“HDMI”) cables. One or more of the PDDs 505 (e.g., the first PDD 505a and the second PDD 505b, as shown in FIG. 5) might be configured to provide pass-through audio and/or video from a local content source 535 to a display device 540 (e.g., using data cables 550). Merely by way of example, in some embodiments, an HDMI input port in the PDD 505 allows HD signals to be input from the corresponding local content source 535, and an HDMI output port in the PDD 505 allows HD signals to be output from the PDD 505 to the corresponding display device 540 (e.g., TV, which might include, but is not limited to, an Internet Protocol TV (“IPTV”), an HDTV, a cable TV, or the like). The output HD signal may, in some cases, be the input HD signal modified by the PDD 505. Local content source 535 might be any suitable local content source. An noted above, a local content source can be any device that provides an audio or video stream to a display device and thus can include, without limitation, a cable or satellite STB, an IPTV STB, devices that generate video and/or audio, and/or acquire video and/or audio from other sources, such as the Internet, and provide that video/audio to a display device; hence a local content source can include devices such as a video game console, a Roku® streaming media player, an AppleTV®, and/or the like. Hence, when situated functionally inline between a local content source and a display device, the PDD 505 can receive an audiovisual stream output from the local content source, modify that audiovisual stream in accordance with the methods described in the '182 patent, and provide the (perhaps modified) audiovisual stream as input to the display device 540. In some embodiments, first PDD 505a, local content source 535a, display device 540a, and user device 545a (if any) might be located at a first customer premises 560a, while second PDD 505b, local content source 535b, display device 540b, and user device 545b (if any) might be located at a second customer premises 560c. According to some embodiments, a user device 545, which might be located at a customer premises 560, might be a portable user device (including, without limitation, a tablet computer, a laptop computer, a smart phone, a mobile phone, a portable gaming device, and/or the like) that is not bound to any particular customer premises 560. In some embodiments, system 500 might further comprise a plurality of customer premises 560 (i.e., customer premises 560a through customer premises 560n), at each of which might be a PDD 505 (with PDD 505n located at customer premises 560n) and a local content source 535 (with local content source 535n located at customer premises 560n), and/or the like.

According to some embodiments, system 500 might further comprise one or more access points (not shown), each of which might be located in proximity to or in the first customer premises 560a, the second customer premises 560b, through the N^{th} customer premises 560n. The access point(s) can allow wireless communication between each PDD 505 and network 515. (Of course, a PDD 505 might also have a wired connection to an access point, router, residential gateway, etc., such as via an Ethernet cable, which can provide similar communication functionality.) In some cases (as shown), each PDD 505 might be communicatively coupled to network 515 (via either wired or wireless connection), without routing through any access points. In some cases, wired or wireless access to network 515 allows PDD 505 to obtain profiles from cloud storage system 530 and/or media content from content server 570 and media content database 575 independent of the corresponding local content source 535, which is in communication with a content distribution network 565 (either via wireless connection or via wired connection). In some cases (not shown), content distribution network 565 (which could be, for example, a cable television distribution network, a satellite television distribution network, an Internet Protocol television (“IPTV”) distribution network, and/or the like) might be communicatively coupled with content server 570, and thus local content source 535 might obtain media content from content server 570 and media content database 575 independently of PDD 505.

In this manner, PDD 505 can overlay the input signal from the corresponding local content source 535 with additional media content to produce an augmented output HD signal to the corresponding display device 540 via data cables 550. This functionality allows for supplemental content (which may be associated with the media content accessed by the local content source 535 for display on display device 540) to be accessed and presented using the first PDD 505, in some cases, as a combined presentation on the display device 540, which may be one of an overlay arrangement (e.g., a picture-in-picture (“PIP”) display, with the supplemental content overlaid on the main content), a split screen arrangement (with the supplemental content adjacent to, but not obscuring, any portion of the main content), a passive banner stream (with non-interactive supplemental content streaming in a banner(s) along one or more of a top, bottom, left, or right edge of a display field in which the main content is displayed on display device 540), and/or an interactive banner stream (with interactive supplemental content streaming in a banner(s) along one or more of a top, bottom, left, or right edge of a display field in which the main content is displayed on display device 540). Herein, examples of interactive supplemental content might include, without limitation, content that when streamed in a banner can be caused to slow, stop, and/or replay within the banner, in response to user interaction with the content and/or the banner (as opposed to passive banner streaming, in which information is streamed in a manner uncontrollable by the user). The interactive supplemental content that is streamed in the banner may, in some instances, also allow the user to invoke operations or functions by interacting therewith; for example, by the user highlighting and/or selecting the supplemental content (e.g., an icon or still photograph of a character, actor/actress, scene, etc. associated with the main content), links for related webpages, links to further content stored in media content database 575, or operations to display related content on display device 540 and/or user device 545 may be invoked. In some embodiments, the interactive supplemental content might include notifications or messages relating to recommendations of media content, the determination and generation of which are described in detail above. According to some embodiments, the interactive supplemental content (whether related or unrelated to the media content being presented) might include advertisement content (such as determined (i.e., selected and/or generated) according to embodiments described above with respect to FIGS. 1-4, or the like).

In some instances, PDD 505 might detect the presence and/or proximity of one or more user devices 545 associated with the user, and might (based on user profile information associated with the user that is stored, e.g., in cloud storage system 530) automatically send supplemental media content via wireless link 555 (directly from PDD 505 or indirectly via an access point (not shown)) for display on a display screen(s) of the one or more user devices 545. In one non-limiting example, a user associated with first PDD 505a might have established a user profile stored in cloud storage system 530 that indicates a user preference for any and all supplemental content for movies and television programs to be compiled and displayed on one or more user devices 545a (including, but not limited to, a tablet computer, a smart phone, a laptop computer, and/or a desktop computer, etc.) concurrent to display of the movie or television program being displayed on display device 540a. In such a case, when a movie is playing on display device 540a broadcast or streamed via local content source 535a from content server 570 and media content database 575 (and/or from some other content server and some other media content source) via network 565, first PDD 505a accesses supplemental content (if available) from content server 570 and media content database 575 via network 515, and sends the supplemental content to the user's tablet computer and/or smart phone via wireless link(s) 555. For example, bios of actors, actresses, and/or crew might be sent to the user's smart phone for display on the screen thereof, while schematics of machines, weapons, robots, tools, etc. associated with the movie or television show might be sent to and displayed on the user's tablet computer, behind the scenes videos or information, news/reviews associated with the main content, and/or music videos associated with the main content may also be sent to the user's smart phone and/or tablet computer, and so on.

Merely by way of example, in some embodiments, first media content might be received by local content source 535a (in customer premises 560a) from media content database 575 via content server 570 and content distribution network 565. The first PDD 505a might provide pass through capability for displaying video aspects (in some cases audio aspects as well) of the first media content from the local content source 535a. As the first media content passes through the first PDD 505a, the first PDD 505a might monitor the media content, might determine whether or not to filter at least one portion of the media content, and might (based on a determination that at least one portion of the media content should be filtered) filter the at least one portion of the media content. In some cases, determining whether at least one portion of the media content should be filtered might be based at least in part on one or more of information in the user profile of the user (or each user whose presence is detected), analyzing the first media content to identify specific images, scenes, audio, etc. that are indicated in a database as being potentially objectionable, receiving user input from at least one of the users (whose presence is detected) indicating that the at least one portion of the media content should be filtered, analysis of the first media content being presented (in some cases, prior to presentation or, in other cases, as it is being presented), and/or analysis of information about the group of users whose presence is detected.

Alternatively, or in addition, the first PDD 505a might comprise sensors (e.g., camera, microphone, proximity sensors, user device sensors, communications links, etc.) that monitor the user(s) within the same room, e.g., to monitor or track reactions of each user (including, but not limited to, vocal expressions or outbursts, facial expressions, hand gestures, body gestures, eye movement, eye focus, shift in proximity with respect to the PDD, and/or the like), using any number or combination of techniques, including, without limitation, facial recognition techniques, facial expression recognition techniques, mood recognition techniques, emotion recognition techniques, voice recognition techniques, vocal tone recognition techniques, speech recognition techniques, eye movement tracking techniques, eye focus determination techniques, proximity detection techniques, and/or the like. The first PDD 505a might determine whether or not to filter/censor/replace at least portions of the media content (or to resume presenting unfiltered/uncensored/unreplaced media content) based at least in part on the monitored reactions of each user.

In some instances, the first PDD 505a might send the information associated with the detected presence of each user, information associated with the monitored media content, and/or information associated with the monitored reactions of each user to control server 510 over network 515, and control server 510 might determine, based at least in part on the presence information, the monitored media content, and/or the monitored reactions of each user, whether or not to filter at least one portion of the media content (and/or whether or not to resume presenting unfiltered versions of the media content). In some cases, control server 510 might alternatively or additionally determine whether or not to filter at least one portion of the media content (and/or whether or not to resume presenting unfiltered versions of the media content) for the users associated with the first PDD 505a (herein, “first users”) based at least in part on the monitored media content from one or more of second through N^{th} PDDs 505b-505n and/or based at least in part on the monitored reactions of users monitored by (or otherwise associated with) second through N^{th} PDDs 505b-505n (herein, “second users”). Here, the second users might be friends of the first users (i.e., known friends, potential friends, or social media friends), might be unrelated yet belonging to a similar demographic group(s), or might be unrelated but representative of a particular population group (either a population group to which the first users belong or some other population group). In one non-limiting set of embodiments, crowdsourcing might be used to determine whether or not to filter at least one portion of the media content (and/or whether or not to resume presenting unfiltered versions of the media content), by compiling marked locations of potentially offensive content (e.g., nude content, sexual content, violent content, offensive language, etc.). In some cases, the profile information of the crowd-sourced users marking such locations might be compared with the users associated with the first PDD 505a. If it is determined that these two sets of users are similar in terms of what they deem offensive (or what they are likely to deem offensive), which might be based on prior user input indicating such or other known information about the users indicating such, then it may be determined that the marked locations of the particular media content should be filtered when presented to the users associated with the first PDD 505a.

In the embodiments in which multiple first users are present, determination of whether to filter media content might take into account similarities and differences amongst the first users, or might conservatively skew toward the most restrictive user in determining whether to filter content. For example, presence of a child (despite presence of adults) while the first media content is being presented by automatically set the automatic filtering to filter out, replace, or otherwise censor the content to eliminate any potentially inappropriate content (e.g., nude content, sexual content, violent content, offensive language, etc.). The age of the child may be estimated or specifically identified, and appropriate levels of filtering may be applied. For instance, the parents of the child might have set or established that at a certain age, some of this filtering may be relaxed when media content containing such inappropriate content is presented to the specific child (in some cases, the parents might allow the child, when the child has reached the age of majority, to view media content without any filtering, or the like). In some embodiments, adults who find certain content disturbing or offensive might set or establish appropriate filtering criteria; by this approach, certain particularly offensive language may be filtered, certain offensive types of scenes (e.g., extremely violent scenes, extremely gory scenes, extremely violent sexual scenes, certain sexual or nude content, etc.) might be filtered, or the like. In some cases, likes, dislikes, indifferences, or other user preferences or default preferences, of each user with respect to particular types of media content or portions of media content might be taken into account when determining whether media content should be filtered for a group. Viewing patterns of each user (either alone or in particular groups with one or more of the present users of the group) might also be taken into account.

Based on the determinations of whether or not to filter media content, the control server 510 or a content filtering server 580 might perform the filtering. In some cases, filtering image content might include one or more of replacing offensive or inappropriate images (e.g., images of nudity, violence, etc.) with polygons (which may be colored, as appropriate), with pixilation or pixelated images, with blurred images, with smiley face(s), with predetermined images, with random images, and/or the like. In some instances, filtering video or gaming content might include one or more of replacing offensive or inappropriate video or gaming scenes (e.g., video or gaming scenes of nudity, violence, etc.) with scenes containing appropriately placed polygons (which may be colored, as appropriate), with scenes containing appropriately placed pixelated images, with scenes containing appropriately placed blurred images, with scenes containing appropriately placed smiley face(s), with scenes containing appropriately placed predetermined images, with scenes containing appropriately placed random images, with replacement scenes, and/or the like. In some embodiments, filtering audio content might include in one or more of replacing offensive or inappropriate audio content (e.g., audio content of sexually explicit or implicit audio content, violent content, offensive language, etc.) with replacement words, a tone (e.g., 1 kHz tone or the like), a muted audio clip, etc. In some cases, replacement words might comprise replacement words matching one or more of gender, age, nationality, accent, and/or characteristics of a speaker of words that are being replaced by the replacement words. For example, a character in a video or gaming content might have a New York accent, and might say an offensive word (e.g., “piss,” which to some people might be deemed offensive); the replacement word (e.g., “urinate,” which to some people might be deemed less offensive) might be modulated or otherwise generated to mimic the New York accent. In some instances, such replacement content might be stored in database 585. Crowd-sourced information related to potentially offensive media content (as well as information related to crowd-sourced users) might also be stored in database 585.

According to some embodiments, the detection of the presence of the user device 545 by the first PDD 505a through the N^{th} PDD 505n might allow identification of a user and thus access of profiles, content, and/or messages and notifications associated with the user's account, regardless of whether the first PDD 505a through the N^{th} PDD 505n is owned by and/or associated with the user. Herein, the user's media content might include, without limitation, at least one of purchased video content, purchased audio content, purchased video game, purchased image content, rented video content, rented audio content, rented video game, rented image content, user-generated video content, user-generated audio content, user-generated video game content, user generated image content, and/or free media content, while the user's profiles might include, but is not limited to, one or more of user profile information for a video game or video game console, web browser history and/or bookmarks, contact information for the user's contacts, user profile information for video or audio content, including without limitation recommended content, device preferences, messaging preferences, videomail preferences, user profile information for cloud services, information regarding what types of content should be filtered, and/or the like. Videomail, herein, might refer to videomail messages addressed to the user or callee. In some cases, the user's profile might also include identifying information—including, but not limited to, the user's biometric information (e.g., facial characteristics, voice characteristics, fingerprint characteristics, iris characteristics, pupil characteristics, retinal characteristics, etc.), user's past monitored reactions (e.g., vocal expressions or outbursts, facial expressions, hand gestures, body gestures, eye movement, eye focus, shift in proximity with respect to the PDD, and/or the like), or the like. In some examples, the user profile information for cloud services might include user log-in information (e.g., username, account number, and/or password/passphrase, etc.) or other suitable credentials for cloud services, which might include, without limitation, video calling service, videomail service, voice calling service, video broadcast/streaming service, audio broadcast/streaming service, on-line gaming service, banking/financial services, travel/accommodation/rental vehicle services, and/or dining/entertainment event reservation/ticketing services, or the like.

In one example, a user might be associated with first PDD 505a (located in the first customer premises 560a), while her friend might be associated with second PDD 505b (located in the second customer premises 560b), and the user and the friend are both subscribers of a similar service provided by control server 510 and/or the cloud service provider associated with control server 510. When the user visits her friend, the friend's PDD 505b might first detect presence of the user, by querying and/or obtaining the identification information for the user's smart phone and/or tablet computer or the like, by capturing video, image, and/or voice data of the user, by infrared detection of a living person in the room, and/or by audio detection of a living person in the room, etc. The friend's PDD 505b might then identify the user using the user's device(s) identification information and/or the captured video, image, and/or voice data, or might send such presence information to control server 510 for identification and authentication analysis. In some cases, detecting presence of, or identifying/authenticating, the user might include, without limitation, analyzing captured images or video segments using one or more of facial recognition software, pupil/iris recognition software, retinal identification software, fingerprint analysis software, and/or physiology recognition software, analyzing captured audio samples using one or more of voiceprint analysis and/or comparison with stored challenge/response information, and/or identification of a user device owned by and/or associated with the user (e.g., based on identification information of the device, which may be previously associated with the user or the user's profile(s), etc.). In terms of detection of the presence of the user's device, any suitable technique may be implemented including, but not limited to, at least one of detecting a Bluetooth connection of the user device, detecting that the user device is associated with a WiFi access point with which the video calling device has associated, and/or communicating with the user device using near field communication (“NFC”).

Once the user has been identified and authenticated, control server 510 might send copies of the user's profiles and/or content to the second PDD 505b (either from first PDD 505a and/or from cloud storage system 530, or the like), or at least provide the user with access to her profiles, notifications of media content recommendations, notification of determined advertisements, preferences for advertisements, videomail, and/or content from her friend's PDD 505b. In some embodiments, the identification and authentication processes might include comparing the user device identification information and/or the captured video, image, and/or voice data against all similar identification data for all users/subscribers of the cloud service that are stored in cloud storage system 530. In some cases, the process might be facilitated where PDDs 505a and 505b might already be associated with each other (e.g., where the user has previously made a video call from first PDD 505a to her friend on second PDD 505b, where the user might have added the friend to the user's contact list, and/or where the friend might have added the user to the friend's contact list). In other cases, the user's first PDD 505a might have access to the user's calendar and/or communications, which might indicate that the user is visiting the friend. The first PDD 505a might query control server 510 to determine whether the friend has a PDD 505b associated with the cloud service provider. In this example, the first PDD 505a determines that second PDD 505b is part of the same service and/or is in communication with control server 510, and based on such determination, first PDD 505a (and/or control server 510) might send the user's profiles and/or content to second PDD 505b, and/or provide second PDD 505b with access to the user's profiles, notifications of media content recommendations, notifications of determined advertisements, preferences for advertisements, videomail, preferences related to what types of content should be filtered, preferences related to desired types of filtering (e.g., use of polygons, blurred images, smiley faces, tones, audio blanks, voice/accent matched replacement words, etc.), and/or content. In some embodiments, the user's profiles, notifications of media content recommendations, notifications of determined advertisements, preferences for advertisements, videomail, and/or content, or access to profiles, notifications of media content recommendations, notifications of determined advertisements, preferences for advertisements, videomail, and/or content, might be encrypted, and might be released/decrypted upon identification and/or authentication by second PDD 505b (and/or by control server 510) when the user is detected by second PDD 505b. In this manner, the user's profiles, notifications of media content recommendations, notifications of determined advertisements, preferences for advertisements, videomail, preferences for types of content to filter, preferences for types of filtering to apply to filtered content, and/or content can follow the user wherever she goes, so long as there is a device (e.g., PDD or video calling device) that is associated with the same or affiliate cloud service provider at her destination, and so long as the device can recognize and authenticate the user.

By the same token, if the user is no longer detected by the second PDD 505b, either after a predetermined number of prompts or queries for the user and/or after a predetermined period of time (e.g., after a specified number of minutes, hours, days, weeks, months, etc.), second PDD 505b (and/or control server 510) might determine that the user is no longer present at the location of second PDD 505b. Based on such a determination, second PDD 505b and/or control server 510 might remove the user's profiles, notifications of media content recommendations, notifications of determined advertisements, preferences for advertisements, videomail, and/or media content (or access thereto) from second PDD 505b. As described above, a time-out system might be utilized. Alternatively, other suitable systems may be used for determining the user is no longer present, and removing the user's profiles, notifications of media content recommendations, notifications of determined advertisements, preferences for advertisements, videomail, and/or media content (or access thereto) from the second PDD 505b. In some cases, once the user is determined to no longer be present at the location of the second PDD 505b, the system might either stop presenting the advertisement(s) (if currently being presented) or not present the advertisement(s) (if not yet presented).

These and other functionalities with regard to filtering of media content may be performed by PDDs 505, control server 510, and/or content filtering server 580, or the like in a manner similar to those as described above with respect to the embodiments of FIGS. 1-4, or the like.

FIG. 6 provides a schematic illustration of one embodiment of a computer system 600 that can perform the methods provided by various other embodiments, as described herein, and/or can function as a video calling device, ICD, PDD, user device, control server, server computer, web server, and/or the like. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include, without limitation, a mouse, a keyboard, and/or the like; and one or more output devices 620, which can include, without limitation, a display device, a printer, and/or the like.

The computer system 600 may further include (and/or be in communication with) one or more storage devices 625, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer system 600 might also include a communications subsystem 630, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 630 may permit data to be exchanged with a network (such as the network described below, to name one example), with other computer systems, and/or with any other devices described herein. In many embodiments, the computer system 600 will further comprise a working memory 635, which can include a RAM or ROM device, as described above.

The computer system 600 also may comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 600) to perform methods in accordance with various embodiments of the invention. According to a set of embodiments, some or all of the procedures of such methods are performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

According to some embodiments, system 600 might further comprise one or more sensors 650, which might include, without limitation, one or more cameras, one or more IR sensors, and/or one or more 3D sensors, or the like. In some cases, the one or more sensors 650 might be incorporated in (or might otherwise be one of) the input device(s) 615. The output device(s) 620 might, in some embodiments, further include one or more monitors, one or more TVs, and/or one or more display screens, or the like.

The terms “machine readable medium” and “computer readable medium,” as used herein, refer to any medium that participates in providing data that causes a machine to operate in a specific fashion. In an embodiment implemented using the computer system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. Such a medium may take many forms, including, but not limited to, non-volatile media, volatile media, and transmission media. Non-volatile media includes, for example, optical and/or magnetic disks, such as the storage device(s) 625. Volatile media includes, without limitation, dynamic memory, such as the working memory 635. Transmission media includes, without limitation, coaxial cables, copper wire and fiber optics, including the wires that comprise the bus 605, as well as the various components of the communication subsystem 630 (and/or the media by which the communications subsystem 630 provides communication with other devices). Hence, transmission media can also take the form of waves (including, without limitation, radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

As noted above, a set of embodiments comprises systems collecting presence information and/or enabling or implementing automatic content filtering of media content, based on presence information (regardless of whether the user device detecting the presence detection is owned by and/or associated with the user). FIG. 7 illustrates a schematic diagram of a system 700 that can be used in accordance with one set of embodiments. The system 700 can include one or more user computers 705. In particular, a user computer 705 can be a video calling device, an ICD, a PDD, and/or a user device, as described above. More generally, a user computer 705 can be a general purpose personal computer (including, merely by way of example, desktop computers, workstations, tablet computers, laptop computers, handheld computers, mobile phones, smart phones, and the like), running any appropriate operating system, several of which are available from vendors such as Apple, Microsoft Corp., as well a variety of commercially-available UNIX™ or UNIX-like operating systems. A user computer 705 can also have any of a variety of applications, including one or more applications configured to perform methods provided by various embodiments (as described above, for example), as well as one or more office applications, database client and/or server applications, and/or web browser applications. Alternatively, a user computer 705 can be any other electronic device, such as a thin-client computer, Internet-enabled mobile telephone, and/or personal digital assistant, capable of communicating via a network (e.g., the network 710 described below) and/or of displaying and navigating web pages or other types of electronic documents. Although the exemplary system 700 is shown with two user computers 705, any number of user computers can be supported.

Certain embodiments operate in a networked environment, which can include a network 710. The network 710 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network 710 can include a local area network (“LAN”), including, without limitation, a fiber network, an Ethernet network, a Token-Ring™ network and/or the like; a wide-area network; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments can also include one or more server computers 715. Each of the server computers 715 may be configured with an operating system, including, without limitation, any of those discussed above with respect to the user computers 705, as well as any commercially (or freely) available server operating systems. Each of the servers 715 may also be running one or more applications, which can be configured to provide services to one or more clients 705 and/or other servers 715.

Merely by way of example, one of the servers 715 might be a control server, with the functionality described above. In another embodiment, one of the servers might be a web server, which can be used, merely by way of example, to provide communication between a user computer 705 and a control server, for example, to process requests for web pages or other electronic documents from user computers 705 and/or to provide user input to the control server. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 705 to perform operations in accordance with methods provided by various embodiments.

The server computers 715, in some embodiments, might include one or more application servers, which can be configured with one or more applications accessible by a client running on one or more of the client computers 705 and/or other servers 715. Merely by way of example, the server(s) 715 can be one or more general purpose computers capable of executing programs or scripts in response to the user computers 705 and/or other servers 715, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer 705 and/or another server 715. In some embodiments, an application server can create web pages dynamically for displaying the information in accordance with various embodiments, such as providing a user interface for a control server, as described above. Data provided by an application server may be formatted as one or more web pages (comprising HTML, JavaScript, etc., for example) and/or may be forwarded to a user computer 705 via a web server (as described above, for example). Similarly, a web server might receive web page requests and/or input data from a user computer 705 and/or forward the web page requests and/or input data to an application server. In some cases, a web server may be integrated with an application server.

In accordance with further embodiments, one or more servers 715 can function as a file server and/or can include one or more of the files (e.g., application code, data files, etc.) necessary to implement various disclosed methods, incorporated by an application running on a user computer 705 and/or another server 715. Alternatively, as those skilled in the art will appreciate, a file server can include all necessary files, allowing such an application to be invoked remotely by a user computer 705 and/or server 715.

It should be noted that the functions described with respect to various servers herein (e.g., application server, database server, web server, file server, etc.) can be performed by a single server and/or a plurality of specialized servers, depending on implementation-specific needs and parameters. Further, as noted above, the functionality of one or more servers 715 might be implemented by one or more containers or virtual machines operating in a cloud environment and/or a distributed, cloud-like environment based on shared resources of a plurality of user video calling devices, a plurality of ICDs, and/or a plurality of PDDs.

In certain embodiments, the system can include one or more data stores 720. The nature and location of the data stores 720 is discretionary: merely by way of example, one data store 720 might comprise a database 720a that stores information about master accounts, user profiles, user preferences (including, but not limited, to acceptable types of content, types of content to filter/censor/replace/etc. for any of a plurality of users, or the like), assigned video calling devices, viewing/listening/Internet browsing/gaming patterns, viewing/listening/Internet browsing/gaming history, etc. Alternatively and/or additionally, a data store 720b might be a cloud storage environment for storing master accounts, user profiles, user preferences, uploaded monitored reactions of users, and/or the like.

As the skilled reader can appreciate, the database 720a and the cloud storage environment 720b might be collocated and/or separate from one another. Some or all of the data stores 720 might reside on a storage medium local to (and/or resident in) a server 715a. Conversely, any of the data stores 720 (and especially the cloud storage environment 720b) might be remote from any or all of the computers 705, 715, so long as it can be in communication (e.g., via the network 710) with one or more of these. In a particular set of embodiments, a database 720a can reside in a storage-area network (“SAN”) familiar to those skilled in the art, and/or the cloud storage environment 720b might comprise one or more SANs. (Likewise, any necessary files for performing the functions attributed to the computers 705, 715 can be stored locally on the respective computer and/or remotely, as appropriate.) In one set of embodiments, the database 720a can be a relational database, such as an Oracle database, that is adapted to store, update, and retrieve data in response to SQL-formatted commands. The database might be controlled and/or maintained by a database server, as described above, for example.

As noted above, the system can also include a first PDD 725, a second PDD 730, and a third PDD 735. The first PDD 725 in the context of the examples described herein corresponds to the device associated with the user or audience member, while the second and third PDDs 730-735 might correspond to devices associated with known friends, potential friends, and/or social media friends associated with the user, and/or might correspond to devices associated with people unrelated to the user (which might include people belonging to similar demographic groups as the user, people within a similar geographic region (but not necessarily within similar demographic groups), people who generally represent average persons within a population, and/or the like). Although only three PDDs are illustrated in FIG. 7, it should be appreciated that any number of PDDs 725-735 may be implemented in accordance with various embodiments.

Using the techniques described herein, each of the first PDD 725, the second PDD 730, and the third PDD 735 can determine presence of one or more users or audience members, identify users or audience members, access profiles of the identified users or audience members, determine whether at least one portion of media content should be filtered prior to presentation to a user, (based on such a determination) filter the at least one portion of the media content, and/or the like. In some cases, determining whether at least one portion of the media content should be filtered might be based on one or more of user preferences of each user; known viewing/listening/gaming patterns from the user profile of each user; monitored reactions of each user (including, but not limited to, vocal expressions or outbursts, facial expressions, hand gestures, body gestures, eye movement, eye focus, shift in proximity with respect to the PDD, and/or the like); portions of similar media content viewed/listened/played by and subsequently marked for filtering or censoring by the user; portions of media content viewed/listened/played by and subsequently marked for filtering or censoring by known friends, potential friends, social media friends, and demographic group members; and/or the like.

Each of the first PDD 725, the second PDD 730, and the third PDD 735 may be (or may have similar functionality as) a video calling device 105, a user device 105, an ICD 105, or a PDD 105, as described in detail above; in some cases, each of the first PDD 725, the second PDD 730, and the third PDD 735 might be (or may have similar functionality as) a VCD as described in the '182 patent.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware, and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a first device, first media content from a local content source;
presenting, with the first device, the received first media content;
collecting, with a presence detection device, presence information of a user;
estimating characteristics of the user, with a first computer, based at least in part on information derived from at least a portion of the presence information;
determining, with a second computer, whether at least one portion of the received first media content should be filtered based at least in part on the estimated characteristics of the user; and
based on a determination that at least one portion of the received first media content should be filtered, filtering the at least one portion of the received first media content prior to presenting the at least one portion of the received first media content.

2. The method of claim 1, wherein the first media content comprises media content type selected from a group consisting of television program content, movie content, music content, gaming content, news-related content, sports-related content, video clip content, advertisement content, and Internet-based media content.

3. The method of claim 1, wherein at least two of the first device, the presence detection device, the first computer, or the second computer are the same device.

4. The method of claim 1, wherein at least one of the first computer or the second computer is a control server in communication with the presence detection device over a network.

5. The method of claim 1, wherein estimating characteristics of the user, with the first computer, based at least in part on information derived from at least a portion of the presence information comprises estimating, with the first computer, one or more of age, gender, or demographics of the user, based at least in part on the information derived from at least a portion of the presence information.

6. The method of claim 1, wherein estimating characteristics of the user, with the first computer, based at least in part on information derived from at least a portion of the presence information comprises identifying the user, with the first computer, based at least in part on the information derived from at least a portion of the presence information.

7. The method of claim 1, wherein the presence detection device comprises:
a video input interface to receive video input from the local content source;
an audio input interface to receive audio input from the local content source;
a video output interface to provide video output to a display device;
an audio output interface to provide audio output to an audio receiver;
an image capture device to capture at least one of image data or video data;
an audio capture device to capture audio data;
a network interface;
at least one processor; and
a storage medium in communication with the at least one processor.

8. The method of claim 7, wherein the presence information comprises at least one of an image captured by the image capture device, a video segment captured by the image capture device, an audio sample captured by the audio capture device, or a detected presence of a user device in proximity to the first presence detection device.

9. The method of claim 7, wherein collecting the presence information comprises capturing one or more images of at least a portion of a room with the image capture device.

10. The method of claim 9, wherein the one or more images comprises a video stream, wherein collecting the presence information comprises analyzing the one or more images.

11. The method of claim 10, wherein analyzing the one or more images comprises:
determining a number of people in the room.

12. The method of claim 10, wherein analyzing the one or more images comprises:
determining a collective demographic of a plurality of people in the room.

13. The method of claim 10, wherein analyzing the one or more images comprises:
determining an identity of at least one person in the room, using facial recognition technology.

14. The method of claim 10, wherein analyzing the one or more images comprises:
determining that a person is watching a display device, using eye tracking technology.

15. The method of claim 1, wherein filtering the at least one portion of the received first media content comprises:
receiving at least one filtered portion of the first media content; and
inserting the at least one filtered portion of the first media content in a media stream comprising the first media content.

16. The method of claim 15, wherein inserting the at least one filtered portion of the first media content in the media stream comprises replacing the at least one portion of the received first media content with the at least one filtered portion of the first media content.

17. The method of claim 16, wherein the at least one filtered portion of the first media content comprises at least one of one or more colored polygons, one or more pixelated images, one or more blurred images, one or more smiley faces, one or more predetermined images, one or more random images, one or more audio tones, one or more audio blanks, one or more replacement words, or one or more video scenes.

18. The method of claim 17, wherein the one or more replacement words comprise replacement words matching one or more of gender, age, nationality, accent, or characteristics of a speaker of words that are being replaced by the one or more replacement words.

19. The method of claim 17, further comprising:
determining, with the second computer, whether at least one portion of the received first media content should be filtered based at least in part on analyzing the first media content to identify specific one or more of video content, image content, game content, or audio content that are indicated in a database as being potentially objectionable, using one or more of pattern recognition technology or object recognition technology,
wherein filtering the at least one portion of the received first media content comprises replacing the identified specific one or more of video content, image content, game content, or audio content with at least one of the one or more colored polygons, the one or more pixelated images, the one or more blurred images, the one or more smiley faces, the one or more predetermined images, or the one or more random images.

20. The method of claim 15, wherein inserting the at least one filtered portion of the first media content in the media stream comprises overlaying the media stream with the at least one filtered portion of the first media content.

21. The method of claim 15, wherein filtering the at least one portion of the received first media content further comprises adding latency to the first media content during presentation of the first media content.

22. The method of claim 1, wherein filtering the at least one portion of the received first media content comprises at least one of:
blocking the at least one portion of the received first media content from being presented;
pausing presentation of the at least one portion of the received first media content;
hiding the at least one portion of the received first media content during presentation of the received first media content;
skipping the at least one portion of the received first media content during presentation of the received first media content;
removing the at least one portion from the received first media content; or
replacing the at least one portion of the received first media content with replacement content.

23. The method of claim 22, wherein the replacement content comprises a different version of the first media content.

24. The method of claim 1, wherein determining, with a second computer, whether at least one portion of the received first media content should be filtered based at least in part on the estimated characteristics of the user comprises determining that the user is a child user and that the at least one portion of the received media content is media content inappropriate for the child user, wherein filtering the at least one portion of the received first media content comprises at least one of pausing or blanking the at least one portion of the received first media content.

25. The method of claim 24, wherein determining that the user is a child user and that the at least one portion of the received media content is media content inappropriate for the child user comprises receiving one or more of a verbal command, from a second user, indicating that the at least one portion of the received media content should be censored, a gesture command, from the second user, indicating that the at least one portion of the received media content should be censored, or instructions based on user profiles associated with the child user indicating that media content similar to the at least one portion of the received media content should be censored.

26. The method of claim 24, further comprising:
determining, with the presence detection device, that the child user is no longer present; and
based on a determination that the child user is no longer present, resuming presentation of the received first media content.

27. The method of claim 26, wherein determining, with the presence detection device, that the child user is no longer present comprises one or more of a verbal command, from the second user, indicating to resume presentation of the at least one portion of the received media content, a gesture command, from the second user, indicating to resume presentation of the at least one portion of the received media content, or instructions based on analysis of current presence information of the child user indicating that the child user is no longer physically present.

28. The method of claim 1, further comprising:
identifying the user, with the first computer, based at least in part on identifying information derived from at least a portion of the presence information.

29. The method of claim 28, wherein identifying the user comprises:
determining an identity of the user, using one or more of facial recognition technology or voice recognition technology.

30. The method of claim 29, further comprising:
determining, with the second computer, whether at least one portion of the received first media content should be filtered based on profile information of each of the identified at least one person in the room.

31. The method of claim 29, wherein collecting presence information of a user comprises collecting presence information the user over a period of time, the method further comprising:
updating, with the presence detection device, a user profile associated with the user with updated identifying information based on a determination that one or more of an appearance or a voice pattern of the user has changed.

32. The method of claim 28, further comprising:
receiving user input from the user indicating desired custom level of content filtering; and
updating a user profile associated with the user, based at least in part on the received user input.

33. The method of claim 1, wherein determining, with a second computer, whether at least one portion of the received first media content should be filtered based at least in part on the estimated characteristics of the user comprises determining, with a second computer, whether at least one portion of the received first media content should be filtered based at least in part on a determination as to whether one or more users whose presence are presently detected are of an estimated age appropriate to view, listen to, or play the first media content based at least in part on content ratings of the first media content.

34. The method of claim 1, further comprising:
monitoring, with the presence detection device, information associated with the first media content;
sending, with the presence detection device, the monitored information associated with the first media content to the second computer over a network.

35. The method of claim 34, wherein the information associated with the first media content comprises media content-based information comprising at least one of:
information pertaining to one or more portions of the first media content containing one or more of video scenes of nudity or images of nudity;
information pertaining to one or more portions of the first media content containing one or more of video scenes of suggestive sexual content or images of suggestive sexual content;
information pertaining to one or more portions of the first media content containing one or more of video scenes of explicit sexual content or images of explicit sexual content;
information pertaining to one or more portions of the first media content containing one or more of video scenes of violence or images of violence;
information pertaining to one or more portions of the first media content containing one or more of audio of violence, audio of sexual content, or audio of coarse or offensive language.

36. The method of claim 35, further comprising:
determining, with a second computer, whether at least one portion of the received first media content should be filtered based at least in part on at least one of one or more first locations containing the media-content based information in the first media content that are monitored by the presence detection device, one or more second locations containing the media-content based information in the first media content that are marked by the user using user input, or one or more third locations containing the media-content based information in the first media content that are monitored by the presence detection device in compiled information received from a database over a network, the compiled information comprising locations containing the media-content based information in the first media content that are marked by at least one of a plurality of users who are unassociated with the user or a plurality of users who are known to the user.

37. The method of claim 34, wherein each of the information associated with the first media content comprises audience-based information comprising at least one of:
number of audience members present during presentation of particular portions of the first media content;
identity of each audience member;
gender of each audience member;
age of each audience member;
demographic group to which each audience member belongs;
viewing patterns of each audience member;
specific reactions of each audience member during presentation of particular portions of the first media content;
overall reactions of each audience member throughout presentation of the first media content;
consistency of audience member reactions of each audience member compared with personal preferences of the audience member; or
consistency of audience member reactions of each audience member compared with past reactions of the audience member.

38. The method of claim 37, wherein each of the specific reactions or the overall reactions comprises reactions selected from a group consisting of:
vocal expressions;
facial expressions;
hand gestures;
body gestures;
eye movement;
eye focus; and
shift in proximity with respect to the presence detection device.

39. The method of claim 37, wherein the audience-based information is monitored using one or more of:
facial recognition techniques;
facial expression recognition techniques;
mood recognition techniques;
emotion recognition techniques;
voice recognition techniques;
vocal tone recognition techniques;
speech recognition techniques;
eye movement tracking techniques;
eye focus determination techniques; or
proximity detection techniques.

40. The method of claim 34, further comprising:
determining, with a second computer, whether at least one portion of the received first media content should be filtered based at least in part on analysis of one or more of:
identification of each person in a room in which the presence detection device is located;
identification of each person viewing the first media content being displayed on a display device communicatively coupled to a video output interface of the presence detection device; or
identification of each person listening to the first media content being presented over a speaker communicatively coupled to an audio receiver that is communicatively coupled to an audio output interface of the presence detection device.

41. An apparatus, comprising:
a non-transitory computer readable medium having encoded thereon a set of instructions executable by one or more processors to cause the apparatus to perform one or more operations, the set of instructions comprising:
instructions for receiving presence information from a presence detection device; and
instructions for determining whether at least one portion of a first media content should be filtered during presentation of the first media content, based at least in part on the presence information.

42. A system, comprising:
a computer; and
a presence detection device;
the computer comprising:
one or more first processors; and
a first non-transitory computer readable medium in communication with the one or more first processors, the first non-transitory computer readable medium having encoded thereon a first set of instructions executable by the one or more first processors to cause the computer to perform one or more operations, the first set of instructions comprising:
instructions for receiving presence information of a user from the presence detection device;
instructions for determining whether at least one portion of a first media content should be filtered during presentation of the first media content, based at least in part on the presence information; and
instructions for, based on a determination that at least one portion of the first media content should be filtered, sending at least one filtered portion of the first media content corresponding to the at least one portion of the first media content;
the presence detection device configured to collect the presence information, the presence detection device comprising:
a video input interface to receive video input from a local content source;
an audio input interface to receive audio input from the local content source;
a video output interface to provide video output to a display device;
an audio output interface to provide audio output to an audio receiver;
an image capture device to capture at least one of image data or video data;
an audio capture device to capture audio data;
a network interface;
one or more second processors; and
a second non-transitory computer readable medium in communication with the one or more second processors, the second non-transitory computer readable medium having encoded thereon a second set of instructions executable by the one or more second processors to control operation of the presence detection device, the second set of instructions comprising:
instructions for controlling the image capture device to capture one of a video stream or at least one image of the user;
instructions for controlling the audio capture device to capture an audio stream;
instructions for encoding the captured video stream and the captured audio stream to produce a series of data packets comprising presence information of the user;
instructions for transmitting, using the network interface, the series of data packets comprising presence information of the user, for reception by the computer;
instructions for receiving the first media content;
instructions for receiving, from the computer, the at least one filtered portion of the first media content;
instructions for presenting the first media content; and
instructions for replacing, during presentation of the first media content, each of the at least one portion of the first media content with a corresponding one of the at least one filtered portion of the first media content, based on the determination that at least one portion of the first media content should be filtered.

43. An image capture device configured to be accessible over a network, the image capture device comprising:
an image sensor to capture at least one of image data or video data;
a communication system;
one or more processors; and
a computer readable medium in communication with the one or more processors, the computer readable medium having encoded thereon a set of instructions executable by the computer system to cause the image capture device to perform one or more operations, the set of instructions comprising:
instructions for collecting presence information of a user; and
instructions for sending the collected presence information to a computer over a network to determine whether at least one portion of a first media content should be filtered during presentation of the first media content, based at least in part on profile information of the user.

44. The system of claim 43, wherein the set of instructions further comprises:
instructions for identifying the user, based at least in part on identifying information derived from at least a portion of the presence information,
wherein the instructions for sending the collected presence information to the computer comprises instructions for sending information pertaining to an identification of the user.

45. The system of claim 43, wherein the set of instructions further comprises:
instructions for presenting the first media content; and
instructions for replacing, during presentation of the first media content, each of the at least one portion of the first media content with a corresponding one of at least one filtered portion of the first media content, based on a determination that the at least one portion of the first media content should be filtered.
